(19) United States
(12) Patent Application Publication
(10) Pub. No.: US 2023/0211463 A1
(43) Pub. Date: Jul. 6, 2023

(54) ABRASIVE ARTICLES AND METHODS FOR FORMING SAME

(71) Applicants: SAINT-GOBAIN ABRASIVES, INC., Worcester, MA (US); SAINT-GOBAIN ABRASIFS, Conflans-Sainte-Honorine (FR)

(72) Inventors: Brahmanandam V. TANIKELLA, Northborough, MA (US); Charles J. GASDASKA, Shrewsbury, MA (US)

(21) Appl. No.: 18/148,867

(22) Filed: Dec. 30, 2022

Related U.S. Application Data
(60) Provisional application No. 63/266,280, filed on Dec. 30, 2021.

(51) Int. Cl. B24D 3/02; C09K 3/14

(52) U.S. Cl. CPC B24D 3/02; C09K 3/1409; B33Y 70/00

(57) ABSTRACT

A method for forming an abrasive article via an additive manufacturing technique including forming a layer of powder material comprising a precursor bond material and abrasive particles, compacting at least a portion of the layer to form a compacted layer, binding at least a portion of the compacted layer, and repeating the steps of forming, compacting, and binding to form a green body abrasive article.

### CROSS-REFERENCE TO RELATED APPLICATION(S)

This application claims priority under 35 U.S.C. § 119(e) to U.S. Provisional Patent Application No. 63/266,280, filed Dec. 30, 2021, by Brahmanandam V. TANIKELLA et al., entitled “ABRASIVE ARTICLES AND METHODS FOR FORMING SAME,” which is assigned to the current assignee hereof and incorporated herein by reference in its entirety for all purposes.

### FIELD OF THE DISCLOSURE

The present disclosure relates to forming abrasive articles and aspects of one or more green bodies and/or finally-formed abrasive articles.

### BACKGROUND

Abrasive articles are used in material removal operations, such as cutting, grinding, or shaping various materials. Abrasive articles or green bodies of abrasive articles can be formed via additive manufacturing. There is a need to develop improved abrasive articles.

### BRIEF DESCRIPTION OF THE DRAWINGS

Embodiments are illustrated by way of example and are not limited in the accompanying figures.

FIGS. 1A-E include illustrations of a process of forming an abrasive article according to an embodiment.

FIGS. 2A and 2B include perspective view illustrations of abrasive articles according to an embodiment.

FIG. 3 includes an illustration of the measuring principle of the developed interfacial area ratio Sdr.

FIGS. 4A-E include cross-sectional images of abrasive articles according to an embodiment.

FIGS. 5A and 5B include images from a bonded abrasive formed through conventional processing techniques of hot pressing.

FIG. 6A includes an illustration of a build box including loose or unbound powder.

FIG. 6B includes an illustration of a process for capturing the loose powder after completing a forming operation.

FIG. 6C is a graphic representation of the process for recycling the unused and loose powder material.

FIG. 7A is a perspective view illustration of a body of an abrasive article.

FIGS. 7B-D include cross-sectional images of the abrasive article of FIG. 7A.

FIG. 8A includes a perspective view illustration of an intended shape of an abrasive article.

FIG. 8B includes a perspective view illustration of a formed abrasive article

FIG. 8C includes a perspective view illustration of a comparison of a formed abrasive article and an intended shape.

FIGS. 9A and 9B include illustrations of scans of abrasive articles.

FIG. 10 includes an apparatus for evaluating moisture content and/or flowability characteristics of an abrasive precursor powder or other raw material powder according to an embodiment.

FIGS. 11A-D include illustrations of analysis techniques for analyzing flowability properties of a powder material according to embodiments.

FIG. 12A includes a process for forming an abrasive article via additive manufacturing according to an embodiment.

FIG. 12B includes a process for forming an abrasive article via additive manufacturing according to an embodiment.

FIG. 13A includes a diagram of a method of forming an article according to an embodiment.

FIG. 13B includes a diagram of a method of forming an article according to an embodiment.

FIG. 14 includes a plot of avalanche angle versus time for two different samples of powder material.

FIG. 15 includes a plot of density for samples.

FIGS. 16-28 include plots of various flowability characteristics of powder materials over time according to embodiments and examples herein.

FIGS. 29A-29E include plots of the flowability characteristics of the powder material used to form Samples S4 and S5.

### DETAILED DESCRIPTION

The present disclosure may be better understood, and its numerous features and advantages made apparent to those skilled in the art by referencing the accompanying drawings.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The present disclosure is directed to methods for forming abrasive articles and the features of the resulting abrasive articles. While prior disclosures have provided some limited examples of forming abrasive articles via additive manufacturing, such abrasive articles are limited in their size, quantity, and quality. In fact, Applicants of the present disclosure have conducted notable empirical studies and have found that the knowledge necessary to create high quality abrasive articles according to conventional additive manufacturing techniques is noted, specifically in the context of dry powder layering and binding techniques. To-date, disclosures in the prior art are limited to micro-abrasive bodies. This is because formation of large-scale, high-quality abrasive articles via dry powder layering and binding techniques is not easily scalable. Numerous hurdles limit the advance of the technology, including but not limited to, the capability of creating dense parts, dimensional stability during and after forming, and the empirical studies needed to fully understand and appreciate the complexities of the process variables. Such process variables include, but is not limited to, composition of the powder material, flowability of the powder material, a force applied by a compaction object to the layer or a plurality of layers of powder, a traverse speed of a compaction object, average thickness of the layer prior to compaction, a particle size distribution of the powder, number of previously formed layers underlying the layer of powder, the number of compacted layers underlying the layer of powder, the density of any layers underlying the layer of powder, the amount of binder in any layers underlying the layer of powder, the relative dimensions of the layer relative to one or more layers underlying the layer, an average thickness of the layer prior to compaction, a printhead deposition resolution, saturation limits of the binder, composition of the binder material, and others.

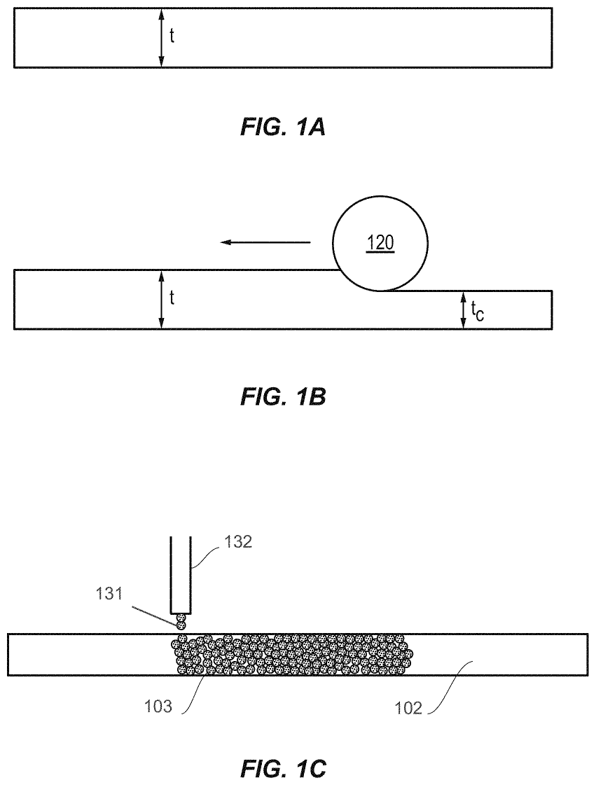

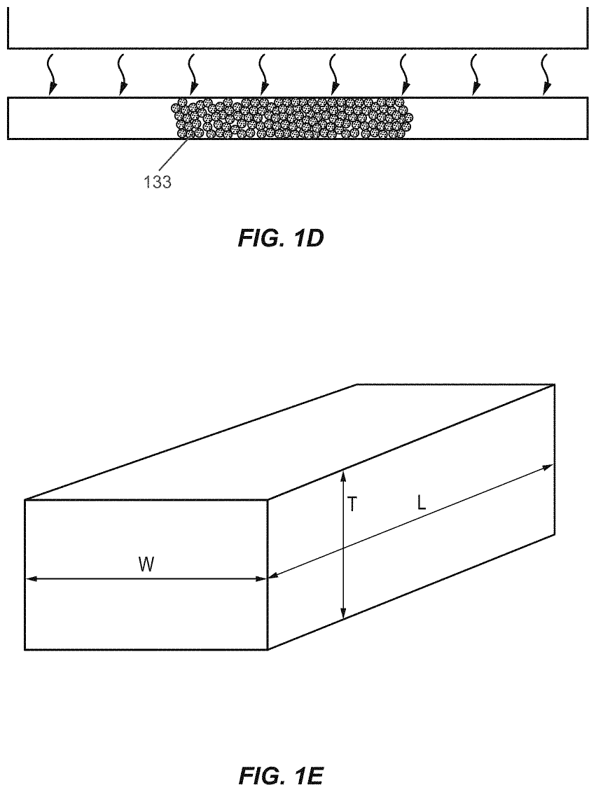

FIG. 1A includes an illustration of a portion of the process including forming one or more layers of powder material that can include abrasive particles, and may include a mixture of abrasive particles and precursor bond material. The layer of powder can have an average thickness (t). The layer of powder material can be dispensed as described in embodiments herein.

In an embodiment, the layer of powder material can have an average thickness (t) that may facilitate improved manufacturing and/or performance of the abrasive article. In an embodiment, the layer of powder material can have an average thickness (t) of at least 1 micron, such as at least 5 microns or at least 10 microns or at least 15 microns or at least 20 microns or at least 25 microns. In still another embodiment, the layer of powder material can have an average thickness (t) of not greater than 500 microns, such as not greater than 400 microns or not greater than 300 microns or not greater than 200 microns or not greater than 100 microns or not greater than 90 microns or not greater than 80 microns or not greater than 70 microns or not greater than 60 microns or not greater than 50 microns or not greater than 40 microns or not greater than 30 microns or not greater than 20 microns. The average thickness (t) of the layer of powder material may be a value between any of the minimum and maximum values noted above, including for example, but not limited to, within a range of at least 1 micron to not greater than 500 microns or within a range of at least 10 microns to not greater than 300 microns or within a range of at least 25 microns to not greater than 100 microns.

In a particular embodiment, forming one or more layers of powder material can include depositing the powder material from a container via agitation of the powder material in the container, which then flows through a screen in the container, and wherein the powder material drops from the container via gravity into a build box or a previously deposited layer of powder material. In still other embodiments, the method of agitation and the screen size can be selected based upon the particle size distribution of the powder.

In one aspect, the powder material may include a precursor bond material that may facilitate improved manufacturing and/or performance of the abrasive article. For example, in one embodiment, the bond material may include one of an organic material, an inorganic material, a metal, a metal alloy, a ceramic, an oxide, a carbide, a nitride, a boride, an amorphous material, a crystalline material, or any combination thereof. In a particular embodiment, the precursor bond material may be converted chemically or undergo a phase change during processing from a precursor bond material to a bond material of a finally-formed abrasive article. In still another embodiment, the precursor bond material does not necessarily undergo any physical or chemical changes during processing and is present as a bond material in the finally-formed abrasive article.

In one aspect, the powder material may include abrasive particles that may facilitate improved manufacturing and/or performance of the abrasive article. For example, in one embodiment, the abrasive particles can include an oxide, a carbide, a nitride, a boride, a superabrasive, or any combination thereof. In an embodiment, the abrasive particles can include diamond, silica, cubic boron nitride, silicon carbide, boron carbide, alumina, silicon nitride, tungsten carbide, zirconia, or any combination thereof.

In an embodiment, the abrasive particles may include a particle size distribution having an average particle size (D50a) that may facilitate improved manufacturing and/or performance of the abrasive article. As used herein, the D50 value signifies the size value in the distribution, up to and including which, 50% of the total counts of the abrasive particles defining the distribution are ‘contained’. For example, in a non-limiting example, if the D50 is 25 microns, 50% of the abrasive particles have a size of 25 microns or smaller. It will be appreciated, the D50 value may also be referred to as the median value of a sample. In one embodiment the average particle size (D50a) of the abrasive particles may be at least 0.025 microns, such as at least 0.05 or at least 0.1 microns or at least 0.3 microns or at least 0.4 microns or at least 0.5 microns or at least 0.8 microns or at least 1 micron or at least 1.5 microns or at least 2 microns or at least 3 microns or at least 5 microns or at least 10 microns or at least 50 microns or at least 100 microns or at least 200 microns or at least 300 microns. In still another non-limiting embodiment, the average particle size (D50a) of the abrasive particles may be not greater than 500 microns, such as not greater than 400 microns or not greater than 300 microns or not greater than 200 microns or not greater than 100 microns or not greater than 50 microns or not greater than 10 microns or not greater than 5 microns or not greater than 4 microns or not greater than 3 microns or not greater than 3 micron or not greater than 1 micron. The average particle size (D50a) of the abrasive particles may be a value between any of the minimum and maximum values noted above, including for example, but not limited to, within a range of at least 0.25 microns to not greater than 500 microns or within a range of at least 0.5 microns to not greater than 300 microns or within a range of at least 1 micron to not greater than 10 microns.

In still other embodiments, the abrasive particles include abrasive particles having a Mohs hardness of at least 6 such as at least 7 or at least 8 or at least 9. In still another embodiment, the abrasive particles include abrasive particles having a Mohs hardness of not greater than 30, such as not greater than 25 or not greater than 20 or not greater than 15 or not greater than 10. It will be appreciated the Mohs hardness of the abrasive particles may be a value between any of the minimum and maximum values noted above, including for example, but not limited to, within a range of at least 6 to not greater than 30 or at least 8 and not greater than 20.

FIG. 1B includes an illustration of a process of compacting at least a portion of the layer with a compaction object (120). The compaction object 120 can traverse the layer and compact the layer to form a compacted layer having an average thickness (tc). The compacted layer thickness (tc) can be less than the layer thickness (t) prior to compaction as described according to embodiments herein. As will be appreciated, in some instances, multiple layers of powder material may be formed and compaction can be completed on more than one layer of powder material simultaneously. In some optional embodiments, a smoothing roller may traverse the surface of the layer of powder, but smoothing rollers do not apply sufficient force to cause compaction, rather they scrape the surface of the layer to remove and smooth any large undulations. In still another embodiment, the smoothing roller is configured to contact the upper surface of the layer sufficiently to spread the powder material and smooth the upper surface after forming the layer.

In an embodiment, the compacted layer may include an average compacted layer thickness that may facilitate improved manufacturing and/or performance of the abrasive article. In one embodiment, the average compacted layer thickness may be at least 0.1 microns such as at least 0.5 microns or at least 0.8 microns or at least 1 micron or at least 2 microns or at least 3 microns or at least 4 microns or at least 5 microns or at least 6 microns or at least 7 microns or at least 8 microns or at least 9 microns or at least 10 microns or at least 11 microns or at least 12 microns or at least 13 microns or at least 14 microns or at least 15 microns or at least 16 microns or at least 17 microns or at least 18 microns or at least 19 microns or at least 20 microns or at least 21 microns or at least 22 microns or at least 23 microns or at least 24 microns or at least 25 microns or at least 26 microns or at least 27 microns or at least 28 microns or at least 29 microns or at least 30 microns or at least 31 microns or at least 32 microns or at least 33 microns or at least 34 microns or at least 35 microns or at least 36 microns or at least 37 microns or at least 38 microns or at least 39 microns or at least 40 microns or at least 41 microns or at least 42 microns or at least 43 microns or at least 44 microns or at least 45 microns or at least 46 microns or at least 47 microns or at least 48 microns or at least 49 microns or at least 50 microns or at least 51 microns or at least 52 microns or at least 53 microns or at least 54 microns or at least 55 microns or at least 56 microns or at least 57 microns or at least 58 microns or at least 59 microns or at least 60 microns or at least 65 microns or at least 70 microns or at least 75 microns or at least 80 microns or at least 85 microns or at least 90 microns or at least 95 microns or at least 100 microns or at least 110 microns or at least 120 microns or at least 130 microns or at least 140 microns or at least 150 microns or at least 160 microns or at least 170 microns or at least 180 microns or at least 190 microns or at least 200 microns or at least 210 microns or at least 220 microns or at least 230 microns or at least 240 microns or at least 250 microns. In still another non-limiting embodiment, the average compacted layer thickness may be not greater than 400 microns such as not greater than 300 microns or not greater than 200 microns or not greater than 100 microns or not greater than 90 microns or not greater than 80 microns or not greater than 70 microns or not greater than 60 microns or not greater than 50 microns or not greater than 40 microns or not greater than 30 microns or not greater than 20 microns or not greater than 15 microns or not greater than 10 microns or not greater than 8 microns or not greater than 5 microns or not greater than 3 microns or not greater than 1 micron or not greater than 0.8 microns. The average compacted layer thickness may be a value between any of the minimum and maximum values noted above, including for example, but not limited to, within a range of at least 0.1 microns to not greater than 400 microns or within a range of at least 1 micron to not greater than 200 microns or within a range of at least 5 microns to not greater than 90 microns.

In an embodiment, compacting may include increasing the density of the compacted layer by at least 2% as compared to the layer prior to compacting such as at least 3% or at least 4% or at least 5% or at least 6% or at least 7% or at least 8% or at least 9% or at least 10% or at least 11% or at least 12% or at least 13% or at least 14% or at least 15% or at least 18% or at least 20% or at least 22% or at least 25% or at least 28% or at least 30% or at least 32% or at least 35% or at least 38% or at least 40% or at least 42% or at least 45% or at least 48% or at least 50% or at least 52% or at least 55% or at least 58% or at least 60% or at least 62% or at least 65% or at least 67% or at least 68% or at least 70% or at least 72% or at least 75% or at least 78% or at least 80% or at least 82% or at least 85% or at least 88% or at least 90% or at least 92% or at least 95% or at least 98% or at least 100% or at least 102% or at least 105% or at least 108% or at least 110% or at least 115% or at least 120% or at least 125% or at least 130% or at least 140% or at least 150%. In still another non-limiting embodiment, compacting may include increasing the density of the compacted layer by not greater than 2000% as compared to the layer prior to compacting such as not greater than 1500% or not greater than 1000% or not greater than 900% or not greater than 800% or not greater than 700% or not greater than 600% or not greater than 500%. Compacting may include increasing the density of the compacted layer by any of the minimum and maximum percentages noted above as compared to the layer prior to compacting, including for example, but not limited to, within a range of at least 2% to not greater than 2000% or within a range of at least 13% to not greater than 1000%.

In an embodiment, compacting may include compacting the layer of powder material by at least 1% to not greater than 95% of the original layer thickness of the layer, such as compaction of at least 2% of the original layer thickness of the layer prior to compaction or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40% or at least 41% or at least 42% or at least 43% or at least 44% or at least 45% or at least 46% or at least 47% or at least 48% or at least 49% or at least 50% or at least 51% or at least 52% or at least 53% or at least 54% or at least 55% or at least 56% or at least 57% or at least 58% or at least 59% or at least 60% or at least 61% or at least 62% or at least 63% or at least 64% or at least 65% or at least 66% or at least 67% or at least 68% or at least 69% or at least 70% or at least 71% or at least 72% or at least 73% or at least 74% or at least 75% or at least 76% or at least 77% or at least 78% or at least 79% or at least 80% or at least 81% or at least 82% or at least 83% or at least 84% or at least 85% or at least 86% or at least 87% or at least 88% or at least 89% or at least 90% or at least 91% or at least 92% or at least 93% or at least 94%. In still another non-limiting embodiment, compacting may include compacting the layer of powder material by at least 1% to not greater than 95% of the original layer thickness of the layer, such as compaction of not greater than 94% of the original layer thickness of the layer prior to compaction or not greater than 93% or not greater than 92% or not greater than 91% or not greater than 90% or not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75% or not greater than 74% or not greater than 73% or not greater than 72% or not greater than 71% or not greater than 70% or not greater than 69% or not greater than 68% or not greater than 67% or not greater than 66% or not greater than 65% or not greater than 64% or not greater than 63% or not greater than 62% or not greater than 61% or not greater than 60% or not greater than 59% or not greater than 58% or not greater than 57% or not greater than 56% or not greater than 55% or not greater than 54% or not greater than 53% or not greater than 52% or not greater than 51% or not greater than 50% or not greater than 49% or not greater than 48% or not greater than 47% or not greater than 46% or not greater than 45% or not greater than 44% or not greater than 43% or not greater than 42% or not greater than 41% or not greater than 40% or not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2%. Compacting may include compacting the layer of powder material by any of the minimum and maximum percentages noted above.

FIG. 1C includes binding at least a portion 133 of the compacted layer of powder material 112 with a binder material 131. In one embodiment, the binder material 131 may be selectively deposited by a print head 132 or other suitable type of delivery mechanism. In an embodiment, binding at least a portion of the compacted layer may include the use of a printhead 132 wherein the printhead deposition resolution may impact the amount of binder material 131 selectively deposited. As further depicted, the layer may include a region 102 including loose or unbound powder material without binder material and a region 103 including a region of powder material and binder.

In an embodiment, the binder material may include a liquid vehicle and a polymer material wherein the polymer material can be dissolved in the liquid vehicle. In a particular embodiment, the liquid vehicle may include one or more organic solvents, water, or a combination thereof. In still another embodiment, the organic solvents may include at least one of alcohols (e.g., butanol, ethylene glycol monomethyl ether), ketones, ethers, or any combination thereof. In still another embodiment, the alcohol may include as methyl alcohol, ethyl alcohol, n-propyl alcohol, isopropyl alcohol, n-butyl alcohol, sec-butyl alcohol, t-butyl alcohol, and isobutyl alcohol; ketones or ketoalcohols such as acetone, methyl ethyl ketone, and diacetone alcohol; esters such as ethyl acetate and ethyl lactate; polyhydric alcohols such as ethylene glycol, diethylene glycol, triethylene glycol, propylene glycol, butylene glycol, 1,4-butanediol, 1,2,4-butanetriol, 1,5-pentanediol, 1,2,6-hexanetriol, hexylene glycol, glycerol, glycerol ethoxylate, trimethylolpropane ethoxylate; lower alkyl ethers such as ethylene glycol methyl or ethyl ether, diethylene glycol ethyl ether, triethylene glycol methyl or ethyl ether, ethylene glycol n-butyl ether, diethylene glycol n-butyl ether, diethylene glycol methyl ether, ethylene glycol phenyl ether, propylene glycol methyl ether, dipropylene glycol methyl ether, tripropylene glycol methyl ether, propylene glycol methyl ether acetate, dipropylene glycol methyl ether acetate, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, propylene glycol phenyl ether, and dipropylene glycol dimethyl ether; nitrogen-containing compounds such as 2-pyrrolidinone and N-methyl-2-pyrrolidinone; sulfur-containing compounds such as dimethyl sulfoxide, tetramethylene sulfone, and thioglycol; and combinations of any of the foregoing. In still another embodiment, the polymer may include at least one of polyvinyl pyrrolidones, polyvinyl caprolactams, polyvinyl alcohols, polyacrylamides, poly(2-ethyl-2-oxazoline) (PEOX), polyvinyl butyrate, copolymers of methyl vinyl ether, and maleic anhydride, certain copolymers of acrylic acid and/or hydroxyethyl acrylate, methyl cellulose, natural polymers (e.g., dextrin, guar gum, xanthan gum). In an embodiment, the binder material may include one or more free-radically polymerizable or otherwise radiation-curable materials, including at least one of acrylic monomers and/or oligomers and/or epoxy resins, a photoinitiator, and/or photocatalysts for curing the free-radically polymerizable or otherwise radiation-curable materials. In a particular embodiment, the organic solvents may have a flash point above 100° C. In an aspect, the one or more organic solvents may be configured to control drying speed of the liquid vehicle, to control surface tension of the liquid vehicle, or to allow dissolution of an ingredient (e.g., of a surfactant).

The amount of binder material may be sufficient to bind the powder material. The regions 134 that do not include binder material 131 can be loose or unbound powder, which may be removed and captured after processing is completed and used as recycled powder. Notably, at the edges of the region between the bound powder material and unbound powder material, the binder material may exist in some of the loose powder. Accordingly, as described in claimed embodiments herein, the recycled powder may include some content of organic material, such as binder material that was included in the captured loose or unbound powder material, particularly at the regions bordering the bound and unbound powder. Methods may be used to treat the loose powder material, including organic material, to remove a certain content of organic material prior to recycling the powder material and using in one or more subsequent additive manufacturing processes to form abrasive articles.

FIG. 1D includes a process for binding the powder material by treating the layer to convert the binder 131 in the bound portion 133 from a liquid material to a solid material to bind the powder material. The process can include curing of at least a portion of the binder material as claimed in embodiments herein.

In an embodiment, forming the green body abrasive article may be conducted at a forming rate that may facilitate improved manufacturing and/or performance of the abrasive article. In an embodiment, forming the green body abrasive article may be conducted at a forming rate of at least 120 cc/hr such as at least 130 cc/hr or at least 150 cc/hr or at least 180 cc/hr or at least 200 cc/hr or at least 300 cc/hr or at least 400 cc/hr or at least 500 cc/hr or at least 600 cc/hr or at least 700 cc/hr or at least 800 cc/hr or at least 900 cc/hr or at least 1000 cc/hr or at least 1200 cc/hr or at least 1400 cc/hr or at least 1600 cc/hr or at least 1800 cc/hr or at least 2000 cc/hr or at least 2200 cc/hr or at least 2400 cc/hr or at least 2600 cc/hr or at least 2800 cc/hr or at least 3000 cc/hr. In still another embodiment, the forming rate may be not greater than 7000 cc/hr such a not greater than 6000 cc/hr or not greater than 5000 cc/hr or not greater than 4000 cc/hr. It will be appreciated the forming rate may be between any of the minimum and maximum values noted above, including for example, but not limited to, within a range of at least 120 cc/hr to not greater than 7000 cc/hr such as within a range of at least 200 cc/hr to not greater than 5000 cc/hr or at least 800 cc/hr to not greater than 3000 cc/hr.

FIG. 1E is an illustration of an abrasive article, which may represent a green body or finally-formed abrasive article. It will be appreciated that the abrasive articles of the embodiments herein can have any three-dimensional shape and FIG. 1E is illustrative of only one possible shape. The length (L) defines the longest dimension of the body and the width (W) defines a dimension of the body substantially perpendicular to the length and may be a value less than the length and greater than the thickness (T). The thickness (T) of the body may extend in a direction perpendicular to a plane defined by the length and width. The dimensions of any body of embodiments herein may have a relationship of length, width, and thickness defined as L≥W≥T. In those instances, wherein the body is in the form of a cylinder with the axial axis being the longest, the length is the longest dimension in the axial direction, the width can be a first diameter of an end surface, and the thickness can be another diameter. In the case of an abrasive article in the form of a disk, wherein the diameter is the greatest dimension, the diameter defines the length of the body, the width defines a diameter perpendicular to the length (and may be the same as the length, and the thickness defines the dimension of the body in an axial direction perpendicular to the plane of the circular end surface. It will be appreciated reference to a length may be reference to a diameter of a circular shape or surface or reference to a primary axis of an elliptical shape or surface. It will also be appreciated reference to a width may be reference to a diameter of a circular shape or surface that is substantially perpendicular to a diameter defining the length or reference to a lateral (secondary) axis of an elliptical shape or surface that extends substantially perpendicular to the primary axis.

In an embodiment, the green body may include a content of abrasive particles that may facilitate improved manufacturing and/or performance of the abrasive article. In an embodiment, the green body may include at least 1 vol % abrasive particles for a total volume of the green body such as at least 2 vol % or at least 3 vol % or at least 4 vol % or at least 5 vol % or at least 6 vol % or at least 7 vol % or at least 8 vol % or at least 9 vol % or at least 10 vol % or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % or at least 31 vol % or at least 32 vol % or at least 33 vol % or at least 34 vol % or at least 35 vol % or at least 36 vol % or at least 37 vol % or at least 38 vol % or at least 39 vol % or at least 40 vol % or at least 41 vol % or at least 42 vol % or at least 43 vol % or at least 44 vol % or at least 45 vol % or at least 46 vol % or at least 47 vol % or at least 48 vol % or at least 49 vol % or at least 50 vol % or at least 51 vol % or at least 52 vol % or at least 53 vol % or at least 54 vol % or at least 55 vol % or at least 56 vol % or at least 57 vol % or at least 58 vol % or at least 59 vol % or at least 60 vol % or at least 61 vol % or at least 62 vol % or at least 63 vol % or at least 64 vol % or at least 65 vol % or at least 66 vol % or at least 67 vol % or at least 68 vol % or at least 69 vol % or at least 70 vol % or at least 71 vol % or at least 72 vol % or at least 73 vol % or at least 74 vol % or at least 75 vol % or at least 76 vol % or at least 77 vol % or at least 78 vol % or at least 79 vol % or at least 80 vol %. In still other embodiment, the green body may include not greater than 90 vol % abrasive particles for a total volume of the green body such as not greater than 85 vol % or not greater than 80 vol % or not greater than 75 vol % or not greater than 70 vol % or not greater than 69 vol % or not greater than 68 vol % or not greater than 67 vol % or not greater than 66 vol % or not greater than 65 vol % or not greater than 64 vol % or not greater than 63 vol % or not greater than 62 vol % or not greater than 61 vol % or not greater than 60 vol % or not greater than 59 vol % or not greater than 58 vol % or not greater than 57 vol % or not greater than 56 vol % or not greater than 55 vol % or not greater than 54 vol % or not greater than 53 vol % or not greater than 52 vol % or not greater than 51 vol % or not greater than 50 vol % or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % or not greater than 29 vol % or not greater than 28 vol % or not greater than 27 vol % or not greater than 26 vol % or not greater than 25 vol % or not greater than 24 vol % or not greater than 23 vol % or not greater than 22 vol % or not greater than 21 vol % or not greater than 20 vol % or not greater than 19 vol % or not greater than 18 vol % or not greater than 17 vol % or not greater than 16 vol % or not greater than 15 vol % or not greater than 14 vol % or not greater than 13 vol % or not greater than 12 vol % or not greater than 11 vol % or not greater than 10 vol % or not greater than 9 vol % or not greater than 8 vol % or not greater than 7 vol % or not greater than 6 vol % or not greater than 5 vol %. It will be appreciated the green body may include a percentage of abrasive particles for a total volume of the green body between any of the minimum and maximum values noted above, including for example, but not limited to, within a range of at least 1 vol % to not greater than 99 vol % abrasive particles for a total volume of the green body such as at least 2 vol % to not greater than 80 vol % or at least 10 vol % to not greater than 75 vol %.

In an embodiment, the green body may include a content of precursor bond material that may facilitate improved manufacturing and/or performance of the abrasive article. In an embodiment, the green body may include at least 1 vol % precursor bond material for a total volume of the green body such as at least 2 vol % or at least 3 vol % or at least 4 vol % or at least 5 vol % or at least 6 vol % or at least 7 vol % or at least 8 vol % or at least 9 vol % or at least 10 vol % or at least 11 vol % or at least 12 vol % or at least 13 vol % or at least 14 vol % or at least 15 vol % or at least 16 vol % or at least 17 vol % or at least 18 vol % or at least 19 vol % or at least 20 vol % or at least 21 vol % or at least 22 vol % or at least 23 vol % or at least 24 vol % or at least 25 vol % or at least 26 vol % or at least 27 vol % or at least 28 vol % or at least 29 vol % or at least 30 vol % or at least 31 vol % or at least 32 vol % or at least 33 vol % or at least 34 vol % or at least 35 vol % or at least 36 vol % or at least 37 vol % or at least 38 vol % or at least 39 vol % or at least 40 vol % or at least 41 vol % or at least 42 vol % or at least 43 vol % or at least 44 vol % or at least 45 vol % or at least 46 vol % or at least 47 vol % or at least 48 vol % or at least 49 vol % or at least 50 vol % or at least 51 vol % or at least 52 vol % or at least 53 vol % or at least 54 vol % or at least 55 vol % or at least 56 vol % or at least 57 vol % or at least 58 vol % or at least 59 vol % or at least 60 vol % or at least 61 vol % or at least 62 vol % or at least 63 vol % or at least 64 vol % or at least 65 vol % or at least 66 vol % or at least 67 vol % or at least 68 vol % or at least 69 vol % or at least 70 vol % or at least 71 vol % or at least 72 vol % or at least 73 vol % or at least 74 vol % or at least 75 vol % or at least 76 vol % or at least 77 vol % or at least 78 vol % or at least 79 vol % or at least 80 vol %. In still other embodiment, the green body may include not greater than 90 vol % precursor bond material for a total volume of the green body such as not greater than 85 vol % or not greater than 80 vol % or not greater than 75 vol % or not greater than 70 vol % or not greater than 69 vol % or not greater than 68 vol % or not greater than 67 vol % or not greater than 66 vol % or not greater than 65 vol % or not greater than 64 vol % or not greater than 63 vol % or not greater than 62 vol % or not greater than 61 vol % or not greater than 60 vol % or not greater than 59 vol % or not greater than 58 vol % or not greater than 57 vol % or not greater than 56 vol % or not greater than 55 vol % or not greater than 54 vol % or not greater than 53 vol % or not greater than 52 vol % or not greater than 51 vol % or not greater than 50 vol % or not greater than 49 vol % or not greater than 48 vol % or not greater than 47 vol % or not greater than 46 vol % or not greater than 45 vol % or not greater than 44 vol % or not greater than 43 vol % or not greater than 42 vol % or not greater than 41 vol % or not greater than 40 vol % or not greater than 39 vol % or not greater than 38 vol % or not greater than 37 vol % or not greater than 36 vol % or not greater than 35 vol % or not greater than 34 vol % or not greater than 33 vol % or not greater than 32 vol % or not greater than 31 vol % or not greater than 30 vol % or not greater than 29 vol % or not greater than 28 vol % or not greater than 27 vol % or not greater than 26 vol % or not greater than 25 vol % or not greater than 24 vol % or not greater than 23 vol % or not greater than 22 vol % or not greater than 21 vol % or not greater than 20 vol % or not greater than 19 vol % or not greater than 18 vol % or not greater than 17 vol % or not greater than 16 vol % or not greater than 15 vol % or not greater than 14 vol % or not greater than 13 vol % or not greater than 12 vol % or not greater than 11 vol % or not greater than 10 vol % or not greater than 9 vol % or not greater than 8 vol % or not greater than 7 vol % or not greater than 6 vol % or not greater than 5 vol %. It will be appreciated the green body may include a percentage of precursor bond material for a total volume of the green body between any of the minimum and maximum values noted above, including for example, but not limited to, within a range of at least 1 vol % to not greater than 99 vol % precursor bond material for a total volume of the green body such as at least 2 vol % to not greater than 80 vol % or at least 10 vol % to not greater than 75 vol %.

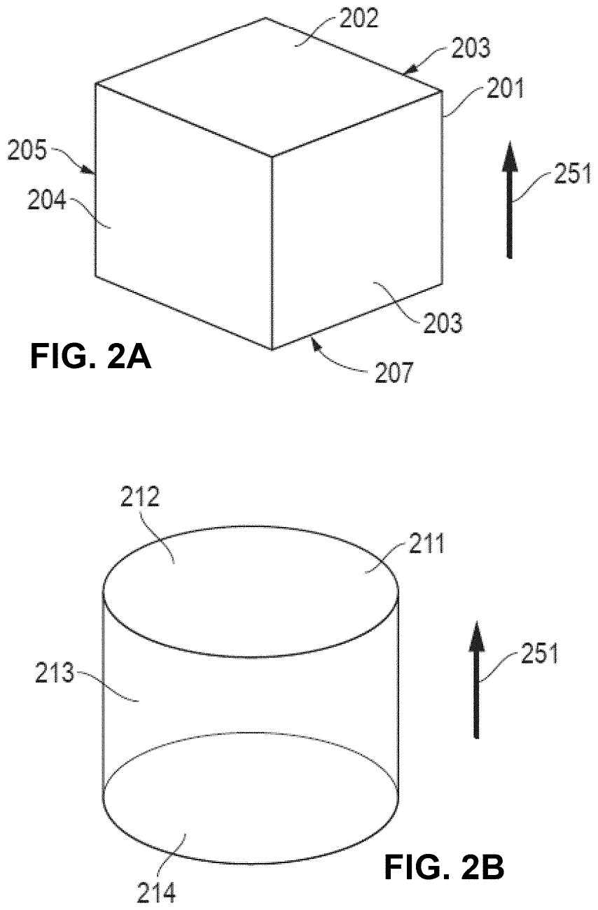

FIGS. 2A and 2B include perspective view illustrations of abrasive articles, which may be green bodies or finally-formed abrasive articles according to embodiments herein. The bodies of FIGS. 2A and 2B can be formed by any of the methods of the embodiments herein, and formed in a build direction 251. The body 201 can have surfaces 201, 203, 204, 205 that are transverse relative to the build direction and surfaces that are not transverse to the build direction 202 and 207. The body 211 can be in the shape of a cylinder having a surface 213 transversely relative to the build direction and surfaces 212 and 214 that are not transverse to the build direction. It will be appreciated that the abrasive articles may be in any number of shapes and not limited to those explicitly shown herein. It will be appreciated that the bodies may be formed using a variety of build directions. In certain embodiments, the build direction may impact certain features of the abrasive articles, as green body abrasive articles and/or finally-formed abrasive articles. In certain instances, the transverse surfaces may have a different Sdr than the other surfaces. In an embodiment, the transverse surfaces may have a higher Sdr than surfaces having a different orientation to the transverse surfaces, and more specifically, surfaces having different orientations relative to the build direction 251. It will be appreciated that the build direction may be manipulated to control which surfaces have a relatively high or low Sdr. For example, an abrasive may be constructed such that the smallest surfaces are not transverse to the build direction, minimizing the amount of surface area with a low Sdr. Different Sdr values may be valuable for different applications. For example, a high Sdr surface may be useful as an abrasive working surface in low pressure grinding applications. A high or low Sdr surface may also more easily bind or adhere to a substrate or another surface using a binder, an adhesive, or other coupling means, depending on the composition of the coupling means. In an embodiment, a transverse surface can be an abrasive working surface of the body. In another embodiment, a surface that is not a transverse surface can be an abrasive working surface of the body. In embodiments, either a transverse surface or a surface that is not transverse can be coupled to another surface via a binder or adhesive. In an embodiment, the transverse surfaces may have visible layering or roughness that is not present on the other surfaces.

FIG. 3 includes an illustration of the measuring principle of the developed interfacial area ratio Sdr. The developed interfacial area ratio Sdr expresses the percent increase in surface area 301 (provided by the surface texture) in relation to a corresponding underlying projected area 302 (ideal flat plane), and was measured according to ISO standard method ISO25178-2:2012.

The developed interfacial area ratio Sdr expresses the percentage rate of an increase in a surface area A₁ 301 that is related to the surface texture in comparison to a projected area A₀ 702, wherein A₀ 302 corresponds to an ideal plane underneath the measured surface texture. An illustration of the relation of surface area A₁ 301 to projected area A₀ 302 is shown in FIG. 3. The Sdr measurements were conducted with an Olympus LEXT OLS5000 laser confocal microscope. The analyzed surface area was 257×257 μm, at a 50 times magnification, with a filter cylinder. Four measurements per sample were conducted at different locations and an average Sdr value was calculated according to the equation:

$$= \frac{1}{A} [ \int {\int }_{A} ( \sqrt{[ 1 + {( \frac{\partial z ( x , y )}{\partial x} )}^{2} + {( \frac{δ z ( x , y )}{δ y} )}^{2} ]} - 1 ) dxdy ] .$$

The Sdr can be also expressed by the following formula: Sdr=[(A₁/A₀)−1]×100(%).

In an embodiment, the additive manufacturing process can be performed with a specific printer head deposition resolution that may result in improved manufacturing or performance of the abrasive body. It will be appreciated that the printhead deposition resolution may be between any of the minimum and maximum values claimed herein. Without wishing to be tied to one theory, some data suggests that manipulating the resolution may alter the Sdr on the surfaces of the body. A small resolution may lead to a smaller Sdr on surfaces transverse to the build direction, as well as a smaller difference in Sdr between transverse surfaces and surfaces that are not transverse to the build direction. The same may be true for the thickness of the layers before and/or after compaction.

In one aspect, the additive manufacturing process can include using as starting material a powder material having a multi-modal particle distribution. The multimodal particle size distribution of the powder material may be related to different sizes of a single phase material or creation of a mixture from different powder components, including, for example, but not limited to, a mixture including a first particulate material (e.g., abrasive particles having a first particle size distribution) and a second particulate material (e.g., particulate bond material or bond material precursor having a second particle size distribution that is different from the first particle size distribution).

In one particular aspect, the powder material for the additive manufacturing process can be bi-modal particle distribution, wherein a first plurality of particles can have an average particle size (D50) of at least 1 μm and not greater than 10 μm, and a second plurality of particles can have an average particle size (D50) of at least 20 μm and not greater than 50 μm.

In another aspect, a weight % ratio of the first plurality of particles to the second plurality of particles can be from 1:0.1 to 1:10. In certain aspects, the weight % ratio can be not greater than 1:0.3, such as not greater than 1:0.5 or not greater than 1:1 or not greater than 1:2 or not greater than 1:3 or not greater than 1:4 or not greater than 1:5 or not greater than 1:6 or not greater than 1:7 or not greater than 1:8 or not greater than 1:9 or not greater than 1:10.

In an embodiment, the finally-formed abrasive body resulting from further processing of the green abrasive article body may have the same amount (vol %) of abrasive particles as the embodiments describing the amount of abrasive particles in the green abrasive article body.

In an embodiment, the abrasive particles can include oxides, carbides, nitrides, borides, diamonds, or any combination thereof. In an embodiment, the abrasive particles can include alumina, zirconia, ceria, diamond, or any combination thereof.

In an embodiment, the body can include a bond material or bond material precursor comprising an organic material or inorganic material or any combination thereof. In an embodiment, the bond material can comprise thermoplastics, thermosets, resins, or any combination thereof. In an embodiment, the bond material can comprise phenolic resin, polyimides, polyamides, polyesters, aramids, epoxies, or any combination thereof. In an embodiment, the bond material can comprise a transition metal element. The fixed abrasive article of claim 33, wherein the bond material comprises an amorphous phase, polycrystalline phase, or any combination thereof. In an embodiment, the bond material can comprise ceramic material, vitreous material, or any combination thereof, or wherein the ceramic material is polycrystalline, or wherein the vitreous material is amorphous. In an embodiment, the bond material can comprise an oxide. In an embodiment, the bond material can comprise an alumina-containing vitreous material. In an embodiment, the bond material can comprise silica-containing vitreous material. In an embodiment, the bond material can comprise at least one of alumina, silica, boron oxide, bismuth oxide, zinc oxide, barium oxide, magnesium oxide, calcium oxide, lithium oxide, sodium oxide, potassium oxide, cesium oxide, strontium oxide, zirconium oxide, manganese oxide, or any combinations thereof.

In an embodiment, an abrasive body can have a first surface having a first (Sdr1) and a second surface having a second developed interfacial area ratio (Sdr2). In an embodiment, Sdr1 can be greater than Sdr2. In another embodiment, Sdr1 can be less than Sdr2. In an embodiment, the first surface can be a transverse surface relative to the build direction of the abrasive article.

In an embodiment, a certain percentage of the surface area of the body can be a relatively high Sdr surface. It will be understood that a surface with a relatively high Sdr has an Sdr greater than the average Sdr of the entire body. In an embodiment at least 5% of the exterior surface area of the body can be a relatively high Sdr surface or at least 7% or at least 10% or at least 12% or at least 14% or at least 16% or at least 20% or at least 22% or at least 24% or at least 26% or at least 28% or at least 30% or at least 32% or at least 34% or at least 36% or at least 38% or at least 40% or at least 42% or at least 44% or at least 46% or at least 48% or at least 50% or at least 52% or at least 54% or at least 56% or at least 58% or at least 60% or at least 62% or at least 64% or at least 66% or at least 68% or at least 70% or at least 72% or at least 74% or at least 76% or at least 78% or at least 80% or at least 82% or at least 84% or at least 86% or at least 88% or at least 90% or at least 93% or at least 95%. In an embodiment not greater than 95% of the exterior surface area of the body can be a relatively high Sdr surface or not greater than 93% or not greater than 90% or not greater than 88% or not greater than 86% or not greater than 84% or not greater than 82% or not greater than 80% or not greater than 78% or not greater than 76% or not greater than 74% or not greater than 72% or not greater than 70% or not greater than 68% or not greater than 66% or not greater than 64% or not greater than 62% or not greater than 60% or not greater than 58% or not greater than 56% or not greater than 54% or not greater than 52% or not greater than 50% or not greater than 48% or not greater than 46% or not greater than 44% or not greater than 42% or not greater than 40% or not greater than 38% or not greater than 36% or not greater than 34% or not greater than 32% or not greater than 30% or not greater than 28%, or not greater than 26% or not greater than 24% or not greater than 22% or not greater than 20% or not greater than 18% or not greater than 16% or not greater than 14% or not greater than 10% or not greater than 7% or not greater than 5%. It will be appreciated that the percent of surface area with a relatively high Sdr can be between any of the minimum and maximum values noted above.

In an embodiment, the first surface may have a particular Sdr1 that may facilitate improved performance and/or manufacturing of the abrasive article. In an embodiment, Sdr1 may be at least 40% or at least 42% or at least 44% or at least 46% or at least 48% or at least 50% or at least 52% or at least 54% or at least 56% or at least 58% or at least 60% or at least 62% or at least 64% or at least 66% or at least 68% or at least 70%. In another embodiment, Sdr1 is not greater than 140% or not greater than 135% or not greater than 130% or not greater than 125% or not greater than 120% or not greater than 115% or not greater than 110% or not greater than 105% or not greater than 100% or not greater than 95% or not greater than 90% or not greater than 85% or not greater than 80%. It will be appreciated that Sdr1 will be between any of the minimum and maximum values noted above.

In an embodiment, the abrasive body may have a second surface with a particular Sdr2 that may facilitate improved performance of the abrasive article. In an embodiment, Sdr2 may be not greater than 110% or not greater than 105% or not greater than 100% or not greater than 95% or not greater than 90% or not greater than 85% or not greater than 80% or not greater than 75%. In another embodiment, Sdr2 is at least 5%, at least 10%, at least 15%, at least 20%, at least 25%, at least 30% or at least 35% or at least 40% or at least 45%. It will be appreciated that Sdr2 will be between any of the minimum and maximum values noted above.

In an embodiment, a first surface can have an Sdr1 that is different than the Sdr2 of a second surface by a particular amount that may facilitate improved manufacturing or performance of the abrasives article. In one non-limiting embodiment, Sdr1 can have a value that is greater relative to Sdr2. In an embodiment, the first surface can have an Sdr1 that is at least 1% different than Sdr2 or at least 2% or at least 3% or at least 4% or at least 5% or at least 6% or at least 7% or at least 8% or at least 9% or at least 10%, different than the Sdr2 of the second surface. In another embodiment, the first surface can have an Sdr1 that is not greater than 25% different than Sdr2 or not greater than 24% or not greater than 23% or not greater than 22% or not greater than 21% or not greater than 20% or not greater than 19% or not greater than 18% or not greater than 17% or not greater than 16% or not greater than 15% different than Sdr2. It will be appreciated that the percent difference between Sdr1 and Sdr2 can be between any of the minimum and maximum values noted above. It will be appreciated that there may be more than two surfaces with different Sdr values, and the differences noted above in Sdr1 and Sdr2 can be equally applicable between two or more surfaces (e.g., exterior surfaces) of a body.

In an embodiment, the ratio of Sdr1:Sdr2 can be not greater than 1:2 or not greater than 1:1.9 or not greater than 1:1.8 or not greater than 1:1.7 or not greater than 1:1.6 or not greater than 1:1.5 or not greater than 1:1.4 or not greater than 1:1.3. In an embodiment the ratio of Sdr1:Sdr2 can be at least 1:1.01 or at least 1:1.03 or at least 1:1.05.

In an embodiment, the first surface, optionally a working surface may be oriented at a particular angle relative to the second surface. The angle can be at least 2°, at least 5°, at least 8°, at least 10°, at least 12°, at least 15°, at least 18°, at least 19°, at least 20°, at least 22°, at least 25°, at least 27°, at least 30°, at least 33°, at least 35°, at least 37°, at least 40°, at least 41°, at least 43°, at least 45°, at least 47°, at least 48°, at least 50°, at least 52°, at least 55°, at least 58°, at least 60°, at least 62°, at least 64°, at least 66°, at least 68°, at least 70°, at least 72°, at least 74°, at least 76°, at least 78°, at least 80°, at least 82°, at least 85°, at least 88°, or at least 90°. In another embodiment, the angle can be at most 180°, at most 178°, at most 176°, at most 174°, at most 172°, at most 170°, at most 168°, at most 166°, at most 164°, at most 162°, at most 160°, at most 158°, at most 156°, at most 154°, at most 152°, at most 150°, at most 147°, at most 145°, at most 143°, at most 140°, at most 138°, at most 135°, at most 133°, at most 130°, at most 127°, at most 124°, at most 1210, at most 118°, at most 115°, at most 112°, at most 109°, at most 105°, at most 102°, at most 99°, at most 96°, at most 93°, at most 90°, such as at most 88°, at most 86°, at most 84°, at most 82°, at most 80°, at most 78°, at most 75°, at most 74°, at most 72°, at most 70°, at most 68°, at most 66°, at most 64°, at most 62°, at most 60°, at most 58°, at most 66°, at most 64°, at most 62°, at most 60°, at most 58°, at most 55°, at most 54°, at most 52°, at most 50°, at most 48°, at most 46°, at most 44°, at most 42°, at most 40°, at most 38°, at most 36°, at most 34°, at most 32°, or at most 30°. It will be appreciated that the angle between the first surface and the second surface may be between any of the minimum and maximum values noted above. In a non-limiting embodiment, the first surface and the second surface may be orthogonal to each other.

In an embodiment, the first surface may have a particular surface roughness (Sa1) that may facilitate improved performance and/or manufacturing of the abrasive body. In an embodiment, Sa1 may be at least 1 micron or at least 1.5 microns or at least 2 microns or at least 2.5 microns or at least 3 microns or at least 3.5 microns or at least 4 microns or at least 4.5 microns or at least 5 microns. In another embodiment, Sa1 may not be greater than 30 microns, such as not greater than 28 microns or not greater than 25 microns or not greater than 22 microns or not greater than 18 microns or not greater than 15 microns. It will be appreciated that Sa1 may be between any of the minimum and maximum values noted above.

In an embodiment, the second surface may have a particular surface roughness (Sa2) that may facilitate improved performance and/or manufacturing of the abrasive body. In an embodiment, Sa2 may be at least 1 micron, such as at least 2 microns or at least 3 microns or at least 4 microns or at least 5 microns. In another embodiment, Sa2 may not be greater than 25 microns, such as not greater than 23 microns or not greater than 21 microns or not greater than 19 microns or not greater than 17 microns or not greater than 15 microns or not greater than 14 microns or not greater than 13 microns. It will be appreciated that Sa2 may be between any of the minimum and maximum values noted above.

In an embodiment, a first surface can have a Sa1 that is different than the Sa2 of a second surface by a particular amount that may facilitate improved manufacturing or performance of the abrasive article. In an embodiment, the first surface can have a Sa1 that is at least 0.2 microns different than the Sdr2 of the second surface, such as at least 0.4 microns or at least 0.6 microns or at least 0.8 microns or at least 1 micron. In another embodiment, the first surface can have a Sa1 that is not greater than 6 microns different than Sa2 or not greater than 5.5 microns or not greater than 5 microns or not greater than 4.5 microns or not greater than 4 microns or not greater than 3.5 microns or not greater than 3 microns different than Sa2. It will be appreciated that the percent difference between Sa1 and Sa2 can be between any of the minimum and maximum values noted above.

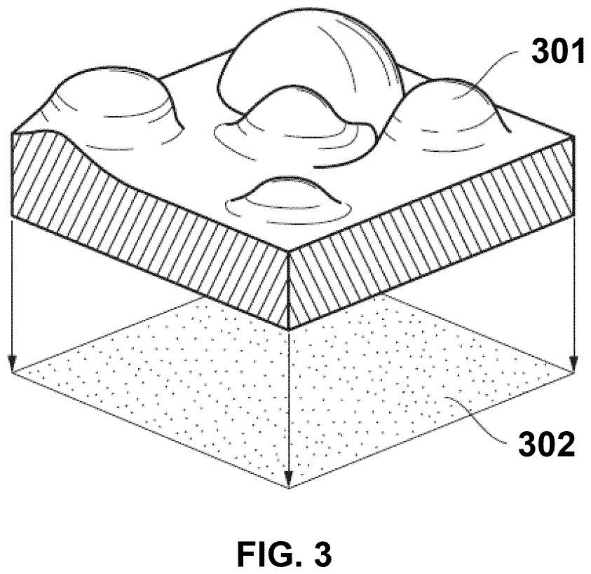

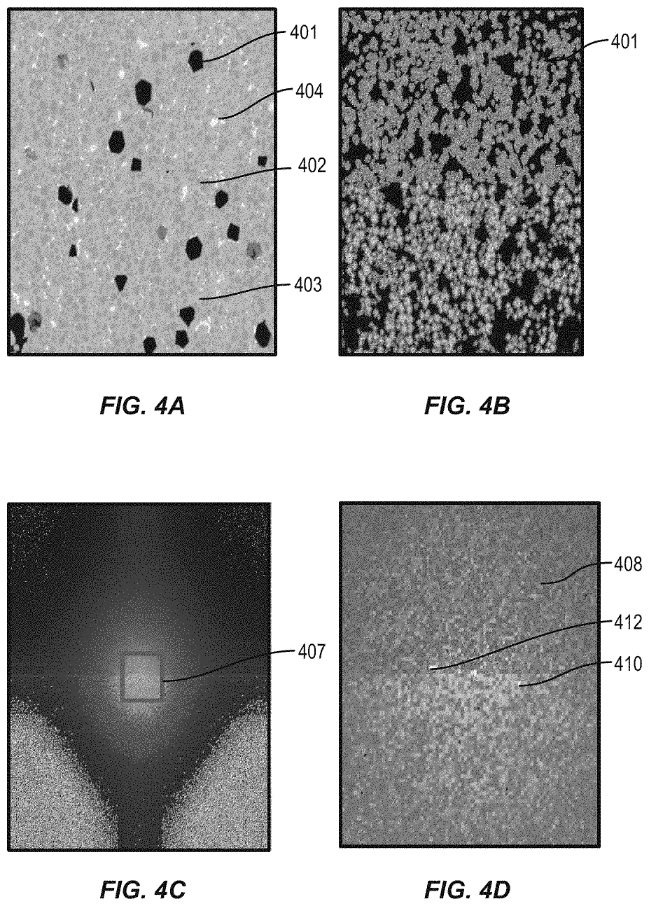

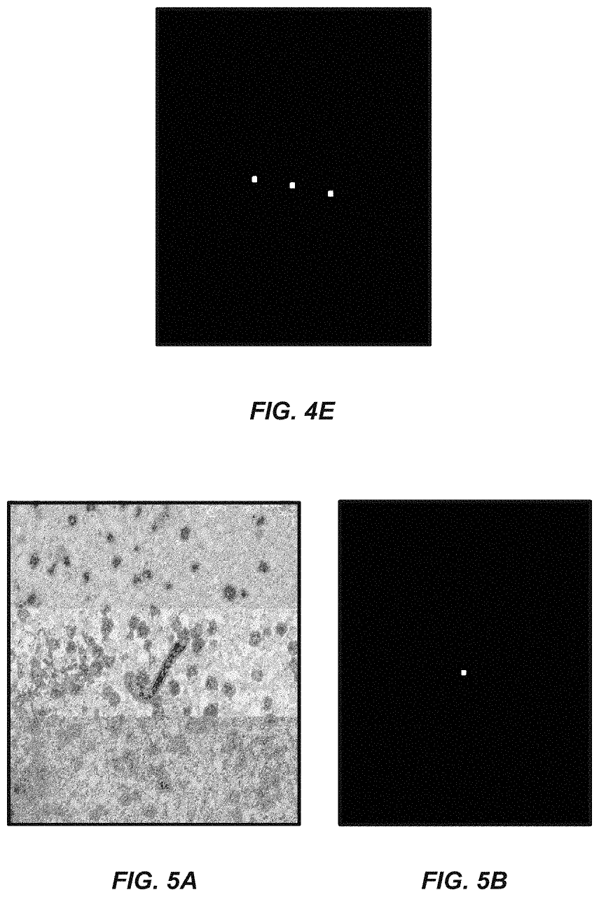

The frequency domain images are obtained by utilizing the Fourier Transform through Python to process the SEM images. Three SEM images of three cross sections of a bonded abrasive body are taken. FIGS. 4A to 4E include images of a cross section of a body of a finally-formed abrasive article formed in accordance with an additive manufacturing technique. FIG. 4A includes a scanning electron microscopic image of a cross section of a body. As illustrated, the abrasive body can include abrasive particles 401 joined by a bond matrix including a bond material 402 and an infiltrant material 403, and a filler material 404. FIG. 4A can be processed by adjusting the threshold such that only the bond material remains present in the image of FIG. 4B. FIG. 4C includes an image that has been further processed by focusing on the center, the brightest area, of FIG. 4B. FIG. 4D is an image of the magnified area within the box 407 in FIG. 4C. As illustrated in FIG. 4D, noise 408 is in greyscale, and frequency signals 410 and 412 have brightness above the noise. Removing the noise from FIG. 4D, a frequency domain image is generated and illustrated in FIG. 4E. The bright dot in the center is the zero frequency component indicating the average brightness of the image in FIG. 4B, and the other two symmetrically distributed bright dots represent the frequency of the bond material 402. The Fast Fourier Transform value refers to the average number of dots other than the zero frequency components shown in frequency domain images of at least three cross-sectional images from the same body. For example, the Microstructure Feature value can be determined by dividing the sum of the number of dots that are not the center dot of each frequency domain image by the total number of the frequency domain images.

In an embodiment, the body of the abrasive article may include a Microstructure Feature value that may facilitate improved performance of the abrasive article. In an embodiment, the Microstructure Feature may be at least 1, such as at least 2 or at least 3 or at least 4 or at least 5 or at least 6 or at least 7. In still another embodiment, the Microstructure Feature may be not greater than 10 or not greater than 9 or not greater than 8 or not greater than 7 or not greater than 6 or not greater than 5 or not greater than 4 or not greater than 3. It will be appreciated the Microstructure Feature may be a value between and of the minimum and maximum values noted above, including, for example, within a range of at least 1 to not greater than 10 or within a range of at least 2 and not greater than 10.

In a further embodiment, the Microstructure Feature can include a Spacing Value. The abrasive body can include an average distance determined based on frequency domain images (i.e., the image of FIG. 4E) of at least three cross-sectional images of the body of an abrasive article. As used herein, the Spacing Value can be determined using the average distance. The average distance is an averaged value of the distance between the zero frequency component (i.e., the center dot) and one other dot of frequency domain images of at least three cross-sections of the abrasive body. For example, the average distance can be calculated by dividing the total of the distance between the center dot and one other dot of each of the frequency domain images by the number of the distances that make up the total. The Spacing Value of an abrasive body can be a relative value that can be obtained by dividing the average distance of the abrasive body by the average distance of an abrasive body having layers having the printed thickness of 120 microns.

More particularly, the Spacing Value can be determined as follows. The bonded abrasive body includes layers having a printed thickness of 120 microns. All the SEM images are processed to obtain images illustrated in FIG. 4E. As illustrated in the frequency domain image of FIG. 4E, the distance from the center of the center dot to the center of one other dot is measured using Image J for each of the frequency domain image. The average of the 3 distances is calculated and referred to as Dal. The average distance is then divided by itself to have a Spacing Value of the body.

In still another embodiment, the body of the abrasive article may include a Microstructure Feature including a Spacing Value that may facilitate improved performance of the abrasive article. In an embodiment, the Spacing Value may be at least 0.01 or at least 0.03 or at least 0.04 or at least 0.06 or at least 0.08 or at least 0.1 or at least 0.2, at least 0.3 or at least 0.4 or at least 0.5 or at least 0.6 or at least 0.7 or at least 0.8 or at least 0.9 or at least 1, at least 1.1 or at least 1.3 or at least 1.4 or at least 1.5 or at least 1.6 or at least 1.8 or at least 1.9 or at least 2 or at least 2.1 or at least 2.3 or at least 2.5 or at least 2.6 or at least 2.8 or at least 3 or at least 3.1 or at least 3.3 or at least 3.5 or at least 3.6 or at least 3.8 or at least 4, at least 4.2 or at least 4.5 or at least 4.7, or at least 5 or at least 6 or at least 7 or at least 8 or at least 9 or at least 10 or at least 11 or at least 12 or at least 15 or at least 20 or at least 30 or at least or at least 80 or at least 100 or at least 200 or at least 300 or at least 400 or at least 500. In still another embodiment, the spacing value may be not greater than 2000 or not greater than 1000 or not greater than 500 or not greater than 400 or not greater than 300 or not greater than 200 or not greater than 100 or not greater than 80 or not greater than 50 or not greater than 40 or not greater than 30 or not greater than 20 or not greater than 10 or not greater than 9.8, not greater than 9.6, not greater than 9.5, not greater than 9.3 or not greater than 9 or not greater than 8.8, not greater than 8.6, not greater than 8.4, not greater than 8.2 or not greater than 8 or not greater than 7.8, not greater than 7.6, not greater than 7.4, not greater than 7.2 or not greater than 7 or not greater than 6.8, not greater than 6.6, not greater than 6.4, not greater than 6.2 or not greater than 6 or not greater than 5.8, not greater than 5.6, not greater than 5.5, not greater than 5.2 or not greater than 5 or not greater than 4.8, not greater than 4.6, not greater than 4.4, not greater than 4.2 or not greater than 4 or not greater than 3.8, not greater than 3.6, not greater than 3.4, not greater than 3.2 or not greater than 3 or not greater than 2.8, not greater than 2.6, not greater than 2.4, not greater than 2.2 or not greater than 2 or not greater than 1.8 or not greater than 1.6 or not greater than 1.5 or not greater than 1.4 or not greater than 1.3 or not greater than 1.2 or not greater than 1 or not greater than 0.8, not greater than 0.6, not greater than 0.4, not greater than 0.2 or not greater than 0.1. It will be appreciated the spacing value may be a value between and of the minimum and maximum values noted above, including, for example, within a range of at least 1 to not greater than 1000.

FIGS. 5A and 5B represent images from a bonded abrasive formed through conventional processing techniques of hot pressing. FIG. 5A is a cross-sectional SEM image processed in the same manner as noted above according to the Fast Fourier Transform to obtain the image of FIG. 5B. The Microstructure Feature value of the sample is 1.

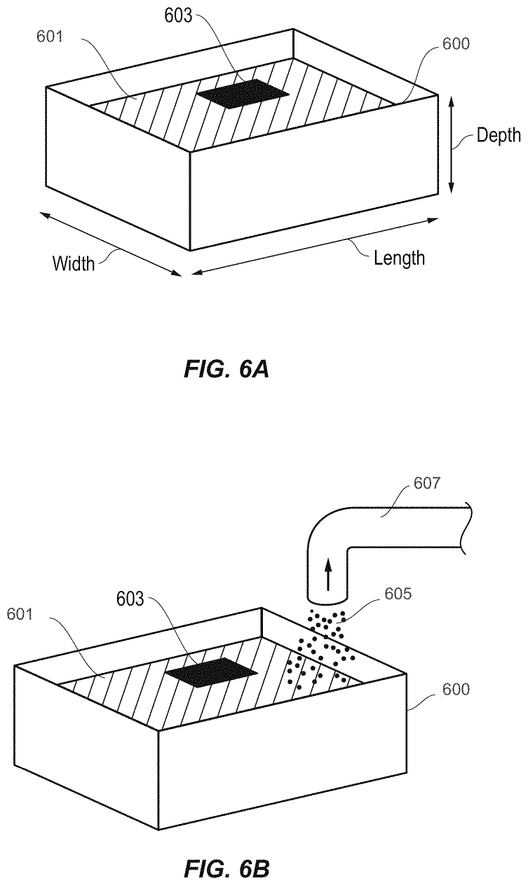

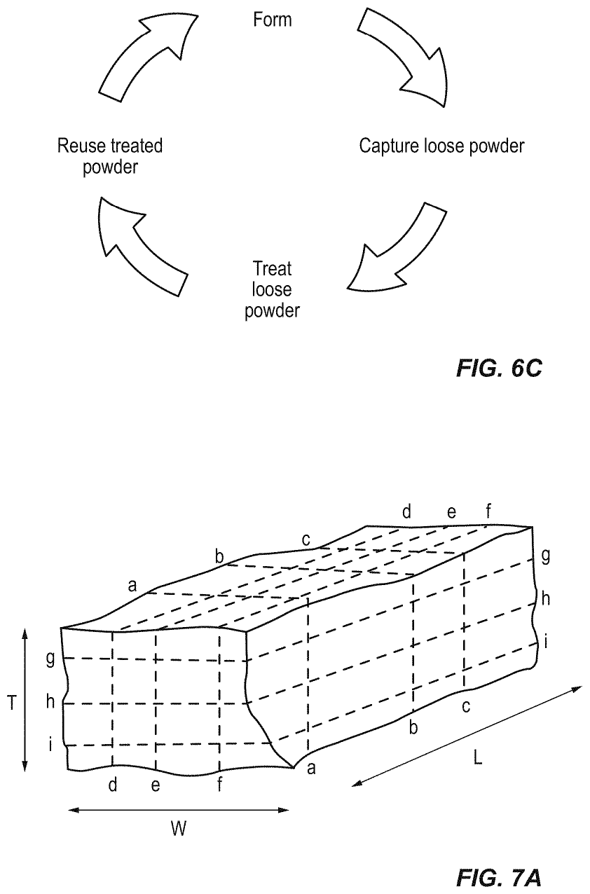

FIG. 6A includes an illustration of a build box for forming an abrasive article according to an embodiment. The build box 600 is configured to contain the powder material as it is deposited. As illustrated in FIG. 6A, the build box 600 can include a portion including loose or unbound powder 601. The build box 600 can further include a portion representing a region of bound powder defining a green body abrasive article 603 surrounded by the portion of loose or unbound powder 601.

FIG. 6B includes an illustration of a process for capturing the loose powder after completing a forming operation to form the green body abrasive article. The loose powder 605 can be captured via a capturing mechanism 607, which may include suction or any other suitable means to remove the loose powder 605 and separate the green body abrasive article 603 from the portion of loose or unbound powder 601. The captured loose powder 605 can be stored in a container. Additionally, or alternatively, the loose powder 605, which may include some content of organic materials from the forming process (e.g., binder material), may be treated to remove a certain content of organic materials. Accordingly, the loose powder 605 can be recycled powder material that is suitable for use in a subsequent forming operation to form one or more green body abrasive articles.

FIG. 6C is a graphic representation of the process for recycling the unused and loose powder material.

FIG. 7A is a perspective view illustration of a body of an abrasive article. As illustrated, the body has a length, width, and thickness and can be evaluated along any of these axes by destructive or non-destructive methods to evaluate one or more properties associated with the body or batch of bodies. Such properties can include, but are not limited to, density variation-L, density variation-W, density variation-T, dimensional variation-L, dimensional variation-W, dimensional variation-T, hardness variation-L, hardness variation-W, hardness variation-T, MOR variation-L, MOR variation-W, MOR variation-T, MOE variation-L, MOE variation-W, and MOE variation-T. FIG. 7B includes three cross-sectional images of cross-sections “a”, “b”, and “c” along a length of the body. Such cross-sections can be generated by cutting the samples for evaluation of one or more properties claimed herein. Alternatively, the cross-sections may be generated from 3D scans of the body to evaluate certain dimensional features and evaluate the quality and consistency of the geometric features of the body. FIG. 7C includes three cross-sectional images of cross-sections “d”, “e”, and “f” along the width of the body. FIG. 7D includes three cross-sectional images of cross-sections “g”, “h”, and “i” along the thickness of the body. In certain instances, the difference in cross-sectional area of each of the cross-sections may be used to quantify the geometric quality of the body.

In an embodiment, the body of the abrasive article may have density variation-L that may facilitate improved performance of the abrasive article. In an embodiment, the density variation-L may be not greater than 20% such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. The density variation-L is calculated by making multiple measurements of density spaced apart from each other along the length of the body. The density measurements may be evaluated by cross-sectional images taken in planes substantially perpendicular to the length of the body. Alternatively, ultrasonic or other non-destructive techniques may be used to create a map of the density variations in the body and used to measure density values and the change in density values of the body along the length of the body. The density variation-L can be the percent difference between an average density value of the body and a density value from a body having the greatest difference, plus or minus, in density from the average density value. The number of density values for a body or batch should be of a suitable statistically relevant sample size.

In an embodiment, the body of the abrasive article may have density variation-W that may facilitate improved performance of the abrasive article. In an embodiment, the density variation-W may be not greater than 20% such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. The density variation-W is calculated by making multiple measurements of density spaced apart from each other along the width of the body. The density measurements may be evaluated by cross-sectional images taken in planes substantially perpendicular to the width of the body at different positions spaced apart from each other along the dimension of width. Alternatively, ultrasonic or other non-destructive techniques may be used to create a map of the density variations in the body and used to measure density values and the change in density values of the body along the width of the body. The density variation-W can be the percent difference between an average density value of the body and a density value from a body having the greatest difference, plus or minus, in density from the average density value. The number of density values for a body or batch should be of a suitable statistically relevant sample size.

In an embodiment, the body of the abrasive article may have density variation-T that may facilitate improved performance of the abrasive article. In an embodiment, the density variation-T may be not greater than 20% such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. The density variation-T is calculated by making multiple measurements of density spaced apart from each other along the thickness of the body. The density measurements may be evaluated by cross-sectional images taken in planes substantially perpendicular to the thickness of the body at different positions spaced apart from each other along the dimension of thickness. Alternatively, ultrasonic or other non-destructive techniques may be used to create a map of the density variations in the body and used to measure density values and the change in density values of the body along the thickness of the body. The density variation-T can be the percent difference between an average density value of the body and a density value from a body having the greatest difference, plus or minus, in density from the average density value. The number of density values for a body or batch should be of a suitable statistically relevant sample size.

In an embodiment, the body of the abrasive article may have a hardness variation-L that may facilitate improved performance of the abrasive article. In an embodiment, the body of the abrasive article may have a hardness variation-L of not greater than 20% of an average hardness value of the body, wherein hardness variation-L is measured along a length of the body, such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. In still another embodiment, the hardness variation-L may be at least 0.00001% or at least 0.0001%. It will be appreciated that the hardness variation-L can be within a range including any of the minimum and maximum values noted above, including for example, but not limited to at least 0.0001%, and not greater than 20%, or within a range of at least 0.001%, and not greater than 10%.

In an embodiment, the body of the abrasive article may have a hardness variation-W that may facilitate improved performance of the abrasive article. In an embodiment, the body of the abrasive article may have a hardness variation-W of not greater than 20% of an average hardness value of the body, wherein hardness variation-W is measured along a width of the body, such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. In still another embodiment, the hardness variation-W may be at least 0.00001% or at least 0.0001%. It will be appreciated that the hardness variation-W can be within a range including any of the minimum and maximum values noted above, including for example, but not limited to at least 0.0001%, and not greater than 20%, or within a range of at least 0.001%, and not greater than 10%.

In an embodiment, the body of the abrasive article may have a hardness variation-T that may facilitate improved performance of the abrasive article. In an embodiment, the body of the abrasive article may have a hardness variation-T of not greater than 20% of an average hardness value of the body, wherein hardness variation-T is measured along a thickness of the body, such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. In still another embodiment, the hardness variation-T may be at least 0.00001% or at least 0.0001%. It will be appreciated that the hardness variation-T can be within a range including any of the minimum and maximum values noted above, including for example, but not limited to at least 0.0001%, and not greater than 20%, or within a range of at least 0.001%, and not greater than 10%.

In an embodiment, a batch of abrasive articles may have a batch hardness variation that may facilitate improved performance of the abrasive article. In an embodiment, the batch of abrasive articles may have a batch hardness variation of not greater than 20% of an average hardness value of the batch, such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. In still another embodiment, the batch hardness variation may be at least 0.00001% or at least 0.0001%. It will be appreciated that the batch hardness variation can be within a range including any of the minimum and maximum values noted above, including for example, but not limited to at least 0.0001%, and not greater than 20%, or within a range of at least 0.001%, and not greater than 10%. The batch hardness variation is calculated by measuring the hardness of each body of the plurality of bodies made via a single operation, wherein the batch hardness variation is a measure of the percent difference between an average hardness value of the batch and a hardness value from a body having the greatest difference, plus or minus, in hardness from the average hardness value of the batch. Note that multiple hardness values can be taken for each body of the plurality of bodies in the batch, and any of the hardness values taken from a body is relevant for comparison and calculation of the batch hardness variation. Each hardness value of the body may be averaged to create an average body hardness value for each discrete body in the batch. The average batch hardness value can be calculated by averaging the average hardness values for each body of the batch. The number of hardness values for a body or batch should be of a suitable statistically relevant sample size.

In an embodiment, the body of the abrasive article may have a dimensional variation-L that may facilitate improved performance of the abrasive article. In an embodiment, the dimensional variation-L may be not greater than 90% of an average dimensional value of the body, wherein dimensional variation-L is measured along a length of the body such as not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75% or not greater than 74% or not greater than 73% or not greater than 72% or not greater than 71% or not greater than 70% or not greater than 69% or not greater than 68% or not greater than 67% or not greater than 66% or not greater than 65% or not greater than 64% or not greater than 63% or not greater than 62% or not greater than 61% or not greater than 60% or not greater than 59% or not greater than 58% or not greater than 57% or not greater than 56% or not greater than 55% or not greater than 54% or not greater than 53% or not greater than 52% or not greater than 51% or not greater than 50% or not greater than 49% or not greater than 48% or not greater than 47% or not greater than 46% or not greater than 45% or not greater than 44% or not greater than 43% or not greater than 42% or not greater than 41% or not greater than 40% or not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1%. In still another embodiment, the dimensional variation-L is at least 0.0001% or at least 0.001% or at least 0.01% or at least 0.1%. It will be appreciated that the dimensional variation-L can be within a range including any of the minimum and maximum values noted above, including for example, but not limited to at least 0.0001%, and not greater than 90%, or within a range of at least 0.001%, and not greater than 80%.

It will be appreciated that a batch of abrasive articles may have a batch dimensional variation-L having a value of any of the values notes above including a range between any of the minimum and maximum values noted above with respect to the dimensional variation-L, wherein the batch dimensional variation-L is calculated by measuring the length of each body of the plurality of bodies made via a single operation, wherein the batch dimensional variation-L is the percent difference between an average length of same-shaped bodies of a batch and a length value of a body having the greatest difference, plus or minus, in length from the average length value of the batch. Note that multiple length values can be taken for each body of the plurality of bodies in the batch, and any of the length values taken from a body is relevant for comparison and calculation of the batch dimensional variation-L. More than one length measurement may be made on an individual body and averaged to create an average length value for each discrete body in the batch. An average length value of the batch can be calculated by averaging the average length values for each same-shaped body of the batch. The number of length values for a body or the batch should be of a suitable statistically relevant sample size.

In an embodiment, the body of the abrasive article may have a dimensional variation-W that may facilitate improved performance of the abrasive article. In an embodiment, the dimensional variation-W may be not greater than 90% of an average dimensional value of the body, wherein dimensional variation-W is measured along a width of the body such as not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75% or not greater than 74% or not greater than 73% or not greater than 72% or not greater than 71% or not greater than 70% or not greater than 69% or not greater than 68% or not greater than 67% or not greater than 66% or not greater than 65% or not greater than 64% or not greater than 63% or not greater than 62% or not greater than 61% or not greater than 60% or not greater than 59% or not greater than 58% or not greater than 57% or not greater than 56% or not greater than 55% or not greater than 54% or not greater than 53% or not greater than 52% or not greater than 51% or not greater than 50% or not greater than 49% or not greater than 48% or not greater than 47% or not greater than 46% or not greater than 45% or not greater than 44% or not greater than 43% or not greater than 42% or not greater than 41% or not greater than 40% or not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1%. In still another embodiment, the dimensional variation-W is at least 0.0001% or at least 0.001% or at least 0.01% or at least 0.1%. It will be appreciated that the dimensional variation-W can be within a range including any of the minimum and maximum values noted above, including for example, but not limited to at least 0.0001%, and not greater than 90%, or within a range of at least 0.001%, and not greater than 80%.

It will be appreciated that a batch of abrasive articles may have a batch dimensional variation-W having a value of any of the values notes above including a range between any of the minimum and maximum values noted above with respect to the dimensional variation-W, wherein the batch dimensional variation-W is calculated by measuring the width of each body of the plurality of bodies made via a single operation, wherein the batch dimensional variation-W is the percent difference between an average width of same-shaped bodies of a batch and a width value of a body having the greatest difference, plus or minus, in width from the average width value of the batch. Note that multiple width values can be taken for each body of the plurality of bodies in the batch, and any of the width values taken from a body is relevant for comparison and calculation of the batch dimensional variation-W. More than one width measurement may be made on an individual body and averaged to create an average width value for each discrete body in the batch. An average width value of the batch can be calculated by averaging the average width values for each same-shaped body of the batch. The number of width values for a body or the batch should be of a suitable statistically relevant sample size.

In an embodiment, the body of the abrasive article may have a dimensional variation-T that may facilitate improved performance of the abrasive article. In an embodiment, the dimensional variation-T may be not greater than 90% of an average dimensional value of the body, wherein dimensional variation-T is measured along a thickness of the body such as not greater than 89% or not greater than 88% or not greater than 87% or not greater than 86% or not greater than 85% or not greater than 84% or not greater than 83% or not greater than 82% or not greater than 81% or not greater than 80% or not greater than 79% or not greater than 78% or not greater than 77% or not greater than 76% or not greater than 75% or not greater than 74% or not greater than 73% or not greater than 72% or not greater than 71% or not greater than 70% or not greater than 69% or not greater than 68% or not greater than 67% or not greater than 66% or not greater than 65% or not greater than 64% or not greater than 63% or not greater than 62% or not greater than 61% or not greater than 60% or not greater than 59% or not greater than 58% or not greater than 57% or not greater than 56% or not greater than 55% or not greater than 54% or not greater than 53% or not greater than 52% or not greater than 51% or not greater than 50% or not greater than 49% or not greater than 48% or not greater than 47% or not greater than 46% or not greater than 45% or not greater than 44% or not greater than 43% or not greater than 42% or not greater than 41% or not greater than 40% or not greater than 39% or not greater than 38% or not greater than 37% or not greater than 36% or not greater than 35% or not greater than 34% or not greater than 33% or not greater than 32% or not greater than 31% or not greater than 30% or not greater than 29% or not greater than 28% or not greater than 27% or not greater than 26% or not greater than 25% or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1%. In still another embodiment, the dimensional variation-T is at least 0.0001% or at least 0.001% or at least 0.01% or at least 0.1%. It will be appreciated that the dimensional variation-T can be within a range including any of the minimum and maximum values noted above, including for example, but not limited to at least 0.0001%, and not greater than 90%, or within a range of at least 0.001%, and not greater than 80%.

It will be appreciated that a batch of abrasive articles may have a batch dimensional variation-T having a value of any of the values notes above including a range between any of the minimum and maximum values noted above with respect to the dimensional variation-T, wherein the batch dimensional variation-T is calculated by measuring the thickness of each body of the plurality of bodies made via a single operation, wherein the batch dimensional variation-T is the percent difference between an average thickness of same-shaped bodies of a batch and a thickness value of a body having the greatest difference, plus or minus, in thickness from the average thickness value of the batch. Note that multiple thickness values can be taken for each body of the plurality of bodies in the batch, and any of the thickness values taken from a body is relevant for comparison and calculation of the batch dimensional variation-T. More than one thickness measurement may be made on an individual body and averaged to create an average thickness value for each discrete body in the batch. An average thickness value of the batch can be calculated by averaging the average thickness values for each same-shaped body of the batch. The number of thickness values for a body or the batch should be of a suitable statistically relevant sample size.

In an embodiment, the body of the abrasive article may have a theoretical density that may facilitate improved performance of the abrasive article. In an embodiment, a theoretical density may be not greater than 99.9% or not greater than 99.5% or not greater than 99%. Still, in a non-limiting embodiment, the theoretical density may be at least 50% or at least 51% or at least 53% or at least 54% or at least 55% or at least 56% or at least 57% or at least 58% or at least 59% or at least 60% or at least 61% or at least 62% or at least 63% or at least 64% or at least 65% or at least 66% or at least 67% or at least 68% or at least 69% or at least 70% or at least 71% or at least 72% or at least 73% or at least 74% or at least 75% or at least 76% or at least 77% or at least 78% or at least 79% or at least 80% or at least 81% or at least 82% or at least 83% or at least 84% or at least 85% or at least 86% or at least 87% or at least 88% or at least 89% or at least 90% or at least 91% or at least 92% or at least 93% or at least 94% or at least 95% or at least 96% or at least 97% or at least 98% or at least 99%. It will be appreciated that the theoretical density can be within a range including any of the minimum and maximum values noted above, including for example, but not limited to within a range of at least 50% to not greater than 99.9% or within a range of at least 62% to not greater than 98%. It will be appreciated that each body of a plurality of bodies of a batch of abrasive articles can have a theoretical density of any of the values noted above with respect to the theoretical density of the body.

In an embodiment, the body of the abrasive article may have a MOR variation-L that may facilitate improved performance of the abrasive article. In an embodiment, the MOR variation-L may be not greater than 20% of an average MOR value of the body, wherein MOR variation-L is measured along a length of the body such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%.

In an embodiment, the body of the abrasive article may have a MOR variation-W that may facilitate improved performance of the abrasive article. In an embodiment, the MOR variation-W may be not greater than 20% of an average MOR value of the body, wherein MOR variation-W is measured along a width of the body such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%.

In an embodiment, the body of the abrasive article may have a MOR variation-T that may facilitate improved performance of the abrasive article. In an embodiment, the MOR variation-T may be not greater than 20% of an average MOR value of the body, wherein MOR variation-T is measured along a thickness of the body such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%.

In an embodiment, a batch of abrasive articles may have a batch MOR variation that may facilitate improved performance of the abrasive article. In an embodiment, the batch MOR variation may be not greater than 20% of an average MOR value of the batch, such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. In still another embodiment, the batch MOR variation is at least 0.00001% or at least 0.0001%. It will be appreciated that the batch MOR variation can be within a range including any of the minimum and maximum values noted above, including for example, but not limited to at least 0.0001%, and not greater than 90%, or within a range of at least 0.001%, and not greater than 80%. The batch MOR variation is calculated by measuring the MOR of each body of the plurality of bodies made via a single operation, wherein the batch MOR variation is a measure of the percent difference between an average MOR value of the batch and a MOR value from a body having the greatest difference, plus or minus, in MOR from the average MOR value of the batch. The number of MOR values for a batch should be of a suitable statistically relevant sample size.

In an embodiment, the body of the abrasive article may have a MOE variation-L that may facilitate improved performance of the abrasive article. In an embodiment, the MOE variation-L may be not greater than 20% of an average MOE value of the body, wherein MOE variation-L is measured along a length of the body such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%.

In an embodiment, the body of the abrasive article may have a MOE variation-W that may facilitate improved performance of the abrasive article. In an embodiment, the MOE variation-W may be not greater than 20% of an average MOE value of the body, wherein MOE variation-W is measured along a width of the body such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%.

In an embodiment, the body of the abrasive article may have a MOE variation-T that may facilitate improved performance of the abrasive article. In an embodiment, the MOE variation-T may be not greater than 20% of an average MOE value of the body, wherein MOE variation-T is measured along a thickness of the body such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%.

In an embodiment, a batch of abrasive articles may have a batch MOE variation that may facilitate improved performance of the abrasive article. In an embodiment, the batch MOE variation may be not greater than 20% of an average MOE value of the batch, such as not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. In still another embodiment, the batch MOE variation is at least 0.00001% or at least 0.0001%. It will be appreciated that the batch MOE variation can be within a range including any of the minimum and maximum values noted above, including for example, but not limited to at least 0.0001%, and not greater than 90%, or within a range of at least 0.001%, and not greater than 80%. The batch MOR variation is calculated by measuring the MOE of each body of the plurality of bodies made via a single operation, wherein the batch MOE variation is a measure of the percent difference between an average MOE value of the batch and a MOE value from a body having the greatest difference, plus or minus, in MOE from the average MOE value of the batch. The number of MOE values for a batch should be of a suitable statistically relevant sample size.

In an embodiment, the abrasive article may include a particular porosity that may facilitate improved manufacturing of the abrasive article. In an embodiment, the porosity of the abrasive article may be at least 1 vol % based on the total volume of the abrasive article or at least 2 vol % such as at least 3 vol % or at least 4 vol % or at least 5 vol % or at least 10 vol % or at least 15 vol % or at least 20 vol % or at least 25 vol % or at least 30 vol % or at least 35 vol %. In another embodiment, the porosity of the abrasive article may be not greater than 90 vol % such as not greater than 80 vol % or not greater than 70 vol % or not greater than 60 vol % or not greater than 50 vol % or not greater than 45 vol % or not greater than 40 vol % or not greater than 30 vol % or not greater than 20 vol % or not greater than 10 vol % not greater than 8 vol % or not greater than 7 vol % or not greater than 6 vol % or not greater than 5 vol % or not greater than 4 vol % or not greater than 3 vol % or not greater than 2 vol % or not greater than 1 vol %. The porosity of the abrasive article can be a value between any of the minimum and maximum values noted above, including for example, but not limited to, within a range of at least 1 vol % to not greater than 90 vol % based on the total volume of the abrasive article, such as within a range of at least 10 vol % to not greater than 60 vol % based on the total volume of the abrasive article body.

Additionally, as illustrated, the body has four major planar surfaces and two end surfaces. Any of the four major planar surfaces extending between the two smaller end surfaces can be used to evaluate certain properties as claimed herein, including, for example, but not limited to, nWarp, nFlatness, nBow. In the instance of the property nDimensional variation, multiple measurements at random locations between two opposing major planar surfaces can be made to evaluate the nDimensional variation. Such a measurement can be made in the dimension of thickness in a direction generally perpendicular to the plane defined by the length and width of the body. A multitude of randomly selected points on the first major surface are selected and the shortest distance to the second major surface through the body is recorded as a dimension. The dimensions are averaged to define the average Dimensional variation. The average is then normalized to the surface area of the first major surface. If one of the major surfaces is smaller than the other, the smaller surface is used. The nDimensional variation is the average value of the dimensional variation normalized (divided) by the area of the smaller of the major planar surfaces.

In an embodiment, a major planar surface of the body may have a nWarp that may facilitate improved performance of the abrasive article. In an embodiment, the major planar surface of the body may have a nWarp of not greater than 50 μm/cm², wherein nWarp is the warp of the major planar surface normalized for the surface area of the major planar surface such as not greater than 40 μm/cm² or not greater than 30 μm/cm² or not greater than 20 μm/cm² or not greater than 10 μm/cm² or not greater than or not greater than 9 μm/cm² or not greater than 8 μm/cm² or not greater than 7 μm/cm² or not greater than 6 μm/cm² or not greater than 5 μm/cm² or not greater than 4 μm/cm² or not greater than 3 μm/cm² or not greater than 2 μm/cm² or not greater than 1 μm/cm² or not greater than 0.9 μm/cm² or not greater than 0.8 μm/cm² or not greater than 0.7 μm/cm² or not greater than 0.6 μm/cm² or not greater than 0.5 μm/cm² or not greater than 0.4 μm/cm² or not greater than 0.3 μm/cm² or not greater than 0.2 μm/cm² or not greater than 0.1 μm/cm² or not greater than 0.09 μm/cm² or not greater than 0.08 μm/cm² or not greater than 0.07 μm/cm² or not greater than 0.06 μm/cm² or not greater than 0.05 μm/cm² or not greater than 0.04 μm/cm² or not greater than 0.03 μm/cm² or not greater than 0.02 μm/cm² or not greater than 0.01 μm/cm². In still another embodiment, the nWarp may be at least 0.0001 μm/cm² or at least 0.0005 μm/cm² or at least 0.001 μm/cm² or at least 0.005 μm/cm² or at least 0.01 μm/cm² or at least 0.1 μm/cm². It will be appreciated that the nWarp can be within a range including any of the minimum and maximum values noted above, including for example, but not limited to within a range of at least 0.0001 μm/cm² to not greater than 50 μm/cm² or within a range of at least 0.001 μm/cm² to not greater than 10 μm/cm².

In an embodiment, a batch of abrasive articles may have a batch nWarp standard deviation that may facilitate improved performance of the abrasive article wherein the batch nWarp variation is the standard deviation of nWarp for all bodies of the same shape in a batch. In an embodiment, the batch nWarp standard deviation may be not greater than 10, such as not greater than 9 or not greater than 8 or not greater than 7 or not greater than 6 or not greater than 5 or not greater than 4 or not greater than 3 or not greater than 2 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1 or not greater than 0.09 or not greater than 0.08 or not greater than 0.07 or not greater than 0.06 or not greater than 0.05 or not greater than 0.04 or not greater than 0.03 or not greater than 0.02 or not greater than 0.01. In still another embodiment, the batch nWarp standard deviation may be at least 0.0005 or at least 0.001 or at least 0.005 or at least 0.01 or at least 0.1. It will be appreciated that the batch nWarp standard deviation can be within a range including any of the minimum and maximum values noted above, including for example, but not limited to within a range of at least 0.01 to not greater than 10 or within a range of at least 0.1 to not greater than 5.

In an embodiment, a major planar surface of the body may have a nFlatness that may facilitate improved performance of the abrasive article. In an embodiment, the major planar surface of the body may have a nFlatness of not greater than 50 μm/cm², wherein nFlatness is the flatness of the major planar surface normalized for the surface area of the major planar surface, such as not greater than 40 μm/cm² or not greater than 30 μm/cm² or not greater than 20 μm/cm² or not greater than 10 μm/cm² or not greater than or not greater than 9 μm/cm² or not greater than 8 μm/cm² or not greater than 7 μm/cm² or not greater than 6 μm/cm² or not greater than 5 μm/cm² or not greater than 4 μm/cm² or not greater than 3 μm/cm² or not greater than 2 μm/cm² or not greater than 1 μm/cm² or not greater than 0.9 μm/cm² or not greater than 0.8 μm/cm² or not greater than 0.7 μm/cm² or not greater than 0.6 μm/cm² or not greater than 0.5 μm/cm² or not greater than 0.4 μm/cm² or not greater than 0.3 μm/cm² or not greater than 0.2 μm/cm² or not greater than 0.1 μm/cm² or not greater than 0.09 μm/cm² or not greater than 0.08 μm/cm² or not greater than 0.07 μm/cm² or not greater than 0.06 μm/cm² or not greater than 0.05 μm/cm² or not greater than 0.04 μm/cm² or not greater than 0.03 μm/cm² or not greater than 0.02 μm/cm² or not greater than 0.01 μm/cm². In still another embodiment, the nFlatness may be at least 0.0001 μm/cm² or at least 0.0005 μm/cm² or at least 0.001 μm/cm² or at least 0.005 μm/cm² or at least 0.01 μm/cm² or at least 0.1 μm/cm². It will be appreciated that the nFlatness can be within a range including any of the minimum and maximum values noted above, including for example, but not limited to within a range of at least 0.0001 μm/cm² to not greater than 50 μm/cm² or within a range of at least 0.001 μm/cm² to not greater than 10 μm/cm².

In an embodiment, a batch of abrasive articles may have a batch nFlatness standard deviation that may facilitate improved performance of the abrasive article wherein batch nFlatness variation is the standard deviation of nFlatness for all bodies of the same shape in a batch. In an embodiment, the batch nFlatness standard deviation may be not greater than 10, such as not greater than 9 or not greater than 8 or not greater than 7 or not greater than 6 or not greater than 5 or not greater than 4 or not greater than 3 or not greater than 2 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1 or not greater than 0.09 or not greater than 0.08 or not greater than 0.07 or not greater than 0.06 or not greater than 0.05 or not greater than 0.04 or not greater than 0.03 or not greater than 0.02 or not greater than 0.01. In still another embodiment, the batch nFlatness standard deviation may be at least 0.0005 or at least 0.001 or at least 0.005 or at least 0.01 or at least 0.1. It will be appreciated that the batch nFlatness standard deviation can be within a range including any of the minimum and maximum values noted above, including for example, but not limited to within a range of at least 0.01 to not greater than 10 or within a range of at least 0.1 to not greater than 5.

In an embodiment, a major planar surface of the body may have a nBow that may facilitate improved performance of the abrasive article. In an embodiment, the major planar surface of the body may have a nBow of not greater than 50 μm/cm², wherein nBow is the bow of the major planar surface normalized for the surface area of the major planar surface, such as not greater than 40 μm/cm² or not greater than 30 μm/cm² or not greater than 20 μm/cm² or not greater than 10 μm/cm² or not greater than or not greater than 9 μm/cm² or not greater than 8 μm/cm² or not greater than 7 μm/cm² or not greater than 6 μm/cm² or not greater than 5 μm/cm² or not greater than 4 μm/cm² or not greater than 3 μm/cm² or not greater than 2 μm/cm² or not greater than 1 μm/cm² or not greater than 0.9 μm/cm² or not greater than 0.8 μm/cm² or not greater than 0.7 μm/cm² or not greater than 0.6 μm/cm² or not greater than 0.5 μm/cm² or not greater than 0.4 μm/cm² or not greater than 0.3 μm/cm² or not greater than 0.2 μm/cm² or not greater than 0.1 μm/cm² or not greater than 0.09 μm/cm² or not greater than 0.08 μm/cm² or not greater than 0.07 μm/cm² or not greater than 0.06 μm/cm² or not greater than 0.05 μm/cm² or not greater than 0.04 μm/cm² or not greater than 0.03 μm/cm² or not greater than 0.02 μm/cm² or not greater than 0.01 μm/cm². In still another embodiment, the nBow may be at least 0.0001 μm/cm² or at least 0.0005 μm/cm² or at least 0.001 μm/cm² or at least 0.005 μm/cm² or at least 0.01 μm/cm² or at least 0.1 μm/cm². It will be appreciated that the nBow can be within a range including any of the minimum and maximum values noted above, including for example, but not limited to within a range of at least 0.0001 μm/cm² to not greater than 50 μm/cm² or within a range of at least 0.001 μm/cm² to not greater than 10 μm/cm².

In an embodiment, a batch of abrasive articles may have a batch nBow standard deviation that may facilitate improved performance of the abrasive article wherein batch nBow variation is the standard deviation of nBow for all bodies of the same shape in a batch. In an embodiment, the batch nBow standard deviation may be not greater than 10, such as not greater than 9 or not greater than 8 or not greater than 7 or not greater than 6 or not greater than 5 or not greater than 4 or not greater than 3 or not greater than 2 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1 or not greater than 0.09 or not greater than 0.08 or not greater than 0.07 or not greater than 0.06 or not greater than 0.05 or not greater than 0.04 or not greater than 0.03 or not greater than 0.02 or not greater than 0.01. In still another embodiment, the batch nBow standard deviation may be at least 0.0005 or at least 0.001 or at least 0.005 or at least 0.01 or at least 0.1. It will be appreciated that the batch nBow standard deviation can be within a range including any of the minimum and maximum values noted above, including for example, but not limited to within a range of at least 0.01 to not greater than 10 or within a range of at least 0.1 to not greater than 5.

In an embodiment, the distance between the first major planar surface and second major planar surface of the body may have a nDimensional Variation that may facilitate improved performance of the abrasive article. In an embodiment, the distance between the first major planar surface and second major planar surface may have a nDimension variation of not greater than 100 μm/cm², herein nDimension variation is the variation in the dimension between the first and second major planar surfaces normalized to the area of the first or second major planar surfaces, such as not greater than 90 μm/cm² or not greater than 80 μm/cm² or not greater than 70 μm/cm² or not greater than 60 μm/cm² or not greater than 50 μm/cm² or not greater than 40 μm/cm² or not greater than 30 μm/cm² or not greater than 20 μm/cm² or not greater than 10 μm/cm² or not greater than 9 μm/cm² or not greater than 8 μm/cm² or not greater than 7 μm/cm² or not greater than 6 μm/cm² or not greater than 5 μm/cm² or not greater than 4 μm/cm² or not greater than 3 μm/cm² or not greater than 2 μm/cm² or not greater than 1 μm/cm² or not greater than 0.9 μm/cm² or not greater than 0.8 μm/cm² or not greater than 0.7 μm/cm² or not greater than 0.6 μm/cm² or not greater than 0.5 μm/cm² or not greater than 0.4 μm/cm² or not greater than 0.3 μm/cm² or not greater than 0.2 μm/cm² or not greater than 0.1 μm/cm² or not greater than 0.09 μm/cm² or not greater than 0.08 μm/cm² or not greater than 0.07 μm/cm² or not greater than 0.06 μm/cm² or not greater than 0.05 μm/cm² or not greater than 0.04 μm/cm² or not greater than 0.03 μm/cm² or not greater than 0.02 μm/cm² or not greater than 0.01 μm/cm². In still another embodiment, the nDimensional Variation may be at least 0.0001 μm/cm² or at least 0.0005 μm/cm² or at least 0.001 μm/cm² or at least 0.005 μm/cm² or at least 0.01 μm/cm² or at least 0.1 μm/cm² or at least 1 μm/cm² or at least 5 μm/cm². It will be appreciated that the nDimensional Variation can be within a range including any of the minimum and maximum values noted above, including for example, but not limited to within a range of at least 0.0001 μm/cm² to not greater than 50 μm/cm² or within a range of at least 0.001 μm/cm² to not greater than 10 μm/cm².

In an embodiment, a batch of abrasive articles may have a batch nDimensional standard deviation that may facilitate improved performance of the abrasive article wherein batch nDimensional standard deviation is the standard deviation of nDimension variation for all bodies of the same shape in a batch. In an embodiment, the batch nDimensional standard deviation may be not greater than 10, such as not greater than 9 or not greater than 8 or not greater than 7 or not greater than 6 or not greater than 5 or not greater than 4 or not greater than 3 or not greater than 2 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1 or not greater than 0.09 or not greater than 0.08 or not greater than 0.07 or not greater than 0.06 or not greater than 0.05 or not greater than 0.04 or not greater than 0.03 or not greater than 0.02 or not greater than 0.01. In still another embodiment, the batch nDimensional standard deviation may be at least 0.0005 or at least 0.001 or at least 0.005 or at least 0.01 or at least 0.1. It will be appreciated that the batch nDimensional standard deviation can be within a range including any of the minimum and maximum values noted above, including for example, but not limited to within a range of at least 0.01 to not greater than 10 or within a range of at least 0.1 to not greater than 5.

In an embodiment, the volume of the plurality of bodies of the batch may include a batch volume that may facilitate improved performance of the abrasive article. In an embodiment, the batch volume may be at least 10 cm³ or at least 11 cm³ or at least 12 cm³ or at least 13 cm³ or at least 14 cm³ or at least 15 cm³ or at least 16 cm³ or at least 17 cm³ or at least 18 cm³ or at least 19 cm³ or at least 20 cm³ or at least 21 cm³ or at least 22 cm³ or at least 23 cm³ or at least 24 cm³ or at least 25 cm³ or at least 26 cm³ or at least 27 cm³ or at least 28 cm³ or at least 29 cm³ or at least 30 cm³ or at least 31 cm³ or at least 32 cm³ or at least 33 cm³ or at least 34 cm³ or at least 35 cm³ or at least 36 cm³ or at least 37 cm³ or at least 38 cm³ or at least 39 cm³, or at least 40 cm³ or at least 42 cm³ or at least 44 cm³ or at least 46 cm³ or at least 48 cm³ or at least 50 cm³. In still another embodiment, the batch volume may be not greater than 5000 cm³ or not greater than 4000 cm³ or not greater than 3000 cm³ or not greater than 2000 cm³ or not greater than 1000 cm³ or not greater than 800 cm³ or not greater than 600 cm³ or not greater than 500 cm³. It will be appreciated that the batch v can be within a range including any of the minimum and maximum values noted above, including for example, but not limited to within a range of at least 10 cm³ to not greater than 100 cm³ or within a range of at least 100 cm³ to not greater than 5000 cm³.

According to another embodiment, the body of an abrasive article, which may be in the form of a green body abrasive article or a finally-formed abrasive article may have a particular volumetric form factor that may be achieved through one or more forming processes of the embodiments herein and facilitate improved abrasive operations. In one embodiment, for a single abrasive article (green body or finally-formed body), the volumetric form factor can be a comparison between the shape of the body in three-dimensions as compared to an intended shape. In certain aspects, abrasive articles are intended to comply with strict dimensional tolerances, and deviations from the intended dimensional tolerances must be addressed by one or more methods, typically a post-forming subtractive process. In some instances, depending upon the severity of the deviation of the body from an intended shape, the body may be scrapped.

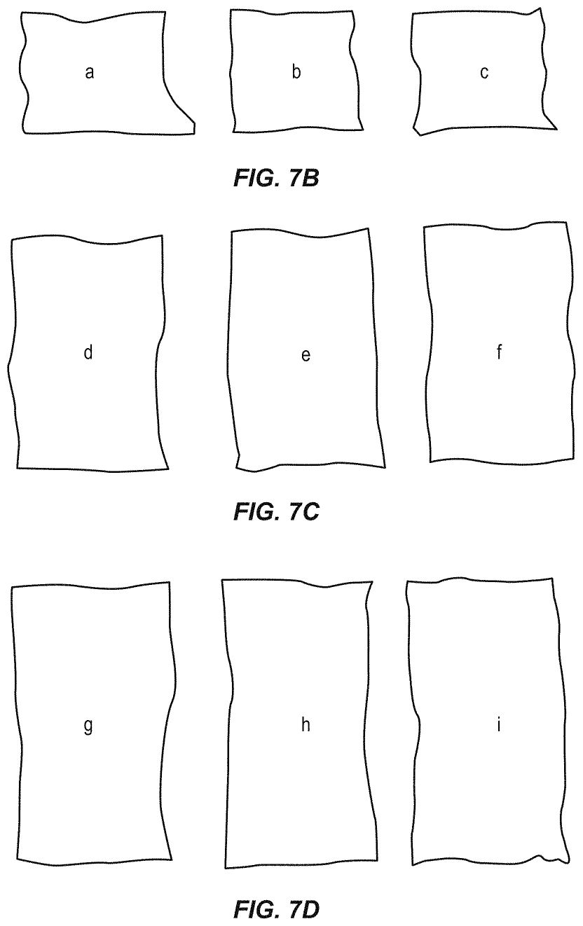

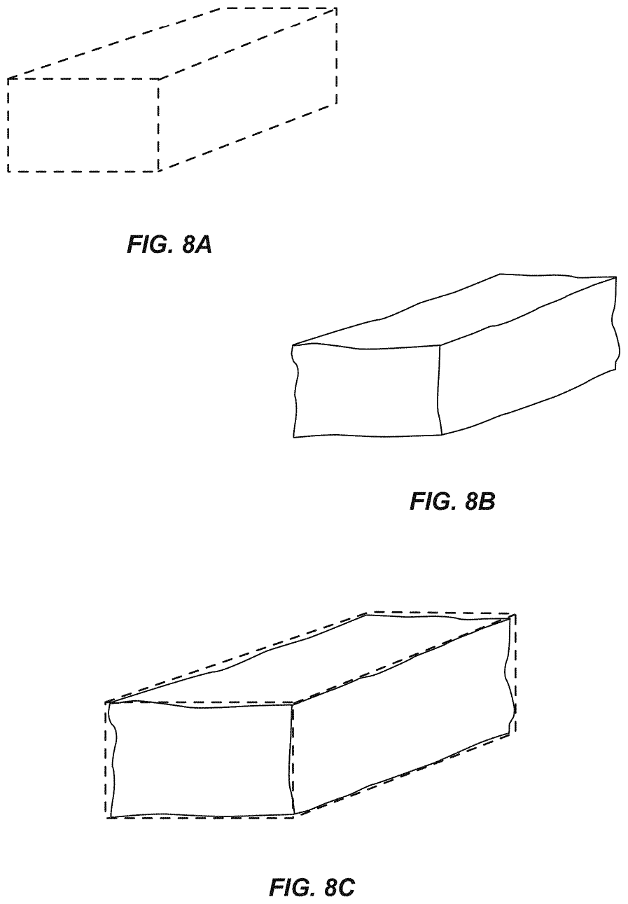

FIG. 8A includes a perspective view illustration of an intended shape of an abrasive article. The intended shape may be a well-known standard that may be stored as electronic data, such as in the form of a three-dimensional model on a computer-readable medium. FIG. 8B includes a perspective view illustration of a formed abrasive article. The volumetric form factor for a single abrasive article can be a value of how well the formed abrasive article (e.g., FIG. 8B) matches to the intended shape (e.g., FIG. 8A). One such comparison is illustrated as FIG. 8C.

According to one aspect, a detailed three-dimensional scan can be conducted on the body via 3D tomography with X-ray radiation to create a representative three-dimensional model of the abrasive article. The model of the abrasive article can be compared to the model of the intended shape. The model of the abrasive article can be compared to the model of the intended shape using slices of the body and measuring the deviations in one or more select planes through the model of the abrasive article. Additionally, or alternatively, the deviations between the two models may be evaluated for the whole of the volume.

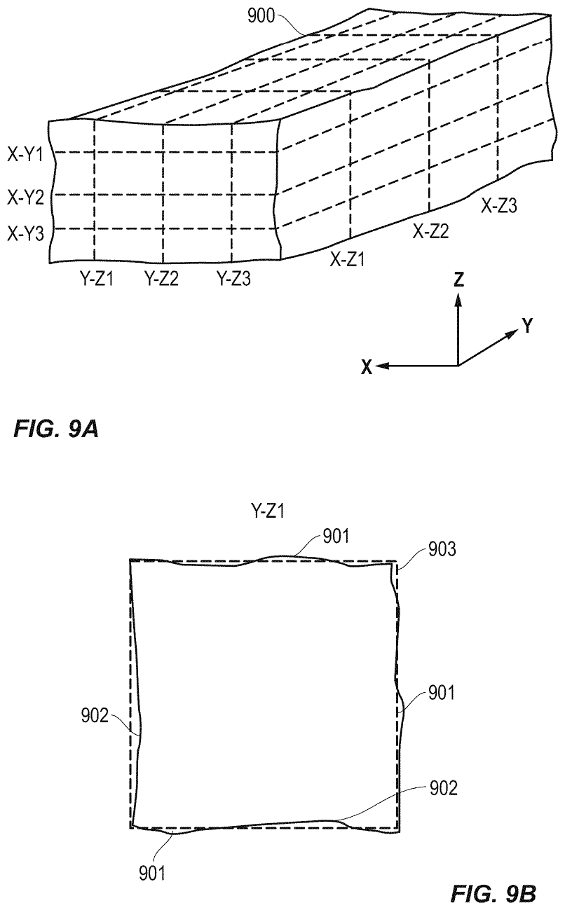

In one particular embodiment, at least three scans are completed in three different planes on the model of the abrasive article as shown in FIG. 9A. FIG. 9A illustrates nine total planes, spaced apart from each other, and cutting through the model of the abrasive article 900 for the planes X-Y, X-Z, and Y-Z. The scanned images can be extracted as 2D images of the body and can be compared to corresponding 2D data (e.g., 903) from the model of the intended shape. Image analysis software can compare the differences in the 2D images of the abrasive article and intended shape and evaluate the difference in area between the images for each of the nine planes. As shown in FIG. 9B, additional area 901 outside of an intended surface can be given a positive value. Negative area 902 on the model of the abrasive article relative to the model of the intended shape can be given a negative value. The total of positive and negative area is summed for each scan. The values for each of the nine scans are averaged and recorded as the average volumetric form value of the model of the abrasive article. The volumetric form factor is calculated as the absolute value of the ratio of the average volumetric form value divided by the volumetric form value of the model of the intended shape. That is, Vff=|Vav/Vmi|, wherein Vff represents the volumetric form factor, Vav represents the average volumetric form value and Vmi represents the volumetric form value of the model of the intended shape.

According to one embodiment, the Vff can be at least 0.1, such as at least 0.2 or at least 0.25 or at least 0.3 or at least 0.35 or at least 0.4 or at least 0.45 or at least 0.5 or at least 0.55 or at least 0.6 or at least 0.65 or at least 0.7 or at least 0.71 or at least 0.72 or at least 0.73 or at least 0.74 or at least 0.75 or at least 0.76 or at least 0.77 or at least 0.78 or at least 0.79 or at least 0.80 or at least 0.81 or at least 0.72 or at least 0.73 or at least 0.74 or at least 0.75 or at least 0.76 or at least 0.77 or at least 0.78 or at least 0.79 or at least 0.80 or at least 0.81 or at least 0.82 or at least 0.83 or at least 0.84 or at least 0.85 or at least 0.86 or at least 0.87 or at least 0.88 or at least 0.89 or at least 0.90 or at least 0.91 or at least 0.92 or at least 0.93 or at least 0.94 or at least 0.95 or at least 0.96 or at least 0.97 or at least 0.98 or at least 0.99 or at least 1.0 or at least 1.01 or at least 1.02 or at least 1.03 or at least 1.04 or at least 1.05 or at least 1.06 or at least 1.07 or at least 1.08 or at least 1.09 or at least 1.10 or at least 1.11 or at least 1.12 or at least 1.13 or at least 1.14 or at least 1.15 or at least 1.16 or at least 1.17 or at least 1.18 or at least 1.19 or at least 1.20 or at least 1.21 or at least 1.22 or at least 1.23 or at least 1.24 or at least 1.25 or at least 1.26 or at least 1.27 or at least 1.28 or at least 1.29 or at least 1.30 or at least 1.31 or at least 1.32 or at least 1.33 or at least 1.34 or at least 1.35 or at least 1.36 or at least 1.37 or at least 1.38 or at least 1.39 or at least 1.40 or at least 1.45 or at least 1.50 or at least 1.55 or at least 1.60 or at least 1.65 or at least 1.70 or at least 1.75 or at least 1.80 or at least 1.85 or at least 1.90 or at least 1.95 or at least 2.00. Still, in a non-limiting embodiment, the Vff can be not greater than 10, such as not greater than 9.5 or not greater than 9 or not greater than 8.5 or not greater than 8 or not greater than 7.5 or not greater than 7 or not greater than 6.5 or not greater than 6 or not greater than 5.5 or not greater than 5 or not greater than 4.5 or not greater than 4 or not greater than 3.5 or not greater than 3 or not greater than 2.5 or not greater than 2 or not greater than 1.5 or not greater than 1.45 or not greater than 1.40 or not greater than 1.39 or not greater than 1.38 or not greater than 1.37 or not greater than 1.36 or not greater than 1.35 or not greater than 1.34 or not greater than 1.33 or not greater than 1.32 or not greater than 1.31 or not greater than 1.30 or not greater than 1.29 or not greater than 1.28 or not greater than 1.27 or not greater than 1.26 or not greater than 1.25 or not greater than 1.24 or not greater than 1.23 or not greater than 1.22 or not greater than 1.21 or not greater than 1.20 or not greater than 1.19 or not greater than 1.18 or not greater than 1.17 or not greater than 1.16 or not greater than 1.15 or not greater than 1.14 or not greater than 1.13 or not greater than 1.12 or not greater than 1.11 or not greater than 1.10 or not greater than 1.09 or not greater than 1.08 or not greater than 1.07 or not greater than 1.06 or not greater than 1.05 or not greater than 1.04 or not greater than 1.03 or not greater than 1.02 or not greater than 1.01 or not greater than 1.00 or not greater than 0.99 or not greater than 0.98 or not greater than 0.97 or not greater than 0.96 or not greater than 0.95 or not greater than 0.94 or not greater than 0.93 or not greater than 0.92 or not greater than 0.91 or not greater than 0.90 or not greater than 0.89 or not greater than 0.88 or not greater than 0.87 or not greater than 0.86 or not greater than 0.85 or not greater than 0.84 or not greater than 0.83 or not greater than 0.82 or not greater than 0.81 or not greater than 0.80 or not greater than 0.79 or not greater than 0.78 or not greater than 0.77 or not greater than 0.76 or not greater than 0.75 or not greater than 0.74 or not greater than 0.73 or not greater than 0.72 or not greater than 0.71 or not greater than 0.70. It will be appreciated that the Vff can be within a range including any of the minimum and maximum values noted above, including for example, but not limited to at least 0.10, and not greater than 10, or within a range of at least 0.50, and not greater than 1.50, or within a range of at least 0.80, and not greater than 1.2, or within a range including at least 0.90, and not greater than 1.10, or even within a range including at least 0.95, and not greater than 1.05.

The method for forming a batch of abrasive articles according to the embodiments herein may be suitable for reducing dimensional variation in a batch of abrasive articles and therefore improving the batch volumetric form factor. Some data indicates that the batch volumetric form factor of the abrasive articles may be impacted by the position and/or orientation of the abrasive articles relative to one or more buttressing elements. According to one embodiment, a batch of abrasive articles, which may be green body abrasive articles or finally-formed abrasive articles may have a particular batch volumetric form factor variation. The batch volumetric form factor variation (batch Vff) can be the standard deviation of the volumetric form factor for a batch of abrasive articles. According to one embodiment, the batch Vff can be not greater than 0.30, such as not greater than 0.25, or not greater than 0.20, or not greater than 0.18, or not greater than 0.16, or not greater than 0.14, or not greater than 0.12, or not greater than 0.10, or not greater than 0.09, or not greater than 0.08, or not greater than 0.07, or not greater than 0.06, or not greater than 0.05, or not greater than 0.04, or not greater than 0.03, or not greater than 0.02, or not greater than 0.01, or not greater than 0.009, or not greater than 0.008, or not greater than 0.007, or not greater than 0.006, or not greater than 0.005. Still, in one non-limiting embodiment, the batch Vff can be at least 0.00001, or at least 0.0001, or at least 0.0005, or at least 0.001, or at least 0.01, or at least 0.1, or at least 0.2, or at least 0.4, or at least 0.6. It will be appreciated that the batch Vff can be within a range including any of the minimum and maximum values noted above, including for example, but not limited to within a range of at least 0.00001, and not greater than 0.3, such as within a range of at least 0.00001 and not greater than 0.2, or within a range of at least 0.00001 and not greater than 0.05, or even within a range of at least 0.00001 and not greater than 0.01.

It will be appreciated that a single forming operation may form a plurality of discrete green body abrasive articles, which can be formed into a plurality of finally-formed abrasive articles. A plurality of abrasive articles may be referred to as a batch of abrasive articles and may be green bodies or finally-formed abrasive articles. In one embodiment, the abrasive articles of a batch can be formed in a single forming process within the same build box. The properties noted in the foregoing and claimed herein can be used to evaluate the abrasive articles on a batch basis. That is, evaluation of one or more geometric features and/or properties of each body within a batch can be compared to evaluate the quality of a batch as a whole. According to one embodiment, a batch may include a certain minimum size or volume of material, such as described in any of the embodiments herein. In another non-limiting embodiment, a batch may include a plurality of abrasive articles formed in a single additive manufacturing build cycle, which may include a plurality of abrasive articles (green or finally-formed) that are formed in the same build box during the same build cycle.

According to one embodiment, a method for forming an abrasive article may include using data to quantify a distortion of a green abrasive article body and/or finally-formed abrasive article and modifying the model used to control the formation of the green abrasive article body using the additive manufacturing process. According to one embodiment, one or more distortion characteristics can include any measure of distortion between a model and the actual body formed via additive manufacturing. For example, one distortion characteristic can include the Volumetric Form Factor. It will be appreciated that other methods for characterizing distortion of one or a batch of abrasive articles may be used. In one embodiment, the process for modifying the model can include changing the dimensions of the model based on a quantified and expected distortion that would likely occur from a particular additive manufacturing process. In one non-limiting embodiment, the process of modifying the model can include comparing one or more dimensions (e.g., length, width, thickness, diameter, etc.) of a model to the corresponding dimensions of a batch of green abrasive article bodies and/or a batch of finally-formed abrasive articles and changing one or more dimensions of the model to change to account for the measured distortion of the resulting batch of green abrasive article bodies and/or a batch of finally-formed abrasive articles.

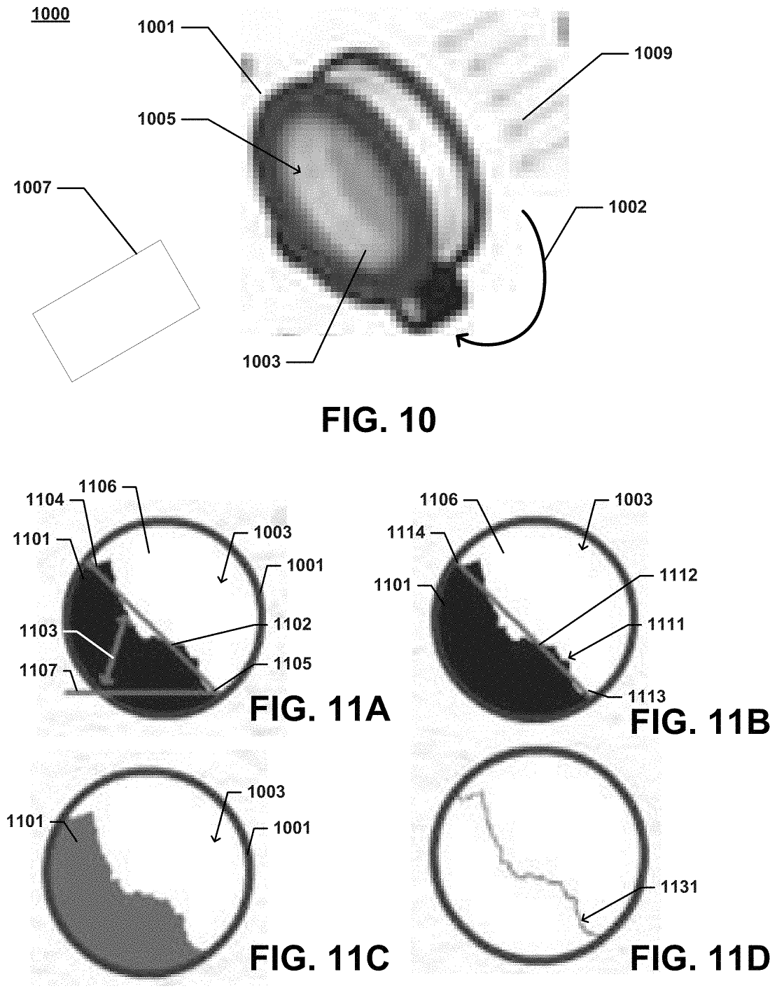

FIG. 10 includes an apparatus for evaluating moisture content and/or one or more flowability characteristics of an abrasive precursor powder or other raw material powder. In one instance, the abrasive precursor powder or other raw material powder may be suitable for use in an additive manufacturing process, including, for example, but not limited to binder jetting operations wherein the abrasive precursor powder or other raw material powder may be deposited in one or more layers and selectively bound with binder material to form a green body in a bed of powder material.

According to one aspect, a plurality of abrasive articles (i.e., green body abrasive articles or finally-formed abrasive articles) can be formed via additive manufacturing wherein the flowability of the powder material is controlled alone or in combination with other process variables to control the quality of the abrasive articles. The plurality may include a batch of abrasive articles having any of the features of the batches described in the embodiments herein. Certain studies conducted by the Applicant have indicated that in large build beds and/or when forming batches of large-sized abrasive articles unintended deformations can happen. While not wishing to be tied to any particular theory, some data suggests that various undesired microstructures and/or dimensional characteristics occur more frequently in large-sized build-beds, requiring a fuller understanding of printing on a commercial scale, which is not necessarily understood in the art that to-date has not been concerned with commercial-scale production.

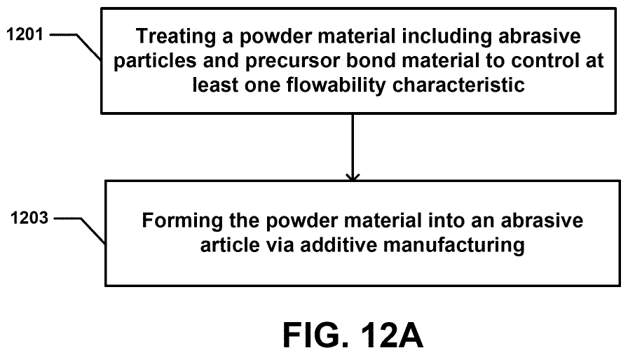

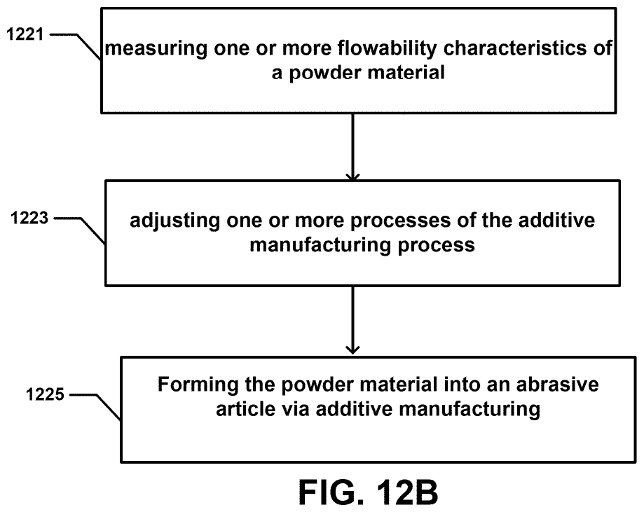

FIG. 12A includes a method for forming an abrasive article according to an embodiment. In one aspect, the process may begin at step 1201 with treating a powder material including abrasive particles and precursor bond material to control at least one flowability characteristic of the powder material. The process may continue at step 1203, which may include forming the powder material into an abrasive article via an additive manufacturing process. The additive manufacturing process may include any one or a combination of features of the claims and embodiments herein. As will be appreciated, the terms powder material and abrasive precursor powder or raw material powder may be the same. As used herein, controlling at least one flowability characteristic of the powder material includes changing a flowability characteristic of the powder material. In still another embodiment, controlling at least one flowability characteristic includes measuring and adjusting a flowability characteristic of the powder material until it is within a predetermined value, and further dispensing the powder material after measuring and adjusting the flowability characteristic of the powder material.

In an embodiment, the process of treating the powder material may include using one or more flowability characteristic of the powder material to calculate a Powder Moisture Score wherein measuring the flowability characteristic includes capturing and storing electronic information related to the position and/or movement of the powder material. In still another embodiment, measuring the flowability characteristic includes capturing and storing electronic information related to the position and/or movement of the powder material and using the electronic information to calculate a flowability characteristic selected from the group of a Flowability Factor Angle, a volume of powder material, a Surface Fractal Factor, a Linearity Factor, Avalanche Angle, Avalanche Angle Median, Avalanche Energy, Avalanche Energy Median, Median Avalanche Time, Avalanche Rest Angle, Dynamic Density, or any combination thereof.

According to one embodiment, the process of treating the powder material may include at least one process of thermally treating, chemically treating, mechanically treating, and/or irradiating the powder material to change the moisture content of the powder material. In one embodiment, treating the powder material may include changing and/or maintaining the moisture content of the powder material. It has been found through empirical studies that a mixture of different types of materials (e.g., abrasive particles and bond precursor material) may have notably different properties, including, for example, but not limited to, propensity to absorb water. The studies have demonstrated that such differences in the properties of the materials in the powder material (e.g., composition, particle size distribution, etc.) may cause unexpected changes in flowability of the powder material, which may negatively impact the additive manufacturing process. Embodiments herein may facilitate improved evaluation and control of the powder material flowability, which is shown in the empirical studies to improve large-scale additive manufacturing processes.

In one non-limiting embodiment, treating the powder may include changing the propensity of the powder material to absorb or adsorb water. In one particular embodiment, such treating may include treating at least a portion of the powder material with a material that may reduce the water absorption and/or water adsorption of the powder material. Such treatment may include, but is not limited to, a surface coating on the powder material to reduce the water absorption of the particles. In another embodiment, treatment may include the incorporation of a water-absorbing material of a particular size relative to the size of particulates in the powder material to alter the flowability characteristics of the powder material

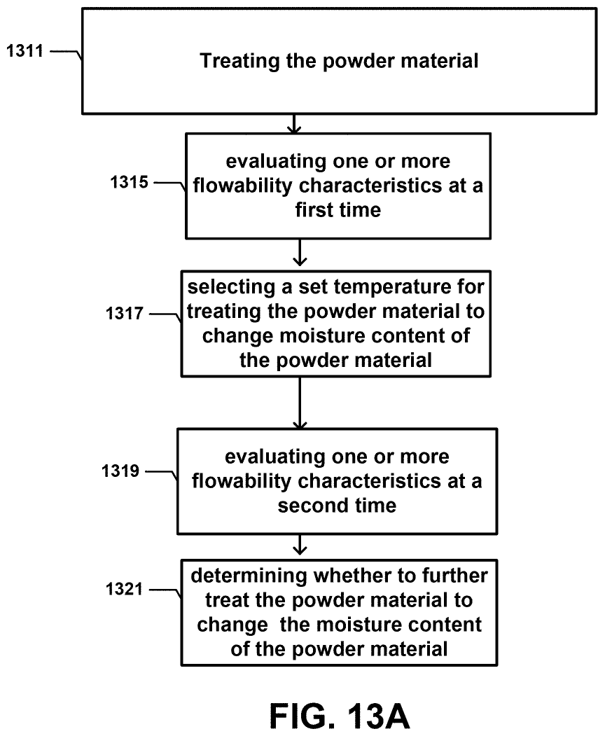

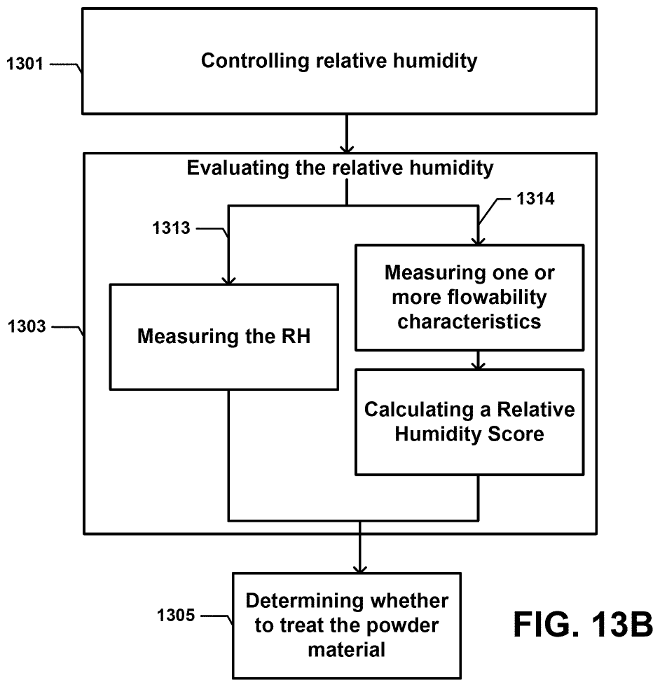

FIG. 13A includes a process for treating the powder material 1311 according to one embodiment. In one instance, the process for treating the powder material begins at step 1313. The process at step 1313 includes evaluating one or more flowability characteristics of the powder material at a first time. After evaluating to one of more flowability characteristics, the process continues to step 1317 including selecting a set temperature for treating the powder material to change moisture content of the powder material.

After step 1317 the process can continue at step 1319 by evaluating the one or more flowability characteristics of the powder material at a second time different from the first time. After evaluating the one or more flowability characteristics of the powder material at a second time, the process can continue to step 1321 by determining whether to further treat the powder material to change the moisture content of the powder material. In an embodiment, treating the powder material can include a continuous and simultaneous process of treating and forming. In still another embodiment, treating includes treating the powder material in a treating vessel, and wherein the treating vessel is coupled to a dispensing mechanism configured to deposit a treated powder material into one or more layers of the build box. In yet another embodiment, treating can include treating the powder material in a treating vessel that is in fluid communication with a dispensing mechanism such that treated powder from the treating vessel is moved from the treating vessel to the dispensing mechanism, wherein the dispensing mechanism is configured to dispense the treated powder into one or more layers of powder material in the build box as part of a binder jetting operation.

FIG. 12B includes a method for forming an abrasive article according to an embodiment. In one aspect, the process may begin at step 1221 with measuring one or more flowability characteristics of a powder material. The process may continue at step 1225, which may include forming the powder material into an abrasive article via an additive manufacturing process. The additive manufacturing process may include any one or a combination of features of the claims and embodiments herein. As will be appreciated, the terms powder material and abrasive precursor powder or raw material powder may be the same. As used herein, measuring one or more flowability characteristics includes moving the powder material and evaluating one or more flowability characteristic of the powder material based upon its movement. In still another embodiment, evaluating one or more flowability characteristic of the powder material based upon its movement includes monitoring the movement of the powder material using one or more sensors configured to store data with respect to the movement. As used herein, measuring the one or more flowability characteristics may be selected from the group of a Flowability Factor Angle, a volume of powder material, a Surface Fractal Factor, a Linearity Factor, Avalanche Angle, Avalanche Angle Median, Avalanche Energy, Avalanche Energy Median, Median Avalanche Time, Avalanche Rest Angle, Dynamic Density, or any combination thereof. In still another embodiment, measuring the flowability characteristic may include capturing and storing electronic information related to the position and/or movement of the powder material and using the electronic information to calculate a flowability characteristic selected from the group of a Flowability Factor Angle, a volume of powder material, a Surface Fractal Factor, a Linearity Factor, Avalanche Angle, Avalanche Angle Median, Avalanche Energy, Avalanche Energy Median, Median Avalanche Time, Avalanche Rest Angle, Dynamic Density, or any combination thereof.

The process may optionally continue to step 1223 prior to step 1225, which may include adjusting one or more processes of the additive manufacturing process based on the measuring of the one or more flowability characteristics of the powder material. As used herein, measuring includes measuring and adjusting at least one of the flowability characteristics of the powder material including Flowability Factor Angle, moisture content, Linearity Factor, Surface Fractal Factor, Dynamic Density, Avalanche Energy, Avalanche Energy Median, Avalanche Angle, or any combination thereof. As used herein, adjusting one or more processes of the additive manufacturing process includes any one of recycling of powder material from a prior additive manufacturing process, blending of recycled powder with virgin powder material, the dispensing technique used to form a layer of the powder material in the build box, treating of the recycled powder material, compacting of the layer of powder material, selecting the type of binder material, the binder saturation, or any combination thereof.

FIG. 13B includes a process for controlling the moisture content of the powder material according to one embodiment. In one instance, the process for controlling the moisture content begins at step 1301. The process at step 1303 includes evaluating the moisture content of the powder material. As provided in FIG. 13B, evaluating the moisture content of the powder material may be conducted using one or more process pathways, including, for example, pathways 1313 and 1314. Either pathway 1313 or 1314 may be used by itself. Alternatively, both pathways 1313 and 1314 may be used to evaluate the moisture content of the powder material.

According to one embodiment, evaluating the moisture content of the powder material may include a direct measurement of the moisture content of the powder material according to pathway 1313. Any method known to those of skill in the art may be used to measure and quantify the moisture content of the powder material.

The process for evaluating the moisture content of the powder material according to pathway 1314 may include a) measuring a flowability characteristic of the powder material and 2) optionally calculating a Powder Moisture Score of the powder material that may directly or indirectly relate to the actual moisture content of the powder material as provided at pathway 1314. As such, one may use one or both process pathways 1313 and/or 1314 for evaluating the moisture content of the powder material.

It will be appreciated that the flowability of the powder material may be evaluated without necessarily using such information to calculate a Powder Moisture Score. Stated alternatively, in one embodiment, the processes for making abrasive articles using the additive manufacturing processes of the embodiments herein may be based on measuring the one or more flowability characteristics. That is, the data gathered with respect to the one or more flowability characteristics may be used to evaluate and adapt the additive manufacturing process.

After evaluating the moisture content of the powder material at step 1303 the process continues at step 1305 by determining whether to treat the powder material. Accordingly, in one particular instance, the process for controlling the moisture content of the powder material may include a) evaluating the moisture content of the powder material at a first time, and b) selecting a treatment option (e.g., a set temperature) for treating the powder material to change the moisture content of the powder material. In an embodiment, the method for controlling the moisture content may further include a) evaluating the moisture content of the powder material at a second time different from the first time and b) determining whether to further treat the powder material to change the moisture content of the powder material. Accordingly, in certain embodiments, the process for evaluating the moisture content of the powder material can include a continuous process wherein the moisture content of the powder material is evaluated at different times or at different intervals, and wherein adjustments to the treatment may be made based upon the continuous evaluations. As will be described in more detail herein, such a process may optionally make use of electronic devices and sensors for the continuous evaluations.

Referring again to pathway 1314, in one embodiment, measuring the flowability characteristic can include moving the powder material under known conditions and evaluating a flowability characteristic of the powder material based upon its movement. Information related to the flowability characteristics may be used to calculate the Powder Moisture Score of the powder material. In another non-limiting embodiment, the process can include a) measuring at least one flowability characteristic of the powder material at a first time and b) selecting a treatment option (e.g., set temperature) for treating the dry particulate mixture to change the moisture content of the powder material. Optionally, the process may further include a) measuring the at least one flowability characteristic of the powder material at a second time different from the first time and b) determining whether to further treat the powder material to change the moisture content of the powder material. Accordingly, in certain embodiments, the process for evaluating the moisture content of the powder material can include a continuous process wherein one or more flow characteristics of the powder material is evaluated at different times or at different intervals, and wherein adjustments to the treatment may be made based upon the continuous evaluations. As will be described in more detail herein, such a process may optionally make use of electronic devices and sensors for the continuous evaluations.

As noted herein, in one embodiment, measuring the flowability characteristic can include moving the powder material under known conditions and evaluating a flowability characteristic of the powder material based upon its movement. In a more particular embodiment, measuring may include tumbling the powder material and evaluating one or more flowability characteristics of the powder material during tumbling. The characteristic of the powder material during tumbling may be evaluated for one or more flowability characteristics, from which the Powder Moisture Score of the powder material may be generated.

According to one embodiment, measuring one or more flowability characteristics may include capturing and storing electronic information related to the position and/or movement of the powder material. For example, in one particular embodiment, measuring the one or more flowability characteristics may include capturing and storing electronic information related to the position and/or movement of the powder material at different times, such that the one or more flowability characteristics may be monitored over time. In another non-limiting embodiment, the one or more flowability characteristics may be selected from the group of a Flowability Factor Angle, a volume of powder material, a Surface Fractal Factor, a Linearity Factor, Avalanche Angle, Avalanche Angle Median, Avalanche Energy, Avalanche Energy Median, Median Avalanche Time, Avalanche Rest Angle, Dynamic Density, or any combination thereof.

As used herein, the Avalanche Energy is the amount of energy released by an avalanche in the sample powder and is calculated by subtracting the energy level of the powder after an avalanche from the energy level before the avalanche. The reported avalanche energy is the average avalanche energy for all of the measurements taken for a sample powder. The Avalanche Energy Median is the median value or 50 percent point of the distribution of the avalanche energy.

The imaging apparatus and software can be configured to take images of the powder and measure the angle of the powder at the maximum power prior to the start of an avalanche occurrence. The Avalanche Angle is the average value for all the avalanche angles measured for a powder sample. The angle is measured the same as provided in FIG. 11A. The Avalanche Angle Median is the median angle value for the distribution of Avalanche Angles measured for a powder sample.

As used herein, the Surface Fractal Factor is the fractal dimension of the surface of the powder and provides an indication of how rough the powder surface is. The measurement is made after each avalanche to determine how the powder reorganizes itself. The standard fractal calculation is used and results are normalized to give a range of 1 to 11. If the powder forms a smooth even surface, the surface fractal will be near two. If the surface is rough and jagged, the surface fractal will be greater than 2.

As used herein, the imaging apparatus and software can measure the density of the sample by measuring the volume. Knowing the mass of the powder sample in the drum, the dynamic density of the powder is calculated, which can be averaged to be the Average Dynamic Density.

As used herein, the Surface Linearity Factor is the linear correlation value for the surface of the powder after an avalanche.

The volume (cc) of the sample is measured using the image analysis software based on the volume of the powder on a pixel-by-pixel basis. The volume is the average volume for all measurements of the sample of the powder material.

The Avalanche Time (sec.) is the average time between the avalanche events. The Median Avalanche Time is the median value for the distribution of measured avalanche times for a sample of powder material.

The Avalanche Rest Angle (degrees) is the angle of the powder at the minimum power of the powder material at the end of an avalanche occurrence. The Avalanche Rest Angle is the average value of all measurements made on a sample of powder material.

In another non-limiting embodiment, measuring the flowability characteristic may include capturing and storing electronic information with one or more image-capturing sensors. In one instance, the process may also include evaluating images from the one or more image-capture sensors to calculate one or more flowability characteristics of the powder material.

FIG. 10 includes an apparatus for evaluating moisture content and/or flowability characteristics of an abrasive precursor powder or other raw material powder. FIGS. 11A, 11B, 11C, and 11D (FIGS. 11A-11D) include depictions of images of a powder material in the apparatus according to an embodiment. In one embodiment, the apparatus 1000 can include a drum 1001 having an interior space 1003 and a viewing port 1005. The drum 901 may be configured to rotate, such as in direction 1002, and move or tumble the powder material contained in the interior space 1003. The apparatus 1000 may optionally include a sensor 1007, which may include, but is not limited to, an image capture device, that may be positioned in a particular manner with respect to the drum 1001 and viewing port 1005 to facilitate evaluation of the movement of the powder material in the interior space 1003 as the drum 1001 is rotated. While not depicted, it will be appreciated that the sensor 1007 may be electronically coupled to one or more computing devices, including, for example, but not limited to a processor capable of storing electronic information associated with the powder material, and more particularly, the movement of the powder material. Moreover, any of the data, such as images of the powder material, may be associated with a given time and analyzed using image analysis software, such as ImageJ.

According to another embodiment, the apparatus 1000 may be part of or coupled to a system 1051 configured to monitor one or more aspects of the apparatus 1000. For example, in one embodiment, the system 1051 may include one or more sensors, including for example, but not limited to sensors 1052 and 1053, which may be configured to sense operational parameters of the apparatus. For example, in one non-limiting embodiment, the sensor 1052 may be configured to monitor the power and/or current used by the apparatus over time. In another non-limiting embodiment, the sensor 1053 may be configured to monitor the torque to the motor used to turn the drum 1001. Moreover, the data collected by the one or more sensors 1052 and/or 1053 may be used in combination with other data, including for example, but not limited to, data from the sensor 1007 to evaluate the movement of the powder material in the drum 1001, which may assist with evaluation of the flowability of the powder material, which may further be used to assist with evaluating the moisture content of the powder material.

FIGS. 11A-11D include depictions of images of the powder material. In one embodiment, the sensor 1007 may capture electronic information related to any one or a combination of the flowability characteristics. FIG. 11A includes an image of the powder material 1101 and how such an image can be used to calculate a Flowability Factor Angle 1103. The Flowability Factor Angle 1103 is a measure of the angle of the powder material 1101 during rotating of the drum 1001 under known conditions and is an indication of how the powder material flows. In one embodiment, the line 1102 is drawn between the two points 1104 and 1105. Point 1104 represents the highest point of the intersection of the powder material 1101, the wall of the interior space 1003 of the drum 1001, and the empty space 1106 inside the interior space 1003. Point 1105 represents the lowest point of the intersection of the powder material 1101, the wall of the interior space 1003 of the drum, and the empty space 1106. Line 1107 is drawn from point 1105 and parallel to the floor or representing a plane perpendicular to the direction of gravity. The Flowability Factor Angle 1103 represents the angle between the lines 1102 and 1107. In a non-limiting embodiment, the Flowability Factor Angle 1103 may be evaluated by imaging processing software capable of analyzing one or more images taken over a given time under known conditions for rotating the powder material. In a non-limiting embodiment, it may be preferred that the Flowability Factor Angle is measured as the angle 1110 between a midpoint 1109 on the surface of the powder material 1101 and point 1104. In some instances, the powder surface may bend (like a L-shape) and calculating the Flowability Factor Angle 1103 between the midpoint 1109 and the point 1104 is more accurate. Unless stated otherwise, all angles (e.g., Flowability Factor Angle, Avalanche Angle, etc.) are measured as angle 1110 between the midpoint 1109 and point 1104. The Flowability Factor Angle is measured continuously over time and is different from the Avalanche Angle, which is measured as the angle of the powder at the maximum power prior to the start of an avalanche occurrence.

In some non-limiting instances, the higher the Flowability Factor Angle 1103, the more cohesive and less flowable the powder material. Still, based on empirical studies, if the flowability of the powder is too high, further processing can be impacted, including for example, but not limited to, a compaction process. Some empirical data developed by the Applicant appears to indicate that powder materials having a higher flowability may not be as easily compacted, which can impact the green body strength and ultimately the formability and properties of the finally-formed abrasive article. As such, it has been found through the empirical studies that certain powder materials, including abrasive particles and a precursor powder material, may have a particular Flowability Factor Angle 1103 that is most suitable for forming an abrasive article, particularly large-sized abrasive articles formed via additive manufacturing. In one embodiment, the Flowability Factor Angle 1103 may be used alone or in combination with any of the other flowability characteristics to evaluate the flowability of the powder material. In one optional embodiment, the Flowability Factor Angle 1103 may be used alone or in combination with any of the other flowability characteristics to calculate the Powder Moisture Score of the powder material.

FIG. 11B includes an image of the powder material 1101 and how such an image can be used to calculate a Linearity Factor of the powder material 1101. The Linearity Factor is a measure of the deviations of the surface of the powder material 1111 from a straight line 1112 drawn between points 1113 and 1114. The Linearity Factor may be a flowability characteristic that is used alone or in combination with another flowability characteristic used to evaluate the flowability of the powder material, which may optionally be used to calculate a Powder Moisture Score of the powder material. Point 1114 represents the highest point of the intersection of the powder material 1101, the wall of the interior space 1003 of the drum 1001, and the empty space 1106 inside the interior space 1003. Point 1113 represents the lowest point of the intersection of the powder material 1101, the wall of the interior space 1003 of the drum, and the empty space 1106. Like any of the flowability characteristics herein, it will be appreciated that the Linearity Factor may be calculated by capturing images that are stored as electronic data and evaluating the data using image processing software.

FIG. 11C includes an image of the powder material 1101 and how such an image can be used to calculate a volume of the powder material 1101. The volume of powder material is based on at least the area of the powder material 1101 as viewed in the interior space 1003 of the drum 1001. The volume of powder material 1101 may also be based on a known weight of the powder material 1101 in the drum 1001 in addition to the area of the powder material 1101 as viewed in cross-section as illustrated in FIG. 11C. Like any of the flowability characteristics herein, it will be appreciated that the volume of the powder material 1101 may be calculated by capturing images of the area of the powder material 1101 that are stored as electronic data and evaluating the data using image processing software.

FIG. 11D includes an image of the powder material 1101 and how such an image can be used to calculate a Surface Fractal Factor of the powder material 1101. The Surface Fractal Factor of powder material can be based on evaluation of the surface of the powder material 1131 as viewed in the interior space 1003 of the drum 1001. The Surface Fractal Factor can be evaluated by capturing images of the area of the powder material 1101 that are stored as electronic data and evaluating the data using image processing software. The Surface Fractal Factor can define the smoothness or irregularity of the surface of the powder material 1101 and provide an indication of the ease of flowability of the powder, with a surface having greater smoothness indicating better flowability.

It will be appreciated that other aspects of the flowability characteristics of the powder material may be monitored and evaluated to control and/or adapt one or more aspects of the additive manufacturing process. The flowability characteristics of the embodiments herein are not so limited and are intended as exemplary embodiments but in no way limiting of the type of flowability characteristics that may be used to control and/or adapt one or more aspects of the additive manufacturing process.

According to an embodiment, the process of forming an abrasive article can include forming a green abrasive body as provided in other embodiments herein. For example, in a non-limiting embodiment, the process of forming can include a) creating one or more layers of the powder material; b) selectively binding portions of the one or more layers with a binder material; and c) converting the binder material to at least partially solidify the binder material and bind portions of powder material from the one or more layers.

According to another aspect, the process for treating the powder material includes changing a moisture content of the powder material. In a more particular embodiment, treating can include heating the powder material to reduce the moisture content of the powder material.

In one non-limiting embodiment, the powder material can undergo treatment such that the change in the moisture content of the powder material from treating to forming of the abrasive article or a portion of the abrasive article is minimized. In certain embodiments, it may be desirable that the powder material is used for forming the abrasive article (e.g., deposited into one or more layers in a binder jetting operation) within a reasonable amount of time upon achieving a target flowability characteristic and/or moisture content. In one particular instance, the drum 1001 may be closely associated with the additive manufacturing apparatus to facilitate rapid deposition of the powder material upon achieving the desired flowability characteristics and/or moisture content. In another non-limiting embodiment, the drum 1001 may be coupled directly or indirectly to a dispensing mechanism associated with the additive manufacturing apparatus configured to deposit the treated powder material into one or more layers and selectively bind portions of the treated powdered material in the one or more layers with a binder. For example, in one embodiment, the drum is suitable as a reservoir for holding the powder material and also the drum is suitable as a treating vessel for treating the powder material immediately prior to deposition of the powder material as one or more layers in an additive manufacturing operation.

According to one non-limiting embodiment, the apparatus 1000 may further include an energy source 1009. In one embodiment, the energy source 1009 may emit radiation used for treating the powder material, such as heating the powder material. In a particular embodiment, the energy source 1009 may emit IR radiation suitable for heating the powder material in the drum 1001 thereby using the drum 1001 as a treating vessel to heat the powder and change the moisture content of the powder material.

In still another non-limiting embodiment, the process for treating the powder material can include a) treating at least a portion of the powder material to create a treated powder material having a particular moisture content, and b) dispensing a portion of the treated powder material while simultaneously treating the portion of the powder material. In one optional embodiment, treating the powder material may include a continuous and simultaneous process of treating and forming. Treating includes treating the powder material in a treating vessel, and wherein the treating vessel is coupled to a dispensing mechanism configured to deposit a treated powder material into one or more layers and selectively bind portions of the treated powdered material in the one or more layers with a binder.

In another aspect, treating the powder material prior to forming the powder material via additive manufacturing may include any of the other treating processes as disclosed herein. For example, in one embodiment, treating may include dissolving and/or washing an organic material from at least a portion of the powder material.

According to one embodiment, the change in moisture content of the powder material from treating to forming is not greater than 10% (plus or minus). In another non-limiting embodiment, the change in the moisture content of the powder material may be less, such as not greater than 9% or not greater than 8% or not greater than 7% or not greater than 6% or not greater than 5% or not greater than 4% or not greater than 3% or not greater than 2% or not greater than 1%. Still, in one non-limiting embodiment, the change in the moisture content of the powder material can be at least 0.001% or at least 0.01%. It will be appreciated that the change in the moisture content of the powder material between treating and forming can be within a range including any of the minimum and maximum values noted above.

According to another embodiment, treating the powder material may include treating the powder no more than 24 hours prior to forming the abrasive article. In another embodiment, the delay between treating and forming can be no more than 20 hours or no more than 16 hours or no more than 12 hours or no more than 10 hours or no more than 8 hours or no more than 6 hours or no more than 4 hours or no more than 2 hours or no more than 1 hour.

In one aspect, the process of the embodiments herein may facilitate the formation of an abrasive precursor powder for additive manufacturing that may have a particular Flowability Factor Angle of not greater than 80 degrees. In another non-limiting embodiment, the Flowability Factor Angle can be not greater than 78 degrees, such as not greater than 75 degrees or not greater than 72 degrees or not greater than 70 degrees or not greater than 68 degrees or not greater than 65 degrees or not greater than 62 degrees or not greater than 60 degrees or not greater than 58 degrees or not greater than 55 degrees or not greater than 52 degrees or not greater than 50 degrees or not greater than 48 degrees or not greater than 45 degrees or not greater than 42 degrees or not greater than 40 degrees or not greater than 38 degrees or not greater than 35 degrees or not greater than 32 degrees or not greater than 30 degrees or not greater than 28 degrees or not greater than 25 degrees. In another non-limiting embodiment, the Flowability Factor Angle may be at least 1 degree or at least 5 degrees or at least 10 degrees or at least 12 degrees or at least 15 degrees or at least 18 degrees or at least 20 degrees or at least 22 degrees or at least 25 degrees or at least 28 degrees or at least 30 degrees or at least 32 degrees or at least 35 degrees or at least 38 degrees or at least 40 degrees. It will be appreciated that the Flowability Factor Angle can be within a range including any of the minimum and maximum values noted above.

In one aspect, the process of the embodiments herein may facilitate the formation of an abrasive precursor powder for additive manufacturing that may have a particular Avalanche Angle of not greater than 80 degrees. In another non-limiting embodiment, the Avalanche Angle can be not greater than 78 degrees, such as not greater than 75 degrees or not greater than 72 degrees or not greater than 70 degrees or not greater than 68 degrees or not greater than 65 degrees or not greater than 62 degrees or not greater than 60 degrees or not greater than 58 degrees or not greater than 55 degrees or not greater than 52 degrees or not greater than 50 degrees or not greater than 48 degrees or not greater than 45 degrees or not greater than 42 degrees or not greater than 40 degrees or not greater than 38 degrees or not greater than 35 degrees or not greater than 32 degrees or not greater than 30 degrees or not greater than 28 degrees or not greater than 25 degrees. In another non-limiting embodiment, the Avalanche Angle may be at least 1 degree or at least 5 degrees or at least 10 degrees or at least 12 degrees or at least 15 degrees or at least 18 degrees or at least 20 degrees or at least 22 degrees or at least 25 degrees or at least 28 degrees or at least 30 degrees or at least 32 degrees or at least 35 degrees or at least 38 degrees or at least 40 degrees. It will be appreciated that the Avalanche Angle can be within a range including any of the minimum and maximum values noted above.

In one aspect, the process of the embodiments herein may facilitate the formation of an abrasive precursor powder for additive manufacturing that may have a particular Avalanche Angle Median of not greater than 80 degrees. In another non-limiting embodiment, the Avalanche Angle Median can be not greater than 78 degrees, such as not greater than 75 degrees or not greater than 72 degrees or not greater than 70 degrees or not greater than 68 degrees or not greater than 65 degrees or not greater than 62 degrees or not greater than 60 degrees or not greater than 58 degrees or not greater than 55 degrees or not greater than 52 degrees or not greater than 50 degrees or not greater than 48 degrees or not greater than 45 degrees or not greater than 42 degrees or not greater than 40 degrees or not greater than 38 degrees or not greater than 35 degrees or not greater than 32 degrees or not greater than 30 degrees or not greater than 28 degrees or not greater than 25 degrees. In another non-limiting embodiment, the Avalanche Angle Median may be at least 1 degree or at least 5 degrees or at least 10 degrees or at least 12 degrees or at least 15 degrees or at least 18 degrees or at least 20 degrees or at least 22 degrees or at least 25 degrees or at least 28 degrees or at least 30 degrees or at least 32 degrees or at least 35 degrees or at least 38 degrees or at least 40 degrees. It will be appreciated that the Avalanche Angle Median can be within a range including any of the minimum and maximum values noted above.

According to another embodiment, the process of the embodiments herein may facilitate the formation of an abrasive precursor powder for additive manufacturing that may have a particular Dynamic Density of at least 1.00 g/cc. In one non-limiting embodiment, the Dynamic Density can be at least 1.10 g/cc or at least 1.15 g/cc or at least 1.20 g/cc or at least 1.25 g/cc or at least 1.30 g/cc or at least 1.35 g/cc or at least 1.40 g/cc or at least 1.45 g/cc or at least 1.50 g/cc or at least 1.55 g/cc or at least 1.60 g/cc or at least 1.65 g/cc or at least 1.70 g/cc or at least 1.75 g/cc or at least 1.80 g/cc or at least 1.85 g/cc or at least 1.90 g/cc. In another non-limiting embodiment, the Dynamic Density can be not greater than 4.00 g/cc, such as not greater than 3.90 g/cc or not greater than 3.80 g/cc or not greater than 3.70 g/cc or not greater than 3.60 g/cc or not greater than 3.50 g/cc or not greater than 3.40 g/cc or not greater than 3.30 g/cc or not greater than 3.20 g/cc or not greater than 3.10 g/cc or not greater than 3.00 g/cc or not greater than 2.90 g/cc or not greater than 2.80 g/cc or not greater than 2.70 g/cc or not greater than 2.60 g/cc or not greater than 2.50 g/cc or not greater than 2.40 g/cc or not greater than 2.30 g/cc or not greater than 2.20 g/cc or not greater than 2.10 g/cc or not greater than 2.00 g/cc. It will be appreciated that the Dynamic Density can be within a range including any of the minimum and maximum values noted above.

According to another embodiment, the process of the embodiments herein may facilitate the formation of an abrasive precursor powder for additive manufacturing that may have a particular Avalanche Energy of at least 5 mJ/kg. In one non-limiting embodiment, the Avalanche Energy can be at least 6 mJ/kg or at least 7 mJ/kg or at least 8 mJ/kg or at least 9 mJ/kg or at least 10 mJ/kg or at least 11 mJ/kg or at least 12 mJ/kg or at least 13 mJ/kg or at least 14 mJ/kg or at least 15 mJ/kg or at least 16 mJ/kg or at least 17 mJ/kg or at least 18 mJ/kg. In another non-limiting embodiment, the Avalanche Energy can be not greater than 50 mJ/kg or not greater than 45 mJ/kg or not greater than 40 mJ/kg or not greater than 37 mJ/kg or not greater than 35 mJ/kg or not greater 33 mJ/kg or not greater than 32 mJ/kg or not greater than 31 mJ/kg or not greater than 30 mJ/kg or not greater than 29 mJ/kg or not greater than 28 mJ/kg or not greater than 27 mJ/kg or not greater than 26 mJ/kg or not greater than 25 mJ/kg or not greater than 24 mJ/kg or not greater than 23 mJ/kg or not greater than 22 mJ/kg or not greater than 21 mJ/kg or not greater than 20 mJ/kg. It will be appreciated that the Avalanche Energy can be within a range including any of the minimum and maximum values noted above.

According to another embodiment, the process of the embodiments herein may facilitate the formation of an abrasive precursor powder for additive manufacturing that may have a particular Avalanche Energy Median of at least 5 mJ/kg. In one non-limiting embodiment, the Avalanche Energy Median can be at least 6 mJ/kg or at least 7 mJ/kg or at least 8 mJ/kg or at least 9 mJ/kg or at least 10 mJ/kg or at least 11 mJ/kg or at least 12 mJ/kg or at least 13 mJ/kg or at least 14 mJ/kg or at least 15 mJ/kg or at least 16 mJ/kg or at least 17 mJ/kg or at least 18 mJ/kg. In another non-limiting embodiment, the Avalanche Energy Median can be not greater than 50 mJ/kg or not greater than 45 mJ/kg or not greater than 40 mJ/kg or not greater than 37 mJ/kg or not greater than 35 mJ/kg or not greater 33 mJ/kg or not greater than 32 mJ/kg or not greater than 31 mJ/kg or not greater than 30 mJ/kg or not greater than 29 mJ/kg or not greater than 28 mJ/kg or not greater than 27 mJ/kg or not greater than 26 mJ/kg or not greater than 25 mJ/kg or not greater than 24 mJ/kg or not greater than 23 mJ/kg or not greater than 22 mJ/kg or not greater than 21 mJ/kg or not greater than 20 mJ/kg. It will be appreciated that the Avalanche Energy Median can be within a range including any of the minimum and maximum values noted above.

According to another aspect, the processes herein may facilitate formation of an abrasive precursor powder for additive manufacturing that may have a particular moisture content, including, for example, but not limited to a moisture content of not greater than 80% or not greater than 78% or not greater than 75% or not greater than 72% or not greater than 70% or not greater than 68% or not greater than 65% or not greater than 62% or not greater than 60% or not greater than 58% or not greater than 55% or not greater than 52% or not greater than 50% or not greater than 48% or not greater than 45% or not greater than 42% or not greater than 40% or not greater than 38% or not greater than 35% or not greater than 32% or not greater than 30% or not greater than 28% or not greater than 25% or not greater than 22% or not greater than 20% or not greater than 18% or not greater than 15% or not greater than 12% or not greater than 10%. Still, in another non-limiting embodiment, the abrasive precursor powder can have a moisture content of at least 2% or at least 5% or at least 8% or at least 10% or at least 12% or at least 15% or at least 18% or at least 20% or at least 22% or at least 25% or at least 28% or at least 30% or at least 32% or at least 35% or at least 38% or at least 40% or at least 32% or at least 35%. It will be appreciated that the moisture content of the abrasive precursor powder can be within a range including any of the minimum and maximum values noted above.

In another aspect, the abrasive precursor powder may have a Linearity Factor of at least 0.70, such as at least 0.75 or at least 0.80 or at least 0.85 or at least 0.90 or at least 0.92 or at least 0.93 or at least 0.94 or at least 0.95. In one non-limiting embodiment, the Linearity Factor may be not greater than 0.99 or not greater than 0.98, or not greater than 0.97. The Linearity Factor may be within a range including any of the minimum and maximum values noted above.

According to one embodiment, the process may include monitoring one or more of the flowability characteristics over time. For example, in one embodiment, the process may include monitoring the Linearity Factor of the powder material, and more particularly, the change in the Linearity Factor of the powder material over time to evaluate the change in the flowability of the powder material. Such a process may also facilitate selecting one or more suitable treatments for the powder material if the measured values deviate beyond one or more threshold values.

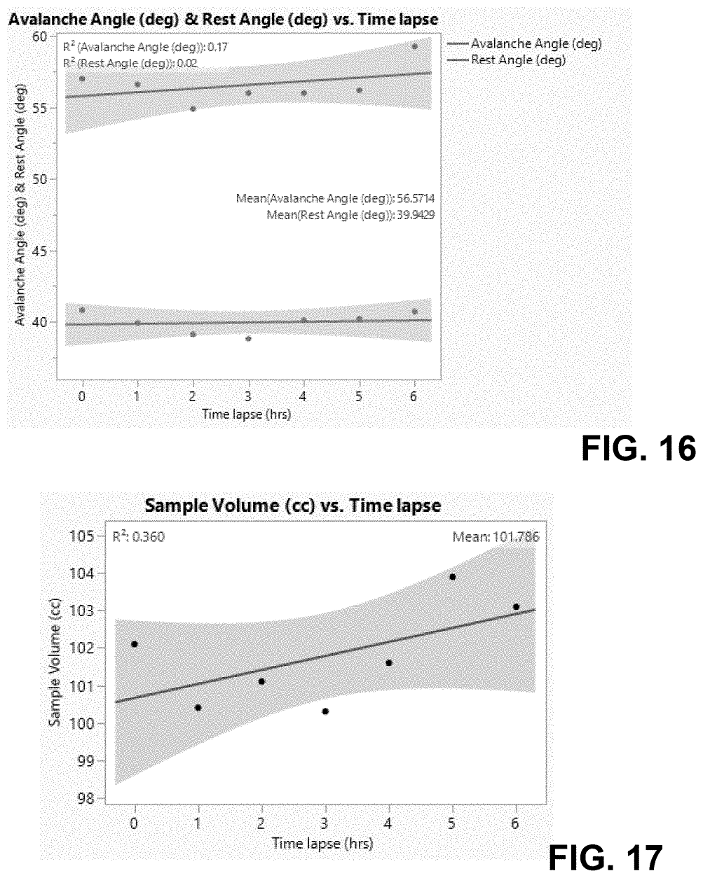

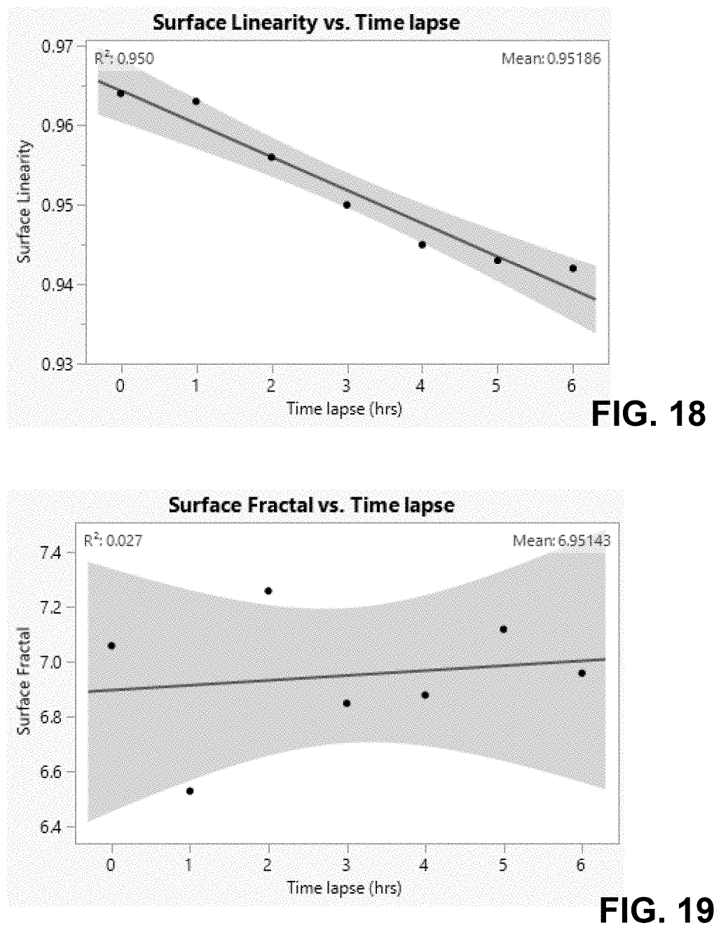

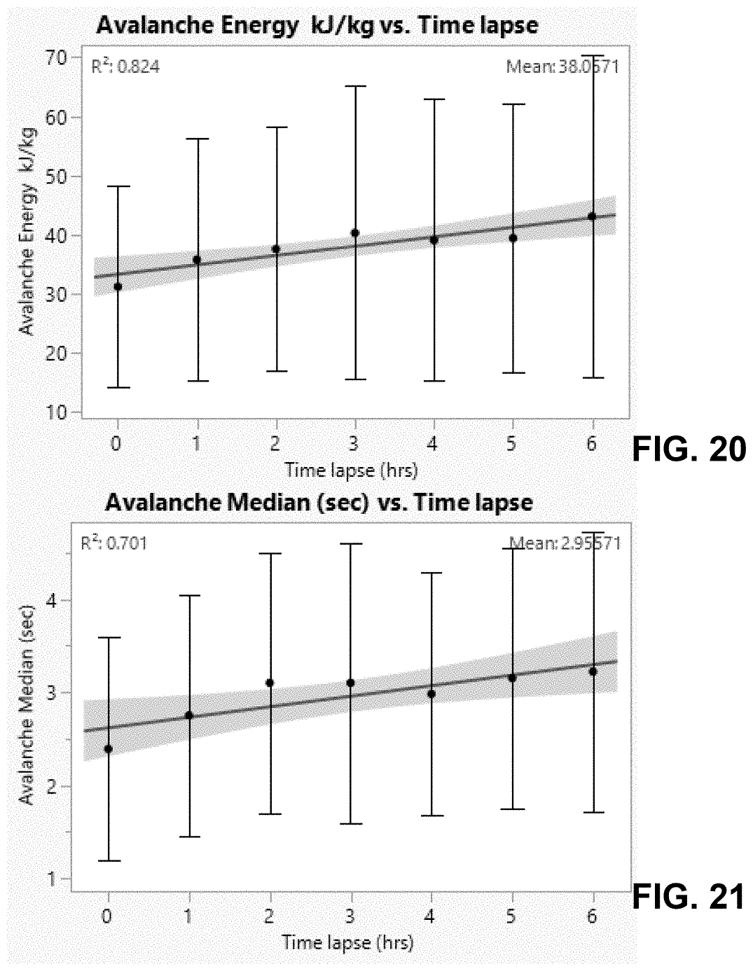

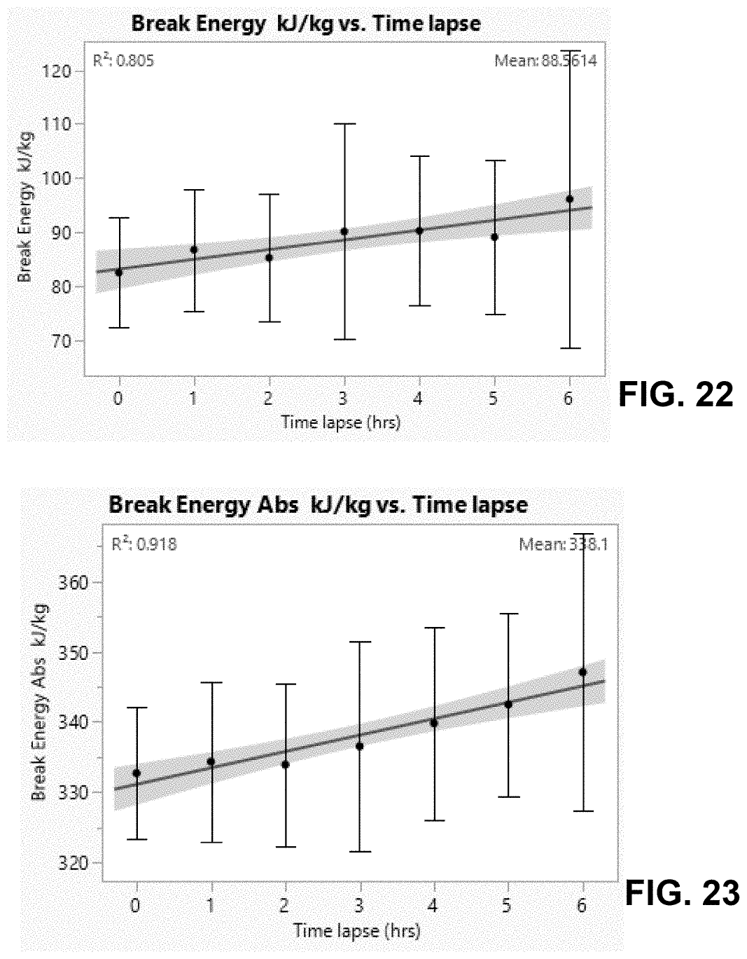

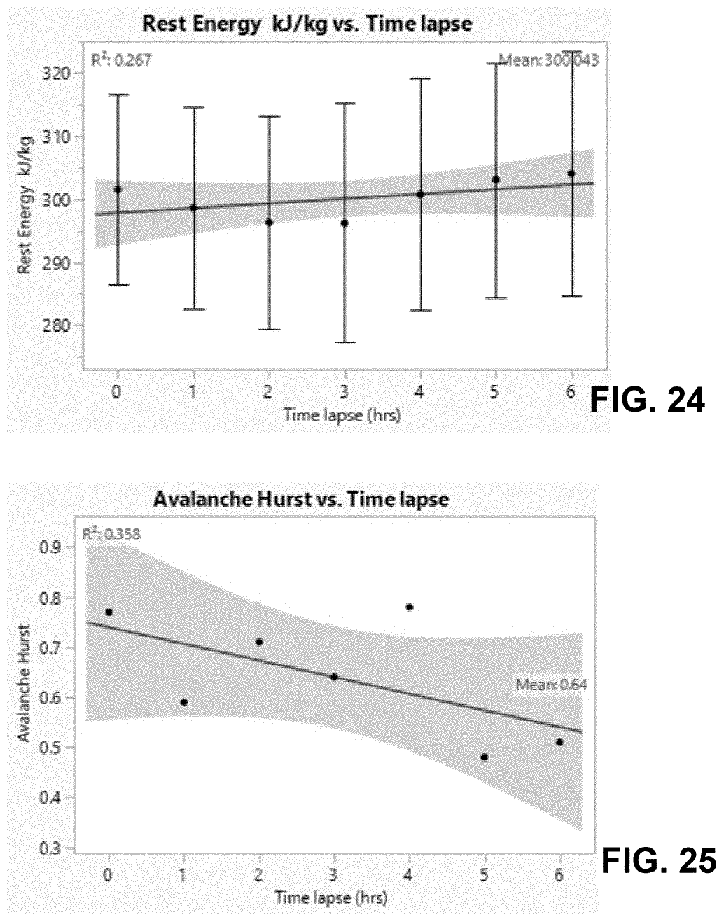

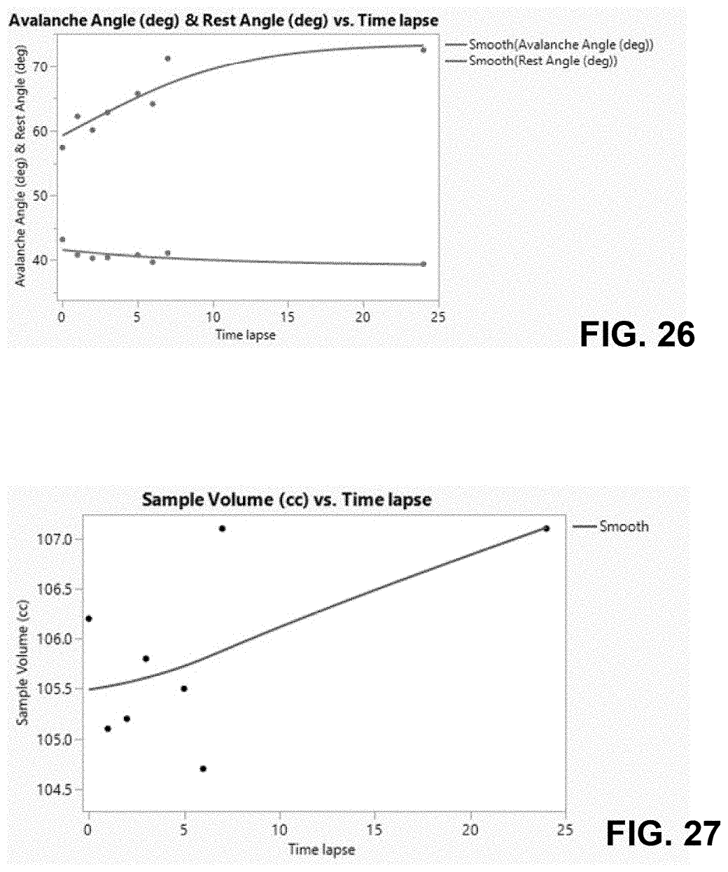

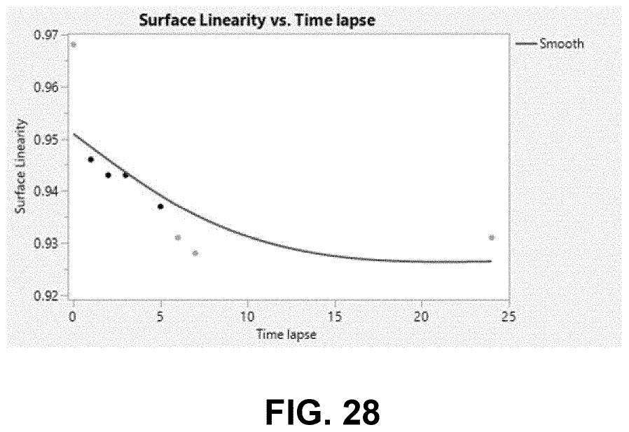

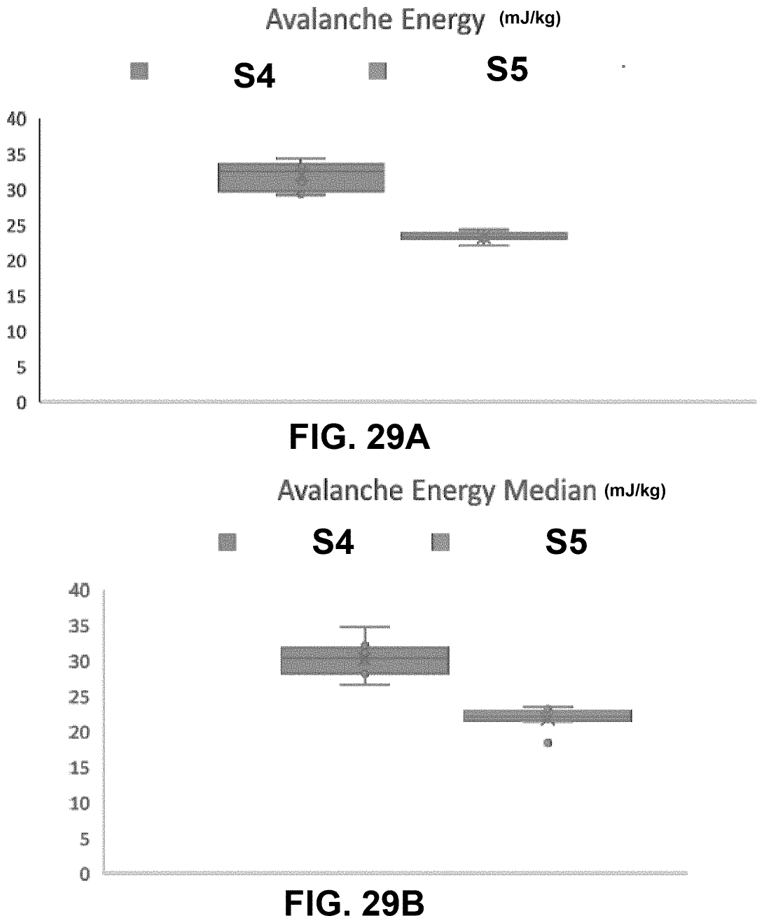

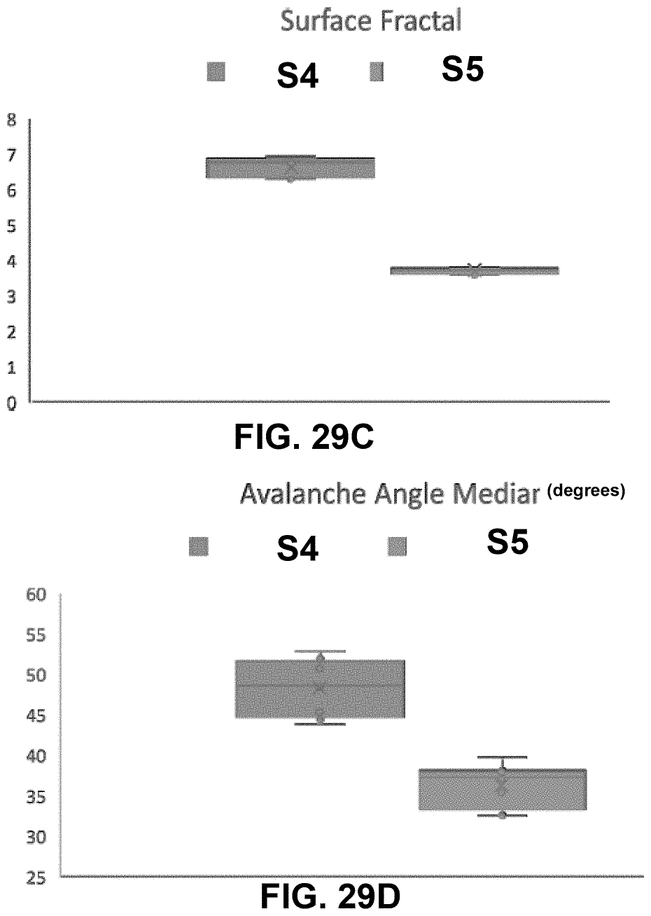

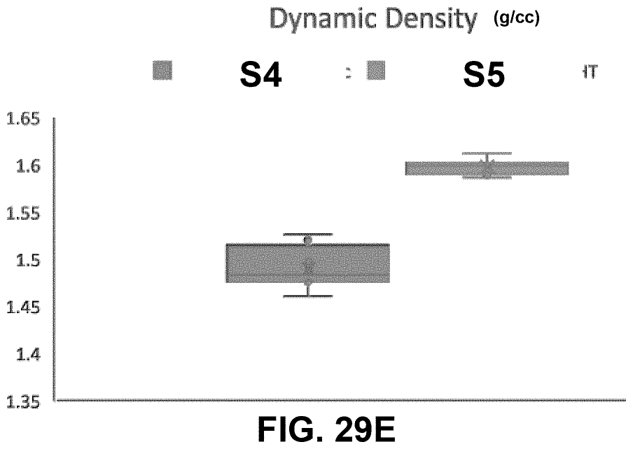

FIGS. 16-26 provide plots of various flowability characteristics of powder materials over time according to embodiments and examples herein. Any of the values provided in FIGS. 16-26 herein provide explicit support for a range including any of the values for any of the corresponding flowability characteristics.

In still another embodiment, the abrasive precursor powder may have a Surface Fractal Factor of at least 1 or at least 2 or at least 3 or at least 4 or at least 5 or at least 6. In another non-limiting embodiment, the Surface Fractal Factor can be not greater than 11 or not greater than 10 or not greater than 9 or not greater than 8 or not greater than 7 or not greater than 6 or not greater than 5 or not greater than 4. It will be appreciated that the Surface Fractal Factor can be within a range including any of the values above or any values described in any of the embodiments, claims, and/or figures.

According to another embodiment, any one or more flowability characteristics may be monitored and altered to adapt to the change in the one or more flowability characteristics. For example, in one embodiment, it may be preferable to limit the change in a flowability characteristic over time. In such instances, the monitoring and treating of the powder material may be completed to limit the change in the value of one or more flowability characteristics of not greater than plus or minus 15% of a target value, average value, or starting value (i.e., first measurement). In another embodiment, the change in the value of the one or more flowability characteristics over time can be not greater than plus or minus 12% or not greater than plus or minus 10% or not greater than plus or minus 9% or not greater than plus or minus 8% or not greater than plus or minus 7% or not greater than plus or minus 6% or not greater than plus or minus 5% or not greater than plus or minus 4% or not greater than plus or minus 3% or not greater than plus or minus 2% or not greater than plus or minus 1% of a target value, average value or starting value.

In another non-limiting embodiment, the distribution of any one or more features of the abrasive articles can be evaluated. The shape of the distribution for such measured features, particularly dimensional features, may be evaluated via kurtosis.

In an embodiment, the thickness of the green body may facilitate improved manufacturing and/or performance of the abrasive article. In an embodiment, the thickness of the green body may be at least 0.1 microns such as at least 0.5 microns or at least 1 micron or at least 2 microns or at least 5 microns or at least 10 microns or at least 20 microns or at least 30 microns or at least 40 microns or at least 50 microns or at least 100 microns or at least 200 microns or at least 300 microns or at least 500 microns or at least 1000 microns or at least 3000 microns or at least 5000 microns or at least 1 cm or at least 5 cm or at least 10 cm or at least 15 cm or at least 25 cm or at least 30 cm or at least 40 cm or at least 50 cm. In still other embodiment, the length of the green body may be not greater than 100 cm or not greater than 90 cm or not greater than 80 cm or not greater than 70 cm. It will be appreciated the green body may have a thickness between any of the minimum and maximum values noted above, including for example, but not limited to, within a range of at least 0.1 microns to not greater than 100 cm or within a range of at least 0.5 microns to not greater than 70 cm. It will be appreciated that each body of a plurality of abrasive bodies in a batch of abrasive articles may have a thickness of any of the values noted above with respect to the thickness of the green body.

In an embodiment, the length of the green body may facilitate improved manufacturing and/or performance of the abrasive article. In an embodiment, the length of the green body may be at least 1 cm or at least 3 cm or at least 4 cm or at least 7 cm or at least 7.5 cm or at least 8 cm or at least 8.5 cm or at least 9 cm or at least 9.5 cm or at least 10 cm or at least 10.5 cm or at least 11 cm or at least 12 cm or at least 13 cm or at least 14 cm or at least 15 cm or at least 18 cm or at least 20 cm. In still other embodiment, the length of the green body may be not greater than 100 cm such as not greater than 90 cm or not greater than 80 cm or not greater than 70 cm or not greater than 60 cm or not greater than 50 cm or not greater than 40 cm or not greater than 30 cm or not greater than 25 cm. It will be appreciated the green body may have a length between any of the minimum and maximum values noted above, including for example, but not limited to, within a range of at least 1 cm to not greater than 100 cm or within a range of at least 8 cm to not greater than 50 cm. It will be appreciated that each body of a plurality of abrasive bodies in a batch of abrasive articles may have a length of any of the values noted above with respect to the length of the green body.

In an embodiment, the width of the green body may facilitate improved manufacturing and/or performance of the abrasive article. In an embodiment, the width of the green body may be at least 3 cm or at least 3.5 cm or at least 4 cm or at least 4.5 cm or at least 5 cm or at least 5.5 cm or at least 6 cm or at least 6.5 cm or at least 7 cm or at least 7.5 cm or at least 8 cm or at least 8.5 cm or at least 9 cm or at least 9.5 cm or at least 10 cm or at least 10.5 cm or at least 11 cm or at least 12 cm or at least 13 cm or at least 14 cm or at least 15 cm. In still other embodiment, the length of the green body may be not greater than 500 cm such as not greater than 450 cm or not greater than 400 cm or not greater than 350 cm or not greater than 300 cm or not greater than 250 cm or not greater than 200 cm or not greater than 150 cm or not greater than 100 cm. It will be appreciated the green body may have a width between any of the minimum and maximum values noted above, including for example, but not limited to, within a range of at least 1 cm to not greater than 100 cm or within a range of at least 8 cm to not greater than 50 cm. It will be appreciated that each body of a plurality of abrasive bodies in a batch of abrasive articles may have a width of any of the values noted above with respect to the width of the green body.

In an embodiment, the green body may have a primary aspect ratio (length:width) that may facilitate improved manufacturing and/or performance of the abrasive article. In an embodiment, the green body may have a primary aspect ratio (length:width) of at least 1:1 such as at least 1.1:1 or at least 1.2:1 or at least 1.3:1 or at least 1.4:1 or at least 1.5:1 or at least 1.8:1 or at least 2:1 or at least 3:1 or at least 4:1 or at least 5:1 or at least 6:1 or at least 7:1 or at least 8:1 or at least 9:1 or at least 10:1. In still other embodiment, the green body may have a primary aspect ratio (length:width) of not greater than 10000:1 or not greater than 5000:1 or not greater than 1000:1 or not greater than 500:1 or not greater than 200:1 or not greater than 100:1 or not greater than 50:1. It will be appreciated the green body may have a primary aspect ratio (length:width) between any of the minimum and maximum values noted above, including for example, but not limited to, within a range of at least 1:1 to not greater than 10000:1 cm or within a range of at least 6:1 to not greater than 200:1. It will be appreciated that each body of a plurality of abrasive bodies in a batch of abrasive articles may have a primary aspect ratio (length:width) of any of the values noted above with respect to the primary aspect ratio (length:width) of the green body.

In an embodiment, the green body may have a secondary aspect ratio (length:thickness) that may facilitate improved manufacturing and/or performance of the abrasive article. In an embodiment, the green body may have a secondary aspect ratio (length:thickness) of at least 1:1 such as at least 1.1:1 or at least 1.2:1 or at least 1.3:1 or at least 1.4:1 or at least 1.5:1 or at least 1.8:1 or at least 2:1 or at least 3:1 or at least 4:1 or at least 5:1 or at least 6:1 or at least 7:1 or at least 8:1 or at least 9:1 or at least 10:1. In still other embodiment, the green body may have a secondary aspect ratio (length:thickness) of not greater than 10000:1 or not greater than 5000:1 or not greater than 1000:1 or not greater than 500:1 or not greater than 200:1 or not greater than 100:1 or not greater than 50:1. It will be appreciated the green body may have a secondary aspect ratio (length:thickness) between any of the minimum and maximum values noted above, including for example, but not limited to, within a range of at least 1:1 to not greater than 10000:1 cm or within a range of at least 6:1 to not greater than 200:1. It will be appreciated that each body of a plurality of abrasive bodies in a batch of abrasive articles may have a secondary aspect ratio (length:thickness) of any of the values noted above with respect to the secondary aspect ratio (length:thickness) of the green body.

In an embodiment, the green body may have a tertiary aspect ratio (width:thickness) that may facilitate improved manufacturing and/or performance of the abrasive article. In an embodiment, the green body may have a tertiary aspect ratio (width:thickness) of at least 1:1 such as at least 1.1:1 or at least 1.2:1 or at least 1.3:1 or at least 1.4:1 or at least 1.5:1 or at least 1.8:1 or at least 2:1 or at least 3:1 or at least 4:1 or at least 5:1 or at least 6:1 or at least 7:1 or at least 8:1 or at least 9:1 or at least 10:1. In still other embodiment, the green body may have a tertiary aspect ratio (width:thickness) of not greater than 10000:1 or not greater than 5000:1 or not greater than 1000:1 or not greater than 500:1 or not greater than 200:1 or not greater than 100:1 or not greater than 50:1. It will be appreciated the green body may have a tertiary aspect ratio (width:thickness) between any of the minimum and maximum values noted above, including for example, but not limited to, within a range of at least 1:1 to not greater than 10000:1 or within a range of at least 6:1 to not greater than 200:1. It will be appreciated that each body of a plurality of abrasive bodies in a batch of abrasive articles may have a tertiary aspect ratio (width:thickness) of any of the values noted above with respect to the tertiary aspect ratio (width:thickness) of the green body.

In still another embodiment, the green body has a length, a width, and a thickness, and wherein length≥width≥thickness. In still another embodiment, each body of the plurality of bodies has a length, a width, and a thickness, and wherein length≥width≥thickness.

In an embodiment, the green body may have a solid volume that may facilitate improved manufacturing and/or performance of the abrasive article. In an embodiment, the green body may have a solid volume of at least 9 cm³ such as at least 10 cm³ or at least 11 cm³ or at least 12 cm³ or at least 13 cm³ or at least 14 cm³ or at least 15 cm³ or at least 16 cm³ or at least 17 cm³ or at least 18 cm³ or at least 19 cm³ or at least 20 cm³ or at least 21 cm³ or at least 22 cm³ or at least 23 cm³ or at least 24 cm³ or at least 25 cm³ or at least 26 cm³ or at least 27 cm³ or at least 28 cm³ or at least 29 cm³ or at least 30 cm³ or at least 31 cm³ or at least 32 cm³ or at least 33 cm³ or at least 34 cm³ or at least 35 cm³ or at least 36 cm³ or at least 37 cm³ or at least 38 cm³ or at least 39 cm³, or at least 40 cm³ or at least 42 cm³ or at least 44 cm³ or at least 46 cm³ or at least 48 cm³ or at least 50 cm³. In still other embodiment, the green body may have a solid volume of not greater than 5000 cm³ or not greater than 4000 cm³ or not greater than 3000 cm³ or not greater than 2000 cm³ or not greater than 1000 cm³ or not greater than 800 cm³ or not greater than 600 cm³ or not greater than 500 cm³. It will be appreciated the green body may have a solid volume between any of the minimum and maximum values noted above, including for example, but not limited to, within a range of at least 9 cm³ to not greater than 5000 cm³ or within a range of at least 25 cm³ to not greater than 1000 cm³.

In an embodiment, the length of the build box may facilitate improved manufacturing and/or performance of the abrasive article. In an embodiment, the length of the build box may be at least 160 mm such as at least 170 mm or at least 180 mm or at least 190 mm or at least 200 mm or at least 210 mm or at least 220 mm or at least 230 mm or at least 240 mm or at least 250 mm or at least 260 mm or at least 270 mm or at least 280 mm or at least 290 mm or at least 300 mm or at least 310 mm or at least 320 mm or at least 330 mm or at least 340 mm or at least 350 mm or at least 360 mm or at least 370 mm or at least 380 mm or at least 390 mm or at least 400 mm. In still other embodiments, the length of the build box may be not greater than 3000 mm such as or not greater than 2000 mm or not greater than 1000 mm. It will be appreciated the build box may have a length between any of the minimum and maximum values noted above, including for example, but not limited to, within a range of at least 160 mm to not greater than 3000 mm or within a range of at least 200 mm to not greater than 1000 mm.

In an embodiment, the width of the build box may facilitate improved manufacturing and/or performance of the abrasive article. In an embodiment, the width of the build box may be at least 65 mm or at least 70 mm or at least 80 mm or at least 90 mm or at least 100 mm or at least 110 mm or at least 120 mm or at least 130 mm or at least 140 mm or at least 150 mm or at least 160 mm or at least 170 mm or at least 180 mm or at least 190 mm or at least 200 mm or at least 210 mm or at least 220 mm or at least 230 mm or at least 240 mm or at least 250 mm. In still other embodiments, the length of the build box may be not greater than 2000 mm such as or not greater than 1500 mm or not greater than 1000 mm. It will be appreciated the build box may have a width between any of the minimum and maximum values noted above, including for example, but not limited to, within a range of at least 65 mm to not greater than 2000 mm or within a range of at least 200 mm to not greater than 1000 mm.

In an embodiment, the depth of the build box may facilitate improved manufacturing and/or performance of the abrasive article. In an embodiment, the depth of the build box may be at least 65 mm or at least 70 mm or at least 80 mm or at least 90 mm or at least 100 mm or at least 110 mm or at least 120 mm or at least 130 mm or at least 140 mm or at least 150 mm or at least 160 mm or at least 170 mm or at least 180 mm or at least 190 mm or at least 200 mm or at least 210 mm or at least 220 mm or at least 230 mm or at least 240 mm or at least 250 mm. In still other embodiments, the length of the build box may be not greater than 2000 mm such as or not greater than 1500 mm or not greater than 1000 mm. It will be appreciated the build box may have a depth between any of the minimum and maximum values noted above, including for example, but not limited to, within a range of at least 65 mm to not greater than 2000 mm or within a range of at least 200 mm to not greater than 1000 mm. In an embodiment, the depth of the build box may facilitate improved manufacturing and/or performance of the abrasive article. In an embodiment, the depth of the build box may be at least 65 mm or at least 70 mm or at least 80 mm or at least 90 mm or at least 100 mm or at least 110 mm or at least 120 mm or at least 130 mm or at least 140 mm or at least 150 mm or at least 160 mm or at least 170 mm or at least 180 mm or at least 190 mm or at least 200 mm or at least 210 mm or at least 220 mm or at least 230 mm or at least 240 mm or at least 250 mm. In still other embodiments, the length of the build box may be not greater than 2000 mm such as or not greater than 1500 mm or not greater than 1000 mm. It will be appreciated the build box may have a depth between any of the minimum and maximum values noted above, including for example, but not limited to, within a range of at least 65 mm to not greater than 2000 mm or within a range of at least 200 mm to not greater than 1000 mm.

In an embodiment, the green body or plurality of green bodies defining a batch may have a volume that is at least 1% of the volume of the build box such as at least 2% or at least 3% or at least 4% or at least 5% or at least 6% or at least 7% or at least 8% or at least 9% or at least 10% or at least 11% or at least 12% or at least 13% or at least 14% or at least 15% or at least 18% or at least 20% or at least 22% or at least 25% or at least 28% or at least 30% or at least 32% or at least 35% or at least 38% or at least 40% or at least 42% or at least 45% or at least 48% or at least 50% or at least 52% or at least 55% or at least 58% or at least 60% or at least 62% or at least 65% or at least 67% or at least 68% or at least 70% or at least 72% or at least 75% or at least 78% or at least 80% or at least 82% or at least 85% or at least 88% or at least 90% or at least 92% or at least 95% or at least 98% of the volume of the build box. In still other embodiment, the green body or plurality of green bodies defining a batch may have a volume that is not greater than 99% of the volume of the build box such as not greater than 90% or not greater than 85% or not greater than 80% or not greater than 75% or not greater than 70% or not greater than 65% or not greater than 60% of the volume of the build box. In an embodiment, the green body or plurality of green bodies defining a batch may have a volume that is within a range of at least 1% of the volume of the build box to not greater than 99% of the volume of the build box or within a range at least 10% to not greater than 60% of the volume of the build box.

The processes of the embodiments herein are developed by empirical studies that have identified certain elements leading to improved abrasive articles. One non-limiting example of a property of the abrasive articles (green or finally-formed) that may be improved includes batch density variation. According to one embodiment, the process may facilitate formation of a batch of abrasive articles having a batch density variation of not greater than 20% of an average density value of the batch or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 7% or not greater than 6% or not greater than 5% or not greater than 4% or not greater than 3% or not greater than 2% or not greater than 1% or not greater than 0.5% or not greater than 0.3% or not greater than 0.1%. In still another embodiment, the batch density variation may be at least 0.00001% or at least 0.0001%. It will be appreciated the batch density variation may be between any of the minimum and maximum values noted above, including for example, but not limited to, within a range of at least 0.00001% to not greater than 20% of an average density value of the batch or within a range of at least 0.0001% to not greater than 10% of an average density value of the batch The batch density variation is calculated by measuring the density of each body of the plurality of bodies made via a single operation, wherein the batch density variation is a measure of the percent difference between an average density value of the batch and a density value from a body having the greatest difference, plus or minus, in density from the average density value of the batch. Note that multiple density values can be taken for each body of the plurality of bodies in the batch, and any of the density values taken from a body is relevant for comparison and calculation of the batch density variation. Each density value of the body may be averaged to create an average body density value for each discrete body in the batch. The average batch density value can be calculated by averaging the average density values for each body of the batch. The number of density values for a body or batch should be of a suitable statistically relevant sample size.

Notably, the empirical studies conducted by the Applicant facilitate methods that have a superior forming ratio (Add/Sub), which can define the ratio of the material added to form the body versus the material subtracted in any post-forming finishing techniques. The methods of the embodiments herein facilitate a forming ratio that is advantageous compared to conventional forming techniques and/or less sophisticated additive manufacturing techniques. In a particular embodiment, the body or method for forming the body defines a forming ratio (Add/Sub) of at least 10, wherein “Add” defines the volume of solid material (cm3) formed via additive processes used to form the body and “Sub” defines the volume (cm3) of solid material formed via a subtractive process to finish the finally-formed body, such as at least 20 or at least 50 or at least 80 or at least 100 or at least 200 or at least 300 or at least 400 or at least 500 or at least 600 or at least 700 or at least 800 or at least 1000 or at least 5000 or at least 10000.

In an embodiment, the finally-formed abrasive articles of a batch may have a residual stress in an exterior surface from post-forming operations that is at least 1% less than residual stress in conventionally-formed abrasive articles, such as at least 2% less or at least 3% less or at least 4% less or at least 5% less or at least 6% less or at least 7% less or at least 8% less or at least 9% less or at least 10% less or at least 11% less or at least 12% less or at least 13% less or at least 14% less or at least 15% less or at least 16% less or at least 17% less or at least 18% less or at least 19% less or at least 20% less or at least 25% less or at least 30% less or at least 35% less or at least 40% less or at least 45% less or at least 50% less or at least 55% less or at least 60% less or at least 65% less or at least 70% less or at least 75% less or at least 80% less or at least 85% less or at least 90% less or at least 95% less or at least 100% less. In still another embodiment, the finally-formed abrasive articles of a batch may have a residual stress in an exterior surface from post-forming operations that is not greater than 500% less than residual stress in conventionally-formed abrasive articles, such as not greater than 400% less or not greater than 300% less or not greater than 200% less or not greater than 100% less or not greater than 90% less.

In an embodiment, the finally-formed abrasive articles of a batch may have subsurface damage or residual stress that extends for at least 0.01% and not greater than 200% of an average particle size (D50) of the abrasive particles, such as at least 0.05% of the D50 of the abrasive particles or at least 0.08% or at least 0.1% or at least 0.5% or at least 1% or at least 2% or at least 3% or at least 4% or at least 5% or at least 6% or at least 7% or at least 8% or at least 9% or at least 10% or at least 11% or at least 12% or at least 13% or at least 14% or at least 15% or at least 18% or at least 20% or at least 22% or at least 25% or at least 28% or at least 30% or at least 32% or at least 35% or at least 38% or at least 40% or at least 42% or at least 45% or at least 48% or at least 50% or at least 52% or at least 55% or at least 58% or at least 60% or at least 62% or at least 65% or at least 67% or at least 68% or at least 70% or at least 72% or at least 75% or at least 78% or at least 80% or at least 82% or at least 85% or at least 88% or at least 90% or at least 92% or at least 95% or at least 98% or at least 100% or at least 102% or at least 105% or at least 108% or at least 110% or at least 115% or at least 120% or at least 125% or at least 130% or at least 140% or at least 150% or at least 160% or at least 170% or at least 180% of the D50 of the abrasive particles. In still another embodiment, the subsurface damage or residual stress extends for a distance below an exterior surface of the body for not greater than 190% of the D50 of the abrasive particles or not greater than 180% or not greater than 170% or not greater than 160% or not greater than 150% or not greater than 140% or not greater than 130% or not greater than 120% or not greater than 110% or not greater than 100% or not greater than 90% or not greater than 80% or not greater than 70% or not greater than 60% or not greater than 50% or not greater than 40% or not greater than 30% or not greater than 20% or not greater than 10% of the D50 of the abrasive particles.

In an embodiment, an abrasive article made herein may include a fixed abrasive such as a bonded abrasive article having abrasive particles contained in a three-dimensional volume of bond material, where the bond material substantially surrounds a majority of the abrasive particles. In still another embodiment, an abrasive article made herein may include a fixed abrasive such as a single-layered abrasive article wherein a substantially single layer of abrasive particles is contained in a layer of bond material.

The improvement in forming ratio is also evident in the limited residual stress and/or subsurface damage on one or more exterior surfaces of the finally-formed abrasive articles. Given the enhancements in the forming process, much less effort, if any, is needed to finish the abrasive articles to suitable shapes and/or tolerances for their intended applications. Accordingly, the amount of residual stress and/or subsurface damage in the finally-formed abrasive articles is less as compared to conventional products or other less sophisticated additive manufacturing techniques.

The foregoing properties of the abrasive articles of the embodiments herein provide various methods to define the quality and size of the abrasive articles capable of being formed using the methods of the embodiments herein.

### Embodiments

Embodiment 1. An abrasive powder material for additive manufacturing comprising abrasive particles and precursor bond material, wherein the powder material comprises at least one of the following flowability characteristics:
i) a Flowability Factor Angle of at least 1 degree and not greater than 80 degrees;
ii) a Linearity Factor of at least 0.70 and not greater than 0.99;
iii) a Surface Fractal Factor of at least 1 and not greater than 11;
iv) a Dynamic Density of at least 1.00 g/cc and not greater than 4 g/cc;
v) an Avalanche Energy of at least 5 mJ/kg and not greater than 28 mJ/kg;
vi) an Avalanche Energy Median of at least 5 mJ/kg and not greater than 28 mJ/kg;
vii) an Avalanche Angle of at least 2 degrees and not greater than 60 degrees;
viii) or any combination of i)-vii).

Embodiment 2. The abrasive precursor powder of Embodiment 1, the powder material comprises at least two of the following flowability characteristics:
i) a Surface Fractal Factor of at least 1 and not greater than 6;
ii) a Dynamic Density of at least 1.55 g/cc and not greater than 4 g/cc;
iii) an Avalanche Energy of at least 5 mJ/kg and not greater than 28 mJ/kg;
iv) an Avalanche Energy Median of at least 5 mJ/kg and not greater than 28 mJ/kg;
v) an Avalanche Angle of at least 2 degrees and not greater than 42 degrees;
vi) or any combination of three or more of i)-v) above.

Embodiment 3. A method of forming an abrasive article comprising:
treating a powder material including abrasive particles and precursor bond material to control at least one flowability characteristic of the powder material; and
forming the powder material into an abrasive article via an additive manufacturing process.

Embodiment 4. The method of Embodiment 3, wherein controlling at least one flowability characteristic includes changing a flowability characteristic of the powder material

Embodiment 5. The method of Embodiment 4, wherein controlling at least one flowability characteristic includes measuring and adjusting a flowability characteristic of the powder material until it is within a predetermined value, and further dispensing the powder material after measuring and adjusting the flowability characteristic of the powder material.

Embodiment 6. The method of Embodiment 3, wherein treating the powder material comprises at least one of thermally treating, chemically treating, mechanically treating, or irradiating the powder material to change the moisture content of the mixture.

Embodiment 7. The method of Embodiment 3, wherein treating the powder material comprises:
a) evaluating one or more flowability characteristics of the powder material at a first time; and
b) selecting a set temperature for treating the powder material to change the moisture content of the powder material.

Embodiment 8. The method of Embodiment 7, wherein further comprising:
a) evaluating the one or more flowability characteristics of the powder material at a second time different from the first time; and
b) determining whether to further treat the powder material to change a moisture content of the powder material.

Embodiment 9. The method of Embodiment 3, further comprising using one or more flowability characteristic of the powder material to calculate a Powder Moisture Score.

Embodiment 10. The method of Embodiment 9, wherein measuring the flowability characteristic includes capturing and storing electronic information related to the position and/or movement of the powder material.

Embodiment 11. The method of Embodiment 9, wherein measuring the flowability characteristic includes capturing and storing electronic information related to the position and/or movement of the powder material and using the electronic information to calculate a flowability characteristic selected from the group of a Flowability Factor Angle, a volume of powder material, a Surface Fractal Factor, a Linearity Factor, Avalanche Angle, Avalanche Angle Median, Avalanche Energy, Avalanche Energy Median, Median Avalanche Time, Avalanche Rest Angle, Dynamic Density, or any combination thereof.

Embodiment 12. The method of Embodiment 3, wherein treating the dry particulate mixture comprises:
a) measuring at least one flowability characteristic of the powder material at a first time; and
b) selecting a set temperature for treating the dry particulate mixture to change a moisture content of the powder material;
c) measuring the at least one flowability characteristic of the powder material at a second time different from the first time; and
b) determining whether to further treat the powder material to change the moisture content of the powder material.

Embodiment 13. The method of Embodiment 3, wherein the change in moisture content of the powder material after treating and before forming is not greater than 10%.

Embodiment 14. The method of Embodiment 3, wherein treating the powder material includes a continuous and simultaneous process of treating and forming.

Embodiment 15. The method of Embodiment 3, wherein treating includes treating the powder material in a treating vessel, and wherein the treating vessel is coupled to a dispensing mechanism configured to deposit a treated powder material into one or more layers of the build box.

Embodiment 16. The method of Embodiment 15, wherein treating includes treating the powder material in a treating vessel that is in fluid communication with a dispensing mechanism such that treated powder from the treating vessel is moved from the treating vessel to the dispensing mechanism, wherein the dispensing mechanism is configured to dispense the treated powder into one or more layers of powder material in the build box as part of a binder jetting operation.

Embodiment 17. A method of forming an abrasive article comprising:
measuring one or more flowability characteristics of a powder material; and
forming the powder material into an abrasive article via an additive manufacturing process.

Embodiment 18. The method of Embodiment 17, wherein measuring one or more flowability characteristics includes moving the powder material and evaluating one or more flowability characteristics of the powder material based upon its movement.

Embodiment 19. The method of Embodiment 18, wherein evaluating one or more flowability characteristics of the powder material based upon its movement includes monitoring the movement of the powder material using one or more sensors configured to store data with respect to the movement.

Embodiment 20. The method of Embodiment 17, wherein measuring the one or more flowability characteristics are selected from the group of a Flowability Factor Angle, a volume of powder material, a Surface Fractal Factor, a Linearity Factor, Avalanche Angle, Avalanche Angle Median, Avalanche Energy, Avalanche Energy Median, Median Avalanche Time, Avalanche Rest Angle, Dynamic Density, or any combination thereof.

Embodiment 21. The method of Embodiment 17, wherein measuring the flowability characteristic includes capturing and storing electronic information related to the position and/or movement of the powder material and using the electronic information to calculate a flowability characteristic selected from the group of a Flowability Factor Angle, a volume of powder material, a Surface Fractal Factor, a Linearity Factor, Avalanche Angle, Avalanche Angle Median, Avalanche Energy, Avalanche Energy Median, Median Avalanche Time, Avalanche Rest Angle, Dynamic Density, or any combination thereof.

Embodiment 22. The method of Embodiment 17, further comprising adjusting one or more processes of the additive manufacturing process based on the measuring of the one or more flowability characteristics of the powder material.

Embodiment 23. The method of Embodiment 22, wherein the one or more processes of the additive manufacturing process to be adjusted includes any one of the following processes:
i) recycling of powder material from a prior additive manufacturing process;
ii) blending of recycled powder with virgin powder material;
iii) the dispensing technique used to form a layer of the powder material in the build box;
iv) treating of the recycled powder material;
v) compacting of the layer of powder material;
vi) selecting the type of binder material;
vii) the binder saturation;
viii) or any combination of i)-vii).

Embodiment 24. The method of Embodiment 17, wherein measuring includes measuring and adjusting at least one of the flowability characteristics of the powder material to at least one of the following:
i) a Flowability Factor Angle of at least 1 degree and not greater than 80 degrees;
ii) a moisture content of at least 2% and not greater than 80%;
iii) a Linearity Factor of at least 0.70 and not greater than 0.99;
iv) a Surface Fractal Factor of at least 1 and not greater than 11.
v) a Dynamic Density of at least 1.00 g/cc and not greater than 4 g/cc;
vi) an Avalanche Energy of at least 5 mJ/kg and not greater than 28 mJ/kg;
vii) an Avalanche Energy Median of at least 5 mJ/kg and not greater than 28 mJ/kg
viii) an Avalanche Angle of at least 2 degrees and not greater than 60 degrees;
ix) or any combination of i)-viii).

Embodiment 25. The method of Embodiment 17, wherein measuring includes measuring and adjusting at least two of the flowability characteristics of the powder material to the following:
i) a Surface Fractal Factor of at least 1 and not greater than 6.
ii) a Dynamic Density of at least 1.55 g/cc and not greater than 4 g/cc;
iii) an Avalanche Energy of at least 5 mJ/kg and not greater than 28 mJ/kg;
iv) an Avalanche Energy Median of at least 5 mJ/kg and not greater than 28 mJ/kg
v) an Avalanche Angle of at least 2 degrees and not greater than 42 degrees;
   or any combination of three or more of i)-v) above.

### EXAMPLES

The following non-limiting examples illustrate the present invention.

### Example 1

A mixture is prepared by combining two individual dry powder materials: a precursor bond material and abrasive particles. The precursor bond material is an oxide-containing material that forms a vitreous phase material upon further processing.

The additive manufacturing process is conducted according to embodiments described herein. The additive manufacturing process may be characterized as a binder jetting operation, wherein layers of the powder material are deposited into a build box, the layers are smoothed, compacted, and selectively bound with a binder material to form a batch of green body abrasive articles contained a bed of unbound or loose powder. Each of the green body abrasive articles has any one or more of the features claimed in the embodiments herein. The batch of green body abrasive articles has any one or more of the features claimed in the embodiments herein. The green body abrasive article is converted to finally-formed abrasive article via heating as provided below. Example 1 was formed using an ExOne (now Desktop Metal) Innovent+. The printing conditions are summarized in Table 1.

TABLE 1

| Parameter | Samples S1 |
|---|---|
| Saturation (%) | 10-200% |
| Layer Thickness [μm] | 1-1000 |
| Foundation Layer Count | 0-200 |
| Oscillator on Delay (sec)Dispenser | 0-20 |
| Delay | |
| Dispense coverage parameter (% | 0-100% |
| of bed length for dispensing | |
| powder material) | |
| Binder Set Time (sec) | 0-30 |
| Recoater Dry Speed (mm/s) | 1-120 |
| Target Bed Temperature (° C.) | 20-100 |
| Recoat Speed (mm/s) | 1-200 |
| Smoothing Roller Rotation | 1-1000 |
| Rate(rpm) | |
| Smoothing Roller Speed (mm/s) | 1-200 |
| Binder Droplet Volume (pL)- | 10-80 |
| Binder Droplet Frequency (Hz)- | 955-10,000 |
| Compaction Roller Speed (mm/s) | 1-150 |
| Compaction thickness Δ (μm) | 5-300 |

The build box has dimensions of length of at least 150 mm, a width of at least 60 mm, and a depth of at least 60 mm. The forming process creates a green body abrasive article having dimensions of a length of at least 6 cm and/or a width of at least 2.8 cm and/or a solid volume of at least 9 cm³. The green body abrasive article has a thickness of at least 1 mm.

After forming, the green body is heated at a rate of 5° C./min up to a temperature of 375° C. under air and held for one hour at 375° C. to remove the binder. Thereafter, the air is replaced with argon and the body is heated at a ramp rate of 5° C./min up to a maximum temperature of 1000° C. The temperature is held for four hours at 1500° C., and cooling is conducted at a rate of 5° C./minute.

### Example 2

A mixture is prepared by combining two individual dry powder materials: a precursor bond material and abrasive particles. The precursor bond material is a metal-containing material.

The process for forming the green body abrasive article of Example 2 is conducted using an ExOne25 Pro (ExOne is now Desktop Metal). Printing conditions are provided in Table 2 below.

TABLE 2

| Parameter | Samples S2 |
|---|---|
| Saturation (%) | 10-200% |
| Layer Thickness [μm] | 1-1000 |
| Foundation Layer Count | 0-200 |
| Oscillator on Delay (sec)Dispenser | 0-20 |
| Delay | |
| Dispense coverage parameter (% | 0-100% |
| of bed length for dispensing | |
| powder material) | |
| Binder Set Time (sec) | 0-30 |
| Recoater Dry Speed (mm/s) | 1-120 |
| Target Bed Temperature (° C.) | 20-100 |
| Recoat Speed (mm/s) | 1-200 |
| Smoothing Roller Rotation | 1-1000 |
| Rate(rpm) | |
| Smoothing Roller Speed (mm/s) | 1-200 |
| Binder Droplet Volume (pL) | 10-80 |
| Binder Droplet Frequency (Hz) | 955-10,000 |
| Compaction Roller Speed (mm/s) | 1-150 |
| Compaction thickness Δ (μm) | 5-300 |

The build box has dimensions of length of at least 150 mm, a width of at least 60 mm, and a depth of at least 60 mm. The forming process creates a green body abrasive article having dimensions of a length of at least 6 cm and/or a width of at least 2.8 cm and/or a solid volume of at least 9 cm³. The green body abrasive article has a thickness of at least 1 mm.

### Comparative Example 1

A sample was prepared using a binder jetting operation as generally described in Example 1. However, the powder material was 20 wt % of SP1086 glass powder from Specialty Glass Inc., in Oldsmar, Fla., and 80 wt % of 200/230 Mesh, D76 diamond powder from Pinnacle Abrasives (Santa Rosa, Calif.). The binder used was PM-B-SR1-04 from ExOne. The forming conditions are detailed below in Table 3 and were formed using an Innovent ExOne Printer. FIG. 27 includes images of CS1 samples.

TABLE 3

| Parameter | Samples CS1 |
|---|---|
| Saturation (%) | 70 |
| Layer Thickness [μm] | 100 |
| Foundation Layer Count | 5 |
| Oscillator on Delay (sec) | 2 |
| Binder Set (sec) | 1 |
| Dry Time (sec) | 45 |
| Target Temperature (° C.) | 60 |
| Recoat Speed (rpm) | 10 |
| Oscillator Speed (rpm) | 2800 |
| Roller Speed (rpm) | 60 |
| Roller Speed (mm/s) | 1 |

The body was then cured in an ambient atmosphere oven for 2 hours at 195° C. After curing and cooling to 23° C. the cured bodies are placed into a furnace and burned out at 400° C. for 2 hours, followed by sintering at 700° C. for 4 hours, to produce comparative sample CS1.

### Sdr and Surface Roughness

The Sdr and surface roughness (Sa) of transverse surfaces and other surfaces of representative samples (“Sample”) and CS1 were measured and detailed below in Table 4.

TABLE 4

| | Sdr[%] | Sdr[%] | Sdr[%] | Sa[microns] | Sa[microns] |
|---|---|---|---|---|---|
| Sample | Transverse | Top | Difference | Transverse | Top |
| Sample | 76.5 | 64.7 | 11.8 | 11 | 9.112 |
| CS1 | 130 | 100 | 30 | | |

Notably, Sample had a much smaller transverse Sdr and Sdr difference than CS1.

### Example 3

A mixture is prepared by combining two individual dry powder materials: a precursor bond material and abrasive particles. The precursor bond material is an oxide-containing material that forms a vitreous phase material upon further processing.

The additive manufacturing process is conducted according to embodiments described herein. The additive manufacturing process may be characterized as a binder jetting operation, wherein layers of the powder material are deposited into a build box, the layers are smoothed, compacted, and selectively bound with a binder material to form a batch of green body abrasive articles contained in a bed of unbound or loose powder. Each of the green body abrasive articles has any one or more of the features claimed in the embodiments herein. The batch of green body abrasive articles has any one or more of the features claimed in the embodiments herein. The green body abrasive article is converted to finally-formed abrasive article via heating as provided below. Example 3 was formed using an ExOne (now Desktop Metal) Innovent+. The printing conditions are summarized in Table 5.

TABLE 5

| Parameter | Samples S3 |
|---|---|
| Saturation (%) | 10-200% |
| Layer Thickness [μm] | 1-1000 |
| Foundation Layer Count | 1-200 |
| Oscillator on Delay (sec) | 0-5 |
| Dispense coverage parameter (% | 0-100% |
| of bed length for dispensing | |
| powder material) | |
| Binder Set Time (sec) | 0-600 |
| Recoater Dry Speed (mm/s) | 1-120 |
| Target Bed Temperature (° C.) | 20-100 |
| Recoat Speed (mm/s) | 1-500 |
| Smoothing Roller Speed (rpm) | 1-1000 |
| Smoothing Roller Speed (mm/s) | 1-150 |
| Binder Droplet Volume (pL) | 10-80 |
| Binder Droplet Frequency (Hz) | 955-10,000 |
| Compaction Roller Speed (mm/s) | 0-150 |
| Compaction thickness Δ (μm) | 5-300 |

The build box has dimensions of length of at least 150 mm, a width of at least 60 mm, and a depth of at least 60 mm. The forming process creates a green body abrasive article having dimensions of a length of at least 6 cm and/or a width of at least 2.8 cm and/or a solid volume of at least 9 cm³. The green body abrasive article has a thickness of at least 1 mm.

After forming, the green body is heated at a rate of 5° C./min up to a temperature of 375° C. under air, and held for one hour at 375° C. to remove the binder. Thereafter, the air is replaced with argon and the body is heated at a ramp rate of 5° C./min up to a maximum temperature of 1000° C. The temperature is held for four hours at 1500° C., and cooling is conducted at a rate of 5° C./minute.

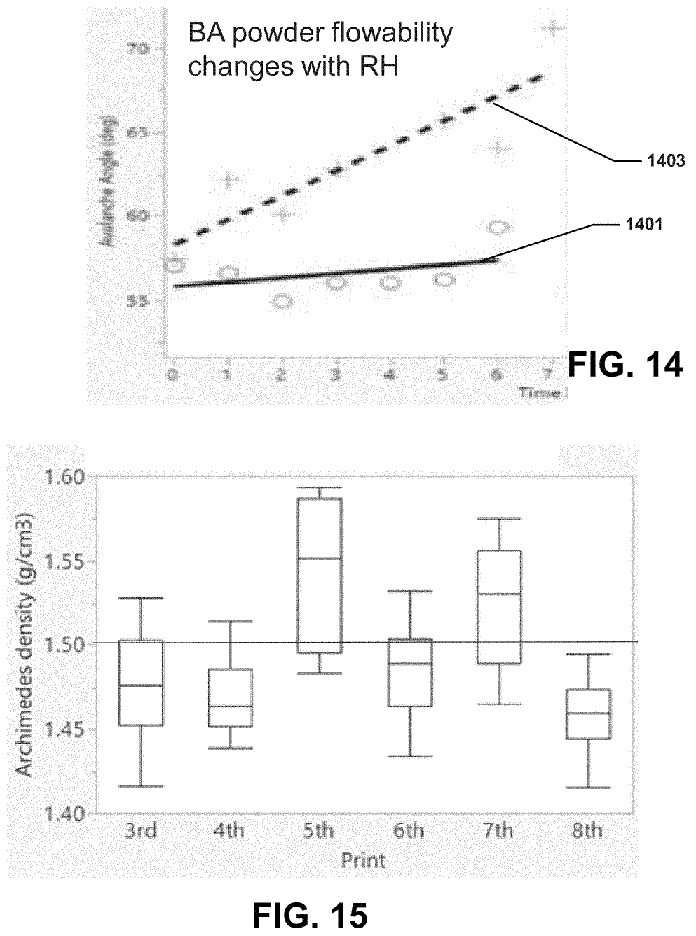

FIG. 14 includes a plot of avalanche angle versus time for a powder material. Line 1401 is a sample of precursor bond material including a vitreous-forming composition having a moisture content of less than 55%. Line 1403 is a sample of the same precursor bond material as the sample used to generate Line 1401, but the sample for Line 1403 has a moisture content greater than 55%. The increase in avalanche angle over time for Line 1403 represents a decrease in the flowability of the powder having a direct impact on the variation of certain properties and characteristics in the abrasive products. FIG. 15 includes a plot of density for samples made from only the precursor bond material according to samples on Line 1403, which are shown to have a density variation of approximately plus or minus 7% from the average value. Such variation would be unsuitable for certain abrasive products.

### Example 4

Two samples (Sample S4 and Sample S5) were formed using the conditions of Example 1, with the difference being that the powder of Sample S4 was heated to a temperature of approximately 60-70° C. in an attempt to control one or more flowability characteristics and/or moisture content of the powder material. The moisture content of the powder material of Sample S4 was greater than 60%. It was found that the powder material for Sample S4 could not be used for deposition and printing, and no samples could be made using such powder material. The same powder material of Sample S4 was then heated to a temperature of approximately 140-150° C. for a minimum of 8 hours to a moisture content of not greater than 55%. The printing conditions used to create Samples S5 are provided below in Table 6 using an ExOne (now Desktop Metal) Innovent+.

TABLE 6

| Parameter | Samples S1 |
|---|---|
| Saturation (%) | 10-200% |
| Layer Thickness [μm] | 1-1000 |
| Foundation Layer Count | 0-200 |
| Oscillator on Delay (sec)Dispenser | 0-20 |
| Delay | |
| Dispense coverage parameter (% | 0-100% |
| of bed length for dispensing | |
| powder material) | |
| Binder Set Time (sec) | 0-30 |
| Recoater Dry Speed (mm/s) | 1-120 |
| Target Bed Temperature (° C.) | 20-100 |
| Recoat Speed (mm/s) | 1-200 |
| Smoothing Roller Rotation | 1-1000 |
| Rate(rpm) | |
| Smoothing Roller Speed (mm/s) | 1-200 |
| Binder Droplet Volume (pL)- | 10-80 |
| Binder Droplet Frequency (Hz)- | 955-10,000 |
| Compaction Roller Speed (mm/s) | 1-150 |
| Compaction thickness Δ (μm) | 5-300 |

FIGS. 27A-27E include plots of the flowability characteristics of the powder material for Samples S4 and S5.

According to the embodiments herein, abrasive articles may be created that have a controlled difference in surface features (e.g., Sdr, etc.) between two surfaces, notably two different exterior surfaces of the abrasive articles. Research into the process variables that may be used to control differences in such surface features are complex and not predictable. Certain surface features, such as the difference in Sdr are understood to be related to build direction and orientation of the body during the forming process. Accordingly, the empirical data generated demonstrates that it is possible to engineer abrasive articles having selective surface features on various surfaces by controlling the build direction and build parameters. Such surface features are thought to be technically beneficial with respect to improved abrasive performance and/or anchoring of the abrasive articles with a bond system or other component for formation of a fixed abrasive article.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include a range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An abrasive powder material for additive manufacturing comprising abrasive particles and precursor bond material, wherein the powder material comprises at least one of the following flowability characteristics:
i) a Flowability Factor Angle of at least 1 degree and not greater than 80 degrees;
ii) a Linearity Factor of at least 0.70 and not greater than 0.99;
iii) a Surface Fractal Factor of at least 1 and not greater than 11;
iv) a Dynamic Density of at least 1.00 g/cc and not greater than 4 g/cc;
v) an Avalanche Energy of at least 5 mJ/kg and not greater than 28 mJ/kg;
vi) an Avalanche Energy Median of at least 5 mJ/kg and not greater than 28 mJ/kg;
vii) an Avalanche Angle of at least 2 degrees and not greater than 60 degrees;
viii) or any combination of i)-vii).

2. The abrasive precursor powder of claim 1, the powder material comprises at least two of the following flowability characteristics:
i) a Surface Fractal Factor of at least 1 and not greater than 6;
ii) a Dynamic Density of at least 1.55 g/cc and not greater than 4 g/cc;
iii) an Avalanche Energy of at least 5 mJ/kg and not greater than 28 mJ/kg;
iv) an Avalanche Energy Median of at least 5 mJ/kg and not greater than 28 mJ/kg;
v) an Avalanche Angle of at least 2 degrees and not greater than 42 degrees;
vi) or any combination of three or more of i)-v) above.

3. A method of forming an abrasive article comprising:
treating a powder material including abrasive particles and precursor bond material to control at least one flowability characteristic of the powder material; and
forming the powder material into an abrasive article via an additive manufacturing process.

4. The method of claim 3, wherein controlling at least one flowability characteristic includes changing a flowability characteristic of the powder material.

5. The method of claim 4, wherein controlling at least one flowability characteristic includes measuring and adjusting a flowability characteristic of the powder material until it is within a predetermined value, and further dispensing the powder material after measuring and adjusting the flowability characteristic of the powder material.

6. The method of claim 3, wherein treating the powder material comprises at least one of thermally treating, chemically treating, mechanically treating, or irradiating the powder material to change the moisture content of the mixture.

7. The method of claim 3, wherein measuring the flowability characteristic includes capturing and storing electronic information related to the position and/or movement of the powder material.

8. The method of claim 3, wherein measuring the flowability characteristic includes capturing and storing electronic information related to the position and/or movement of the powder material and using the electronic information to calculate a flowability characteristic selected from the group of a Flowability Factor Angle, a volume of powder material, a Surface Fractal Factor, a Linearity Factor, Avalanche Angle, Avalanche Angle Median, Avalanche Energy, Avalanche Energy Median, Median Avalanche Time, Avalanche Rest Angle, Dynamic Density, or any combination thereof.

9. The method of claim 3, wherein treating the dry particulate mixture comprises:
a) measuring at least one flowability characteristic of the powder material at a first time; and
b) selecting a set temperature for treating the dry particulate mixture to change a moisture content of the powder material;
c) measuring the at least one flowability characteristic of the powder material at a second time different from the first time; and
d) determining whether to further treat the powder material to change the moisture content of the powder material.

10. The method of claim 3, wherein a change in moisture content of the powder material after treating and before forming is not greater than 10%.

11. The method of claim 3, wherein treating the powder material includes a continuous and simultaneous process of treating and forming.

12. The method of claim 3, wherein treating includes treating the powder material in a treating vessel, and wherein the treating vessel is coupled to a dispensing mechanism configured to deposit a treated powder material into one or more layers of the build box.

13. The method of claim 12, wherein treating includes treating the powder material in a treating vessel that is in fluid communication with a dispensing mechanism such that treated powder from the treating vessel is moved from the treating vessel to the dispensing mechanism, wherein the dispensing mechanism is configured to dispense the treated powder into one or more layers of powder material in the build box as part of a binder jetting operation.

14. A method of forming an abrasive article comprising:
measuring one or more flowability characteristics of a powder material; and
forming the powder material into an abrasive article via an additive manufacturing process.

15. The method of claim 14, wherein measuring one or more flowability characteristics includes moving the powder material and evaluating one or more flowability characteristics of the powder material based upon its movement.

16. The method of claim 15, wherein evaluating one or more flowability characteristics of the powder material based upon its movement includes monitoring the movement of the powder material using one or more sensors configured to store data with respect to the movement of the powder material.

17. The method of claim 14, wherein measuring the flowability characteristic includes capturing and storing electronic information related to the position and/or movement of the powder material and using the electronic information to calculate a flowability characteristic selected from the group of a Flowability Factor Angle, a volume of powder material, a Surface Fractal Factor, a Linearity Factor, Avalanche Angle, Avalanche Angle Median, Avalanche Energy, Avalanche Energy Median, Median Avalanche Time, Avalanche Rest Angle, Dynamic Density, or any combination thereof.

18. The method of claim 14, further comprising adjusting one or more processes of the additive manufacturing process based on the measuring of the one or more flowability characteristics of the powder material.

19. The method of claim 18, wherein the one or more processes of the additive manufacturing process to be adjusted includes any one of the following processes:
i) recycling of powder material from a prior additive manufacturing process;
ii) blending of recycled powder with virgin powder material;
iii) the dispensing technique used to form a layer of the powder material in the build box;
iv) treating of the recycled powder material;
v) compacting of the layer of powder material;
vi) selecting the type of binder material;
vii) the binder saturation;
viii) or any combination of i)-vii).

20. The method of claim 14, wherein measuring includes measuring and adjusting at least two of the flowability characteristics of the powder material to the following:
i) a Surface Fractal Factor of at least 1 and not greater than 6;
ii) a Dynamic Density of at least 1.55 g/cc and not greater than 4 g/cc;
iii) an Avalanche Energy of at least 5 mJ/kg and not greater than 28 mJ/kg;
iv) an Avalanche Energy Median of at least 5 mJ/kg and not greater than 28 mJ/kg
v) an Avalanche Angle of at least 2 degrees and not greater than 42 degrees;
vi) or any combination of three or more of i)-v) above.
